(19) United States
(12) Patent Application Publication
(10) Pub. No.: US 2003/0185502 A1
(43) Pub. Date: Oct. 2, 2003

(54) Optical receiving apparatus, optical transmitting apparatus, optical transmitting/receiving apparatus and optical transfer system

(76) Inventors: Seiichiro Kawashima, Yokohama-shi (JP); Yoshikazu Ishii, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/394,055

(22) Filed: Mar. 24, 2003

(30) Foreign Application Priority Data
Mar. 29, 2002 (JP) PAT.2002-97822

(51) Int. Cl. G02B 6/28

(52) U.S. Cl. 385/24; 385/89

(57) ABSTRACT

Disclosed is a wavelength multiplexing/demultiplexing optical transfer system which is prevented from becoming larger by an increase in the number of wavelength multiplexing/demultiplexing couplers which is increased as the number of wavelengths increases, thereby reducing the number of assembling steps to lead to cost reduction. As WDM (Wavelength Division Multiplexing) optical receiver modules each having a wavelength multiplexing/demultiplexing element and a light emitting element are connected sequentially, an input optical signal with four wavelengths is demultiplexed and each demultiplexed signal is converted to an electric signal to thereby ensure wavelength demultiplexing and data reproduction.

### BACKGROUND OF THE INVENTION

1. Field of the Invention

The present invention relates to an optical receiving apparatus, optical transmitting apparatus, optical transmitting/receiving apparatus and optical transfer system which are used to transfer signals of a plurality of signal forms in wavelength multiplexing. More particularly, the invention relates to those which can be constructed as a service multiplexed transfer system, a one-fiber bidirectional optical transfer system, a wavelength division multiplexing optical transfer system, a wavelength division multiplexing optical transmitting/receiving apparatus, a wavelength division multiplexing optical receiving apparatus and a wavelength division multiplexing optical receiving apparatus.

2. Description of the Related Art

FIG. 29 is a block diagram of this type of wavelength division multiplexing (WDM) optical receiving apparatus, FIG. 30 is a block diagram of an optical receiver module which is used in this type of WDM optical receiving apparatus, FIG. 31 is a block diagram of this type of WDM optical transmitting apparatus, FIG. 32 is a block diagram of an optical transmitter module which is used in this type of WDM optical transmitting apparatus, and FIG. 33 is a block diagram of this type of WDM optical transmitting/receiving apparatus. Although the number of wavelength multiplexing stages of this type of WDM optical receiving apparatus and the types of input/output data should be arbitrary, a case where the number of wavelength multiplexing stages is four and the types of input/output data are four will be illustrated and discussed hereinafter for the sake of simplifying the description. It should be easy for those skilled in the art to anticipate and realize setting the number of wavelength multiplexing stages and the types of input/output data greater than four.

In FIG. 29, optical signals of four types of wavelengths (λ1, λ2, λ3, λ4) are multiplexed in a transfer optical fiber 1 and are input to a WDM optical receiving apparatus 2924. Intraconnection optical fibers 2916, 2917, 2918, 2919, 2920, 2921 and 2922 optically connect the components inside the apparatus to one another. A wavelength multiplexing/demultiplexing section 2923 separates and outputs the input optical signal with four types of wavelengths multiplexed to four intraconnection optical fibers, wavelength by wavelength. Reference numerals “2913”, “2914” and “2915” are wavelength multiplexing/demultiplexing couplers. The wavelength multiplexing/demultiplexing coupler 2913 separates the input optical signal with the wavelengths λ1, λ2, λ3, λ4 to an optical signal with the wavelengths λ1 and λ2 and an optical signal with the wavelengths λ3 and λ4 and outputs the optical signals. The wavelength multiplexing/demultiplexing coupler 2914 separates the input optical signal with the wavelengths λ1 and λ2 to an optical signal of the wavelength λ1 and an optical signal of the wavelength λ2 and outputs the optical signals. The wavelength multiplexing/demultiplexing coupler 2915 separates the input optical signal with the wavelengths λ3 and λ4 to an optical signal of the wavelength λ3 and an optical signal of the wavelength λ4 and outputs the optical signals.

Receiver modules 2901, 2902, 2903 and 2904 output current signals corresponding to input optical signal powers. Electric processing circuits for the receiver modules (hereinafter simply called “electric processing circuits” or “electric circuits”) 2905, 2906, 2907 and 2908 convert current signals respectively output from the receiver modules 2901 to 2904 to demanded signal forms or signal levels. Optical receiving sections 2909, 2910, 2911 and 2912 respectively comprise the associated receiver modules 2901 to 2904 and the associated electric processing circuits 2905 to 2908. Electric connectors “15”, “16”, “17”, “18” are provided to output signals outside. In FIG. 30, “3004” denotes an intraconnection optical fiber, “3001” denotes a light receiving element and “3002” denotes an electric interconnection lead. The light receiving element (PD) 3001 is optically coupled to the intraconnection optical fiber 3004 and electrically connected to the electric interconnection leads 3002, thereby constituting a receiver module 3003.

Reference numeral “3124” in FIG. 31 denotes a WDM optical transmitting apparatus. The WDM optical transmitting apparatus 3124 multiplexes optical signals of four types of wavelengths (λ5, λ6, λ7, λ8) and outputs the multiplexed signal to a transfer optical fiber 1. Intraconnection optical fibers 3116, 3117, 3118, 3119, 3120, 3121 and 3122 optically connect the components inside the apparatus to one another. A wavelength multiplexing/demultiplexing section 3123 wavelength-multiplexed optical signals input from the four intraconnection optical fibers 3119, 3120, 3121 and 3122 and outputs the multiplexed signal. Reference numerals “3113”, “3114” and “3115” are wavelength multiplexing/demultiplexing couplers. The wavelength multiplexing/demultiplexing coupler 3113 multiplexes the input optical signal with the wavelengths λ5 and λ6 and the input optical signal with the wavelengths λ7 and λ8 and outputs an optical signal with the wavelengths λ5, λ6, λ7 and λ8. The wavelength multiplexing/demultiplexing coupler 3114 multiplexes the input optical signal of the wavelength λ5 and the input optical signal of the wavelength λ6 and outputs an optical signal with the wavelengths λ5 and λ6. The wavelength multiplexing/demultiplexing coupler 3115 multiplexes the input optical signal of the wavelength λ7 and the input optical signal of the wavelength λ8 and outputs an optical signal with the wavelengths λ7 and λ8. Transmitter modules 3101, 3102, 3103 and 3104 output optical signals corresponding to input currents. Electric processing circuits for the transmitter modules (hereinafter simply called “electric processing circuits” or “electric circuits”) 3105, 3106, 3107 and 3108 convert input signal forms or signal levels to current signals needed by the transmitter modules 3101 to 3104. Optical transmitting sections 3109, 3110, 3111 and 3112 respectively comprise the associated transmitter modules 3101 to 3104 and the associated electric processing circuits 3105 to 3108. Reference numerals “36”, “37”, “38” and “39” denote electric connectors. In FIG. 32, “3204” denotes an intraconnection optical fiber, “3201” denotes a light emitting element (LD) and “3203” denotes an electric interconnection lead. The light emitting element 3201 is optically coupled to the intraconnection optical fiber 3204 and electrically connected to the electric interconnection leads 3203, thereby constituting a transmitter module 3202.

Reference numeral “3328” in FIG. 33 denotes a WDM optical transmitting/receiving apparatus. The WDM optical transmitting/receiving apparatus 3328 receives optical signals of four types of wavelengths (λ1, λ2, λ3, λ4) from a transfer optical fiber 1, and multiplexes optical signals of four types of wavelengths (λ5, λ6, λ7, λ8) and outputs the multiplexed signal to the transfer optical fiber 1. Intraconnection optical fibers 3312, 3313, 3314, 3315, 3316, 3317, 3318, 3319, 3320, 3321, 3322, 3323, 3324, 3325 and 3326 optically connect the components inside the apparatus to one another. Receiver modules 2901, 2902, 2903 and 2904 output currents corresponding to input optical signals. Transmitter modules 3101, 3102, 3103 and 3104 output optical signals corresponding to input currents. Reference numerals “2905”, “2906”, “2907” and “2908” denote electric processing circuits for the receiver modules (hereinafter simply called “electric processing circuits” or “electric circuits”). Optical transmitting/receiving sections 3301, 3302, 3303 and 3304 respectively comprise the associated receiver modules 2901 to 2904, the associated transmitter modules 3101 to 3104 and the associated electric processing circuits 2905 to 2908 and 3105 to 3108. A wavelength multiplexing/demultiplexing section 3327 outputs the input optical signals of four types of wavelengths to the 3319, 3321, 3323 and 3325 wavelength by wavelength and wavelength-multiplexes optical signals input from the four intraconnection optical fibers 3320, 3322, 3324 and 3326 and outputs the multiplexed signal.

Reference numerals “3305”, “3306, “3307”, “3308”, “3309”, “3310” and “3311” are wavelength multiplexing/demultiplexing couplers. The wavelength multiplexing/demultiplexing coupler 3305 separates the optical signal with the wavelengths λ1, λ2, λ3 and λ4 input from the intraconnection optical fiber 3312 to an optical signal with the wavelengths λ1 and λ2 and an optical signal with the wavelengths λ3 and λ4, and multiplexes an optical signal with the wavelengths λ5 and λ6 input from the intraconnection optical fiber 3313 and an optical signal with the wavelengths λ7 and λ8 input from the intraconnection optical fiber 3314 and outputs the optical signal with the wavelengths λ5, λ6, λ7 and λ8 to the intraconnection optical fiber 3312. The wavelength multiplexing/demultiplexing coupler 3306 separates the optical signal with the wavelengths λ1 and λ2 input from the intraconnection optical fiber 3313 to an optical signal with the wavelength λ1 and an optical signal with the wavelength λ2, and multiplexes the optical signal with the wavelength λ5 input from the intraconnection optical fiber 3315 and an optical signal with the wavelength λ6 input from the intraconnection optical fiber 3316 and outputs the optical signal with the wavelengths λ5 and λ6 to the intraconnection optical fiber 3313. The wavelength multiplexing/demultiplexing coupler 3307 separates the optical signal with the wavelengths λ3 and λ4 input from the intraconnection optical fiber 3314 to an optical signal with the wavelength λ3 and an optical signal with the wavelength λ4, and multiplexes the optical signal with the wavelength λ7 input from the intraconnection optical fiber 3317 and an optical signal with the wavelength λ8 input from the intraconnection optical fiber 3318 and outputs the optical signal with the wavelengths λ7 and λ8 to the intraconnection optical fiber 3314. The wavelength multiplexing/demultiplexing coupler 3308 outputs the optical signal of the wavelength λ1, input from the intraconnection optical fiber 3315, to the optical transmitting/receiving section 3301 and outputs the optical signal of the wavelength λ5, input from the optical transmitting/receiving section 3301, to the optical intraconnection optical fiber 3315. The wavelength multiplexing/demultiplexing coupler 3309 outputs the optical signal of the wavelength λ2, input from the intraconnection optical fiber 3316, to the optical transmitting/receiving section 3302 and outputs the optical signal of the wavelength λ6, input from the optical transmitting/receiving section 3302, to the optical intraconnection optical fiber 3316. The wavelength multiplexing/demultiplexing coupler 3310 outputs the optical signal of the wavelength λ3, input from the intraconnection optical fiber 3317, to the optical transmitting/receiving section 3303 and outputs the optical signal of the wavelength λ7, input from the optical transmitting/receiving section 3303, to the optical intraconnection optical fiber 3317. The wavelength multiplexing/demultiplexing coupler 3311 outputs the optical signal of the wavelength λ₄, input from the intraconnection optical fiber 3318, to the optical transmitting/receiving section 3304 and outputs the optical signal of the wavelength λ8, input from the optical transmitting/receiving section 3304, to the optical intraconnection optical fiber 3318. Reference numerals “15”, “16”, “17”, “18” “36”, “37”, “38” and “39” denote electric connectors.

The operation will be discussed below. The optical signal with the four wavelengths λ1, λ2, λ3 and λ4 input to the WDM optical receiving apparatus 2924 in FIG. 29 is demultiplexed wavelength by wavelength by the wavelength multiplexing/demultiplexing section 2923. The optical signal of the wavelength λ1 is input to the optical receiving section 2909, the optical signal of the wavelength λ2 is input to the optical receiving section 2910, the optical signal of the wavelength λ3 is input to the optical receiving section 2911 and the optical signal of the wavelength λ4 is input to the optical receiving section 2912. In the optical receiving sections 2909 to 2912, the receiver modules 2901 to 2904 convert those optical signals to electric signals, and the electric processing circuits 2905 to 2908 convert the electric signals to have demanded signal forms and signal levels and output DATA1, DATA2, DATA3 and DATA4. DATA5, DATA6, DATA7 and DATA8 input to the WDM optical transmitting apparatus 3124 in FIG. 31 are respectively converted to optical signals with wavelengths λ5, λ6, λ7 and λ8 by the optical transmitting sections 3109 to 3112. The optical signals with wavelengths λ5 and λ6 are multiplexed by the wavelength multiplexing/demultiplexing coupler 3114 and the multiplexed optical signal is output to the wavelength multiplexing/demultiplexing coupler 3113. The optical signals with wavelengths λ7 and λ8 are multiplexed by the wavelength multiplexing/demultiplexing coupler 3115 and the multiplexed optical signal is output to the wavelength multiplexing/demultiplexing coupler 3113. The wavelength multiplexing/demultiplexing coupler 3113 multiplexes the input optical signals with wavelengths λ5, λ6, λ7 and λ8 and outputs the multiplexed signal to the transfer optical fiber 1 via an optical connector 19. The optical signal with the four wavelengths λ1, λ2, λ3 and λ4 input to the WDM optical transmitting/receiving apparatus 3328 in FIG. 33 is demultiplexed wavelength by wavelength by the wavelength multiplexing/demultiplexing section 3327. The optical signal of the wavelength λ1 is input to the optical transmitting/receiving section 3301, the optical signal of the wavelength λ2 is input to the optical transmitting/receiving section 3302, the optical signal of the wavelength λ3 is input to the optical transmitting/receiving section 3303 and the optical signal of the wavelength λ4 is input to the optical transmitting/receiving section 3304. In the optical transmitting/receiving sections 3301 to 3304, the receiver modules 2901 to 2904 convert those optical signals to electric signals, and the electric processing circuits 2905 to 2908 convert the electric signals to have demanded signal forms and signal levels and output DATA1, DATA2, DATA3 and DATA4. Meanwhile, DATA5, DATA6, DATA7 and DATA8 input to the WDM optical transmitting/receiving apparatus 3328 are respectively converted to optical signals with wavelengths λ5, λ6, λ7 and λ8 by the optical transmitting/receiving sections 3301 to 3304. The optical signal with wavelengths λ5 and λ6 and the optical signal with wavelengths λ7 and λ8 are multiplexed by the wavelength multiplexing/demultiplexing coupler 3327 and the multiplexed optical signal is output to the transfer optical fiber 1.

It is apparent that the conventional optical receiving apparatus can demultiplex an optical signal with a plurality of wavelengths to output data of each wavelength, the conventional optical transmitting apparatus can convert a plurality of electric signals to optical signals with different wavelengths and transmit the optical signals, and the conventional optical transmitting/receiving apparatus can demultiplex an optical signal with a plurality of wavelengths to output data of each wavelength and convert a plurality of electric signals to optical signals with different wavelengths and transmit the optical signals in a multiplexed form.

As the number of wavelength multiplexing stages increases in the conventional optical receiving apparatus, optical transmitting apparatus and optical transmitting/receiving apparatus, however, the number of wavelength multiplexing/demultiplexing couplers in the wavelength multiplexing/demultiplexing section increases. This results in an increase in the number of intraconnection optical fibers, which would inevitably enlarge the apparatus.

### SUMMARY OF THE INVENTION

Accordingly, it is an object of the invention to provide an excellent wavelength division multiplexing transfer apparatus which can increase the number of wavelength multiplexing stages without enlarging the apparatus.

To achieve the object, the invention suppresses an increase in the number of wavelength multiplexing/demultiplexing couplers which is caused by an increase in the number of wavelength multiplexing stages by incorporating wavelength multiplexing/demultiplexing elements, formed of a dielectric multilayer film, in receiver modules and transmitter modules and sequentially connecting the receiver modules or the transmitter modules.

The invention therefore suppresses an increase in the number of wavelength multiplexing/demultiplexing couplers originated from an increase in the number of wavelength multiplexing stages and can thus make the apparatus compact, and also suppresses an increase in the number of intraconnection optical fibers, which would suppress the troublesome assembling work and lead to cost reduction.

According to the first aspect of the invention, there is provided an optical receiving apparatus comprising:

first to n-th optical receiving sections (n being an integer equal to or greater than 2) each including a receiver module having a wavelength multiplexing/demultiplexing element for passing an optical signal of a specific wavelength and reflecting optical signals having other wavelengths than the specific wavelength, and a light receiving element for converting output light from the wavelength multiplexing/demultiplexing element to an electric signal, and an electric circuit for converting an output electric signal from the receiver module into a predetermined form and/or level and outputting the output electric signal; and

optical fiber means for sequentially connecting the wavelength multiplexing/demultiplexing elements of the first to n-th optical receiving sections one to another and connecting the wavelength multiplexing/demultiplexing element of the first optical receiving section to an optical connector.

In the first aspect, the specific wavelength may differ among the wavelength multiplexing/demultiplexing elements of the first to n-th optical receiving sections (first modification).

According to the second aspect of the invention, there is provided an optical transmitting apparatus comprising:

first to n-th optical transmitting sections (n being an integer equal to or greater than 2) each including an electric circuit for converting an electric signal to be input into a predetermined form and/or level and outputting the electric signal, and a transmitter module equipped in a single module with a light emitting element for converting the output electric signal from the electric circuit to an optical signal, a wavelength multiplexing/demultiplexing element, provided at an optical output section of the light emitting element, for passing an optical signal of a specific wavelength and reflecting optical signals having other wavelengths than the specific wavelength and an optical coupling section for optically coupling an input optical fiber and an output optical fiber to the wavelength multiplexing/demultiplexing element; and

optical fiber means for sequentially connecting the optical coupling sections of the first to n-th optical transmitting sections one to another and connecting the optical coupling section of the first optical transmitting section to an optical connector.

In the second aspect, the specific wavelength may differ among the wavelength multiplexing/demultiplexing elements of the first to n-th optical transmitting sections (second modification).

According to the third aspect of the invention, there is provided an optical transmitting/receiving apparatus comprising:

first to n-th optical receiving sections (n being an integer equal to or greater than 2) each including a receiver module having a wavelength multiplexing/demultiplexing element for passing an optical signal of a specific wavelength and reflecting optical signals having other wavelengths than the specific wavelength, and a light receiving element for converting output light from the wavelength multiplexing/demultiplexing element to an electric signal, and an electric circuit for converting an output electric signal from the receiver module into a predetermined form and/or level and outputting the output electric signal;

first to n-th optical transmitting sections each including an electric circuit for converting an electric signal to be input into a predetermined form and/or level and outputting the electric signal, and a transmitter module equipped in a single module with a light emitting element for converting the output electric signal from the electric circuit to an optical signal, a wavelength multiplexing/demultiplexing element, provided at an optical output section of the light emitting element, for passing an optical signal of a specific wavelength and reflecting optical signals having other wavelengths than the specific wavelength and an optical coupling section for optically coupling an input optical fiber and an output optical fiber to the wavelength multiplexing/demultiplexing element; and

optical fiber means for connecting the wavelength multiplexing/demultiplexing element of the first optical receiving section to the optical coupling section of the first optical transmitting section, connecting the optical coupling section of the first optical transmitting section to the wavelength multiplexing/demultiplexing element of the second optical receiving section, making similar connections thereafter and connecting the wavelength multiplexing/demultiplexing element of the first optical receiving section to an optical connector.

According to the fourth aspect of the invention, there is provided an optical transfer system for transferring data of a plurality of different signal forms in a form of a wavelength multiplexed signal, comprising:

(a) an optical transmitting apparatus having

first to n-th optical transmitting sections (n being an integer equal to or greater than 2) each including an electric circuit for converting an electric signal to be input into a predetermined form and/or level and outputting the electric signal, and a transmitter module equipped in a single module with a light emitting element for converting the output electric signal from the electric circuit to an optical signal, a wavelength multiplexing/demultiplexing element, provided at an optical output section of the light emitting element, for passing an optical signal of a specific wavelength and reflecting optical signals having other wavelengths than the specific wavelength and an optical coupling section for optically coupling an input optical fiber and an output optical fiber to the wavelength multiplexing/demultiplexing element, and

optical fiber means for sequentially connecting the optical coupling sections of the first to n-th optical transmitting sections one to another and connecting the optical coupling section of the first optical transmitting section to an optical connector;

(b) an optical receiving apparatus having

first to n-th optical receiving sections each including a receiver module having a wavelength multiplexing/demultiplexing element for passing an optical signal of a specific wavelength and reflecting optical signals having other wavelengths than the specific wavelength and a light receiving element for converting output light from the wavelength multiplexing/demultiplexing element to an electric signal, and an electric circuit for converting an output electric signal from the receiver module into a predetermined form and/or level and outputting the output electric signal, and

optical fiber means for sequentially connecting the wavelength multiplexing/demultiplexing elements of the first to n-th optical receiving sections one to another and connecting the wavelength multiplexing/demultiplexing element of the first optical receiving section to an optical connector; and

(c) a transfer optical fiber provided between the optical transmitting apparatus and the optical receiving apparatus.

According to the fifth aspect of the invention, there is provided an optical transfer system for bidirectionally transferring data of a plurality of different signal forms in a form of a wavelength multiplexed signal, comprising:

(a) a first optical transmitting/receiving apparatus having

first to n-th optical receiving sections (n being an integer equal to or greater than 2) each including a receiver module having a wavelength multiplexing/demultiplexing element for passing an optical signal of a specific wavelength and reflecting optical signals having other wavelengths than the specific wavelength and a light receiving element for converting output light from the wavelength multiplexing/demultiplexing element to an electric signal, and an electric circuit for converting an output electric signal from the receiver module into a predetermined form and/or level and outputting the output electric signal,

first to n-th optical transmitting sections each including an electric circuit for converting an electric signal to be input into a predetermined form and/or level and outputting the electric signal, and a transmitter module equipped in a single module with a light emitting element for converting the output electric signal from the electric circuit to an optical signal, a wavelength multiplexing/demultiplexing element, provided at an optical output section of the light emitting element, for passing an optical signal of a specific wavelength and reflecting optical signals having other wavelengths than the specific wavelength and an optical coupling section for optically coupling an input optical fiber and an output optical fiber to the wavelength multiplexing/demultiplexing element, and

optical fiber means for connecting the wavelength multiplexing/demultiplexing element of the first optical receiving section to the optical coupling section of the first optical transmitting section, connecting the optical coupling section of the first optical transmitting section to the wavelength multiplexing/demultiplexing element of the second optical receiving section, making similar connections thereafter and connecting the wavelength multiplexing/demultiplexing element of the first optical receiving section to an optical connector;

(b) a second optical transmitting/receiving apparatus having a same structure as the first optical transmitting/receiving apparatus; and

(c) a single transfer optical fiber for connecting the first optical transmitting/receiving apparatus and the second optical transmitting/receiving apparatus together.

According to the sixth aspect of the invention, there is provided an optical transmitting/receiving apparatus comprising:

first to n-th optical receiving sections (n being an integer equal to or greater than 2) each including a receiver module having a wavelength multiplexing/demultiplexing element for passing an optical signal of a specific wavelength and reflecting optical signals having other wavelengths than the specific wavelength and a light receiving element for converting output light from the wavelength multiplexing/demultiplexing element to an electric signal, and an electric circuit for converting an output electric signal from the receiver module into a predetermined form and/or level and outputting the output electric signal;

first to n-th optical transmitting sections each including an electric circuit for converting an electric signal to be input into a predetermined form and/or level and outputting the electric signal, and a transmitter module equipped in a single module with a light emitting element for converting the output electric signal from the electric circuit to an optical signal, a wavelength multiplexing/demultiplexing element, at an optical output section of the light emitting element, for passing an optical signal of a specific wavelength and reflecting optical signals having other wavelengths than the specific wavelength and an optical coupling section for optically coupling an input optical fiber and an output optical fiber to the wavelength multiplexing/demultiplexing element;

first optical fiber means for sequentially connecting the wavelength multiplexing/demultiplexing elements of the first to n-th optical receiving sections one to another and connecting the wavelength multiplexing/demultiplexing element of the first optical receiving section to the optical coupling section of the n-th optical transmitting section; and

second optical fiber means for sequentially connecting the optical coupling sections of the first to n-th optical transmitting sections one to another and connecting the optical coupling section of the first optical transmitting section to an optical connector, whereby output light from any optical transmitting section which has a large optical output level is prevented from being input to an associated one of the optical receiving sections.

According to the seventh aspect of the invention, there is provided an optical transfer system for bidirectionally transferring data of a plurality of different signal forms in a form of a wavelength multiplexed signal, comprising:

(a) a first optical transmitting/receiving apparatus having

first to n-th optical receiving sections (n being an integer equal to or greater than 2) each including a receiver module having a wavelength multiplexing/demultiplexing element for passing an optical signal of a specific wavelength and reflecting optical signals having other wavelengths than the specific wavelength and a light receiving element for converting output light from the wavelength multiplexing/demultiplexing element to an electric signal, and an electric circuit for converting an output electric signal from the receiver module into a predetermined form and/or level and outputting the output electric signal,

first to n-th optical transmitting sections each including an electric circuit for converting an electric signal to be input into a predetermined form and/or level and outputting the electric signal, and a transmitter module equipped in a single module with a light emitting element for converting the output electric signal from the electric circuit to an optical signal, a wavelength multiplexing/demultiplexing element, provided at an optical output section of the light emitting element, for passing an optical signal of a specific wavelength and reflecting optical signals having other wavelengths than the specific wavelength and an optical coupling section for optically coupling an input optical fiber and an output optical fiber to the wavelength multiplexing/demultiplexing element, all into a single module,

first optical fiber means for sequentially connecting the wavelength multiplexing/demultiplexing elements of the first to n-th optical receiving sections one to another and connecting the wavelength multiplexing/demultiplexing element of the first optical receiving section to the optical coupling section of the n-th optical transmitting section, and

second optical fiber means for sequentially connecting the optical coupling sections of the first to n-th optical transmitting sections one to another and connecting the optical coupling section of the first optical transmitting section to an optical connector, whereby output light from any optical transmitting section which has a large optical output level is prevented from being input to an associated one of the optical receiving sections.

(b) a second optical transmitting/receiving apparatus having a same structure as the first optical transmitting/receiving apparatus; and

(c) a single transfer optical fiber for connecting the first optical transmitting/receiving apparatus and the second optical transmitting/receiving apparatus together.

In the seventh aspect, the specific wavelengths of the wavelength multiplexing/demultiplexing elements of the first to n-th optical receiving sections of the first optical transmitting/receiving apparatus may differ from one another and may be set equal to the specific wavelengths of the wavelength multiplexing/demultiplexing elements of the n-th to first optical transmitting sections of the second optical transmitting/receiving apparatus (third modification).

In the seventh aspect, the specific wavelengths in the first to n-th optical receiving sections of the first optical transmitting/receiving apparatus may differ from one another and may be set equal to the specific wavelengths of the wavelength multiplexing/demultiplexing elements of the n-th to first optical transmitting sections of the second optical transmitting/receiving apparatus, and the specific wavelengths in the first to n-th optical transmitting sections of the first optical transmitting/receiving apparatus may differ from one another and may be set equal to the specific wavelengths of the wavelength multiplexing/demultiplexing elements of the n-th to first optical transmitting sections of the second optical transmitting/receiving apparatus.

According to the eighth aspect of the invention, there is provided an optical receiving apparatus comprising a plurality of optical receiving sections each including:

an optical coupler for splitting an optical signal input from a transfer optical fiber to two;

a receiver module equipped in a single module with a light receiving element, two wavelength multiplexing/demultiplexing elements provided at an optical output section of the light receiving element and an optical coupling section for optically coupling two pairs of optical fibers each pair having an input optical fiber and an output optical fiber; and

an electric processing circuit for converting an output electric signal from the receiver module into a demanded signal form or signal level and outputting the electric signal,

wherein one output of the optical coupler is connected to the input optical fiber in the first optical fiber pair of the first optical receiving section, the other optical receiving sections are sequentially connected to one another by the first optical fiber pairs, the other output of the optical coupler is connected to the input optical fiber of the second optical fiber pair of that optical receiving section which is located last in sequential connection using the first optical fiber pairs, and sequential connection is made by the second optical fiber pairs, so that if one of the optical receiving sections fails and is removed, the other optical receiving sections are not influenced.

According to the ninth aspect of the invention, there is provided an optical transmitting apparatus comprising a plurality of optical transmitting sections each including:

an optical coupler for combining two optical signals and outputting a combined signal to a transfer optical fiber;

a transmitter module equipped in a single module with a light emitting element, two wavelength multiplexing/demultiplexing elements provided at an optical output section of the light emitting element and an optical coupling section for optically coupling two pairs of optical fibers each pair having an input optical fiber and an output optical fiber; and

an electric processing circuit for converting a form or level of an input signal to a one required by the transmitter module,

wherein one input of the optical coupler is connected to the output optical fiber in the first optical fiber pair of the first optical transmitting section, the other optical transmitting sections are sequentially connected to one another by the first optical fiber pairs, the other input of the optical coupler are connected to the output optical fiber of the second optical fiber pair of that optical transmitting section which is located last in sequential connection using the first optical fiber pairs, and sequential connection is made by the second optical fiber pairs, so that if one of the optical transmitting sections fails and is removed, the other optical transmitting sections are not influenced.

According to the tenth aspect of the invention, there is provided an optical transmitting/receiving apparatus comprising a plurality of optical transmitting/receiving sections each including an optical coupler for splitting and combining an input optical signal from a transfer optical fiber and an output optical signal to a transfer optical fiber, having an output optical fiber in a first optical fiber pair of an optical receiving section supplied to connected to an output optical fiber in a first optical fiber pair of an optical transmitting section and having an output optical fiber in a second optical fiber pair of the optical receiving section supplied to connected to an output optical fiber in a second optical fiber pair of the optical transmitting section,

wherein one of two inputs/outputs of the optical coupler is connected to the first optical fiber pair of the first optical transmitting/receiving section to sequentially connect plural optical transmitting/receiving sections to one another by the first optical fiber pairs, and the other input/output of the optical coupler is sequentially connected by the second optical fiber pairs, so that if one of the optical transmitting/receiving sections fails and is removed, the other optical transmitting/receiving sections are not influenced.

According to the eleventh aspect of the invention, there is provided an optical transmitting/receiving apparatus comprising a plurality of optical transmitting/receiving sections each including a wavelength multiplexing/demultiplexing coupler for splitting an optical signal input from a transfer optical fiber to two different optical fibers in accordance with wavelength components of the optical signal and combining optical signals of different wavelength components input from two different optical fibers, first and second optical couplers connected to the two optical fibers of the wavelength multiplexing/demultiplexing coupler, an optical receiving section and an optical transmitting section,

wherein one optical fiber of the first optical coupler is connected to a first optical fiber pair of the optical receiving section of the first optical transmitting/receiving section to sequentially connect plural optical receiving sections to one another by the first optical fiber pairs, the other optical fiber of the first optical coupler is connected to a second optical fiber pair of an end one of the optical receiving sections sequentially connected by the first optical fiber pairs to sequentially connect the other optical receiving sections by the second optical fiber pairs, one optical fiber of the second optical coupler is connected to a first optical fiber pair of the optical transmitting section of the first optical transmitting/receiving section to sequentially connect plural optical transmitting sections to one another by the first optical fiber pairs, the other optical fiber of the second optical coupler is connected to a second optical fiber pair of an end one of the optical transmitting sections sequentially connected by the first optical fiber pairs to sequentially connect the other optical transmitting sections by the second optical fiber pairs, so that if one of the optical transmitting/receiving sections fails and is removed, the other optical transmitting/receiving sections are not influenced.

According to the twelfth aspect of the invention, there is provided an optical transmitting/receiving apparatus comprising a plurality of optical transmitting/receiving sections each including first and second wavelength multiplexing/demultiplexing couplers connected to two different optical fibers of an optical coupler for splitting an optical signal input from a transfer optical fiber to two and combining two optical signals to be output to the transfer optical fiber, an optical receiving section and an optical transmitting section,

wherein one optical fiber of the first wavelength multiplexing/demultiplexing coupler is connected to a first optical fiber pair of the optical receiving section of the first optical transmitting/receiving section to sequentially connect plural optical receiving sections to one another by the first optical fiber pairs, one optical fiber of the second optical coupler is connected to a second optical fiber pair of an end one of the optical receiving sections sequentially connected by the first optical fiber pairs to sequentially connect the other optical receiving sections by the second optical fiber pairs, the other optical fiber of the second wavelength multiplexing/demultiplexing coupler is connected to a first optical fiber pair of the optical transmitting section of the first optical transmitting/receiving section to sequentially connect plural optical transmitting sections to one another by the first optical fiber pairs, the other optical fiber of the second wavelength multiplexing/demultiplexing coupler is connected to a second optical fiber pair of an end one of the optical transmitting sections sequentially connected by the first optical fiber pairs to sequentially connect the other optical transmitting sections by the second optical fiber pairs, so that if one of the optical transmitting/receiving sections fails and is removed, the other optical transmitting/receiving sections are not influenced.

According to the thirteenth aspect of the invention, there is provided an optical transfer system for bidirectionally transferring data of a plurality of different signal forms in a form of a wavelength multiplexed signal, comprising:

an optical transmitting apparatus having a plurality of optical transmitting sections each including an optical coupler for combining two optical signals and outputting a combined signal to a transfer optical fiber, a transmitter module equipped in a single module with a light emitting element, two wavelength multiplexing/demultiplexing elements provided at an optical output section of the light emitting element and an optical coupling section for optically coupling two pairs of optical fibers each pair having an input optical fiber and an output optical fiber, and an electric processing circuit for converting a form or level of an input signal to a one required by the transmitter module, wherein one input of the optical coupler is connected to the output optical fiber in the first optical fiber pair of the first optical transmitting section, the other optical transmitting sections are sequentially connected to one another by the first optical fiber pairs, the other input of the optical coupler are connected to the output optical fiber of the second optical fiber pair of that optical transmitting section which is located last in sequential connection using the first optical fiber pairs, and sequential connection is made by the second optical fiber pairs, so that if one of the optical transmitting sections fails and is removed, the other optical transmitting sections are not influenced;

an optical receiving apparatus having a plurality of optical receiving sections each including an optical coupler for splitting an optical signal input from a transfer optical fiber to two, a receiver module equipped in a single module with a light receiving element, two wavelength multiplexing/demultiplexing elements provided at an optical output section of the light receiving element and an optical coupling section for optically coupling two pairs of optical fibers each pair having an input optical fiber and an output optical fiber, and an electric processing circuit for converting an output electric signal from the receiver module into a demanded signal form or signal level and outputting the electric signal, wherein one output of the optical coupler is connected to the input optical fiber in the first optical fiber pair of the first optical receiving section, the other optical receiving sections are sequentially connected to one another by the first optical fiber pairs, the other output of the optical coupler is connected to the input optical fiber of the second optical fiber pair of that optical receiving section which is located last in sequential connection using the first optical fiber pairs, and sequential connection is made by the second optical fiber pairs, so that if one of the optical receiving sections fails and is removed, the other optical receiving sections are not influenced;

a single transfer optical fiber for connecting the optical transmitting apparatus and the optical receiving apparatus together.

According to the fourteenth aspect of the invention, there is provided an optical transfer system which has two optical transmitting/receiving apparatuses of the tenth aspect, the eleventh aspect or the twelfth aspect by a single transfer optical fiber and bidirectionally transfers data of a plurality of different signal forms in a form of a wavelength multiplexed signal.

According to the fifteenth aspect of the invention, there is provided a compact optical transmitting/receiving apparatus comprising a plurality of optical transmitting/receiving sections each including:

an optical coupler for splitting an optical signal input from a transfer optical fiber to two;

a transmitter/receiver module equipped in a single module with a light receiving element, a light emitting element, a light receiving element, optical coupler elements for combining optical signals at an optical input section of the light receiving element and at an optical output section of the light emitting element, two wavelength multiplexing/demultiplexing elements and an optical coupling section for optically coupling two pairs of optical fibers each pair having an input optical fiber and an output optical fiber;

an electric processing circuit for converting an output electric signal from the transmitter/receiver module into a demanded signal form or signal level and outputting the electric signal; and

an electric processing circuit for converting an input electric signal to a signal needed by the light emitting element,

wherein one output of the optical coupler is connected to the input optical fiber in the first optical fiber pair of the first optical transmitting/receiving section, the other optical transmitting/receiving sections are sequentially connected to one another by the first optical fiber pairs, the other output of the optical coupler is connected to the input optical fiber of the second optical fiber pair of that optical transmitting/receiving section which is located last in sequential connection using the first optical fiber pairs, and sequential connection is made by the second optical fiber pairs, so that if one of the optical receiving sections fails and is removed, the other optical receiving sections are not influenced.

According to the sixteenth aspect of the invention, there is provided an optical transfer system for bidirectionally transferring data of a plurality of different signal forms in a form of a wavelength multiplexed signal, comprising:

a first compact optical transmitting/receiving apparatus comprising a plurality of optical transmitting/receiving sections each including an optical coupler for splitting an optical signal input from a transfer optical fiber to two, a transmitter/receiver module equipped in a single module with a light receiving element, a light emitting element, a light receiving element, optical coupler elements for combining optical signals at an optical input section of the light receiving element and at an optical output section of the light emitting element, two wavelength multiplexing/demultiplexing elements and an optical coupling section for optically coupling two pairs of optical fibers each pair having an input optical fiber and an output optical fiber, an electric processing circuit for converting an output electric signal from the transmitter/receiver module into a demanded signal form or signal level and outputting the electric signal, and an electric processing circuit for converting an input electric signal to a signal needed by the light emitting element, wherein one output of the optical coupler is connected to the input optical fiber in the first optical fiber pair of the first optical transmitting/receiving section, the other optical transmitting/receiving sections are sequentially connected to one another by the first optical fiber pairs, the other output of the optical coupler is connected to the input optical fiber of the second optical fiber pair of that optical transmitting/receiving section which is located last in sequential connection using the first optical fiber pairs, and sequential connection is made by the second optical fiber pairs, so that if one of the optical receiving sections fails and is removed, the other optical receiving sections are not influenced;

a second optical transmitting/receiving apparatus having a same structure as the first optical transmitting/receiving apparatus; and

a single transfer optical fiber for connecting the first optical transmitting/receiving apparatus and the second optical transmitting/receiving apparatus together.

In any of the fifth, seventh, fourteenth and sixteenth aspects and the fourth modification, The optical transfer system according to any one of claims 7, 9, 11, 18 and 20, the optical transfer system may further comprise at least one of an IP router for performing packet exchange, a video signal source for a plurality of channels multiplexed by frequency multiplexing, an ATM multiplexer/demultiplexer for multiplexing and demultiplexing an ATM signal and an STM multiplexer/demultiplexer for multiplexing and demultiplexing an STM signal, whereby service interfacing with plurality of different signal forms is possible.

### BRIEF DESCRIPTION OF THE DRAWINGS

FIG. 1 is a block diagram of a WDM optical receiving apparatus according to a first embodiment of the invention;

FIG. 2 is a block diagram of a WDM optical receiver module according to the first embodiment of the invention;

FIG. 3 is a block diagram of a WDM optical transmitting apparatus according to a second embodiment of the invention;

FIG. 4 is a block diagram of a WDM optical transmitter module according to the second embodiment of the invention;

FIG. 5 is a block diagram of a WDM optical transmitting/receiving apparatus according to a third embodiment of the invention;

FIG. 6 is a block diagram of a WDM optical transfer system according to a fourth embodiment of the invention;

FIG. 7 is a block diagram of a one-fiber bidirectional WDM optical transfer system according to a fifth embodiment of the invention;

FIG. 8 is a block diagram of a service multiplexed transfer system according to a sixth embodiment of the invention;

FIG. 9 is a block diagram of a WDM optical transmitting/receiving apparatus according to a seventh embodiment of the invention;

FIG. 10 is a block diagram of a one-fiber bidirectional WDM optical transfer system to an eighth embodiment of the invention;

FIG. 11 is a block diagram of a service multiplexed transfer system according to a ninth embodiment of the invention;

FIG. 12 is a block diagram of a WDM optical transfer system according to a tenth embodiment of the invention;

FIG. 13 is a block diagram of a one-fiber bidirectional WDM optical transfer system to an eleventh embodiment of the invention;

FIG. 14 is a block diagram of a service multiplexed transfer system according to a twelfth embodiment of the invention;

FIG. 15 is a block diagram of a WDM optical receiving apparatus according to a thirteenth embodiment of the invention;

FIG. 16 is a block diagram of a WDM optical receiver module according to the thirteenth embodiment of the invention;

FIG. 17 is a block diagram of a WDM optical transmitting apparatus according to a fourteenth embodiment of the invention;

FIG. 18 is a block diagram of a WDM optical transmitter module according to the fourteenth embodiment of the invention;

FIG. 19 is a block diagram of a WDM optical transmitting/receiving apparatus according to a fifteenth embodiment of the invention;

FIG. 20 is a block diagram of a WDM optical transmitting/receiving apparatus according to a sixteenth embodiment of the invention;

FIG. 21 is a block diagram of a WDM optical transmitting/receiving apparatus according to a seventeenth embodiment of the invention;

FIG. 22 is a block diagram of a WDM optical transfer system to an eighteenth embodiment of the invention;

FIG. 23 is a block diagram of a one-fiber bidirectional WDM optical transfer system according to a nineteenth embodiment of the invention;

FIG. 24 is a block diagram of a service multiplexed transfer system according to a twentieth embodiment of the invention;

FIG. 25 is a block diagram of a WDM optical transmitting/receiving apparatus according to a twenty-first embodiment of the invention;

FIG. 26 is a block diagram of a WDM optical transmitter/receiver module according to the twenty-first embodiment of the invention;

FIG. 27 is a block diagram of a one-fiber bidirectional WDM optical transfer system according to a twenty-second embodiment of the invention;

FIG. 28 is a block diagram of a service multiplexed transfer system according to a twenty-third embodiment of the invention;

FIG. 29 is a block diagram of a conventional WDM optical receiving apparatus;

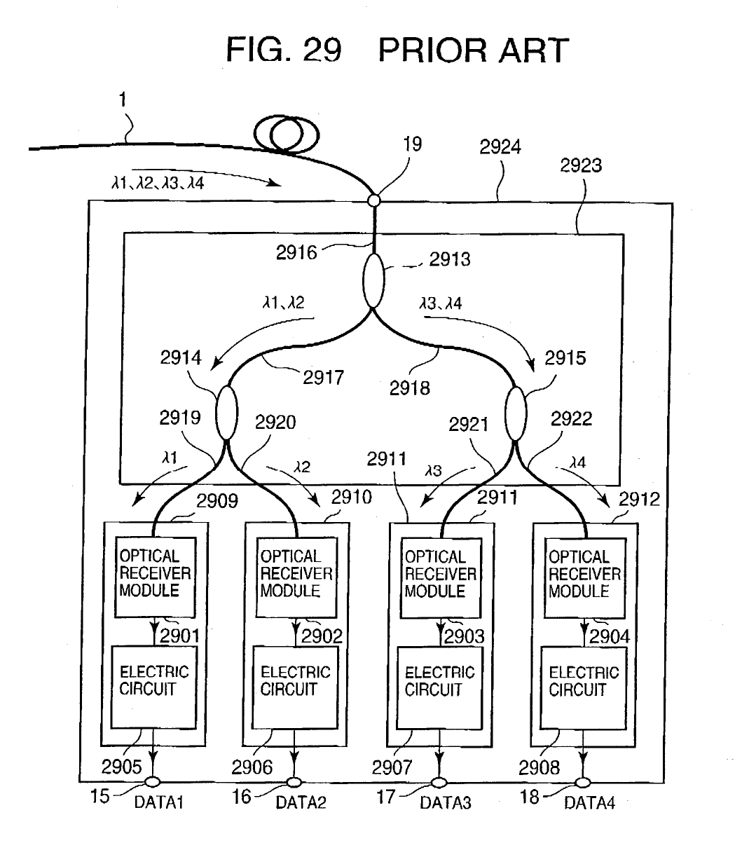

FIG. 30 is a block diagram of a conventional optical receiver module;

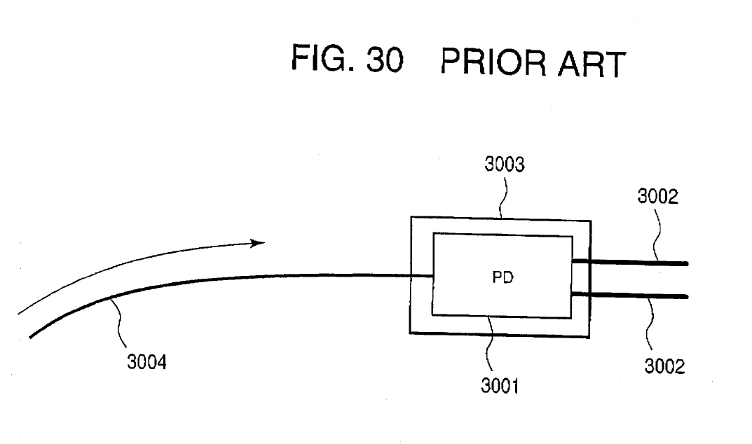

FIG. 31 is a block diagram of a conventional WDM optical transmitting apparatus;

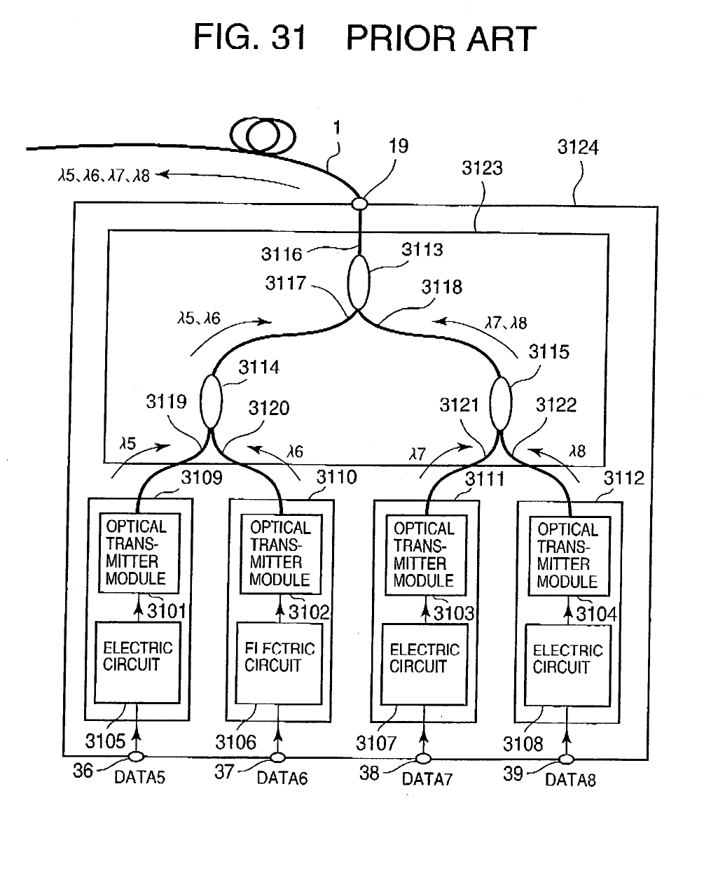

FIG. 32 is a block diagram of a conventional optical transmitter module; and

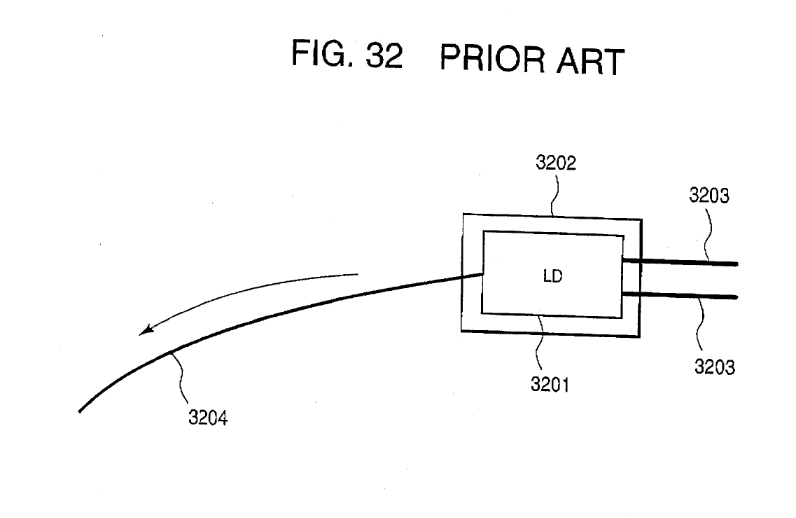

FIG. 33 is a block diagram of a conventional WDM optical transmitting/receiving apparatus.

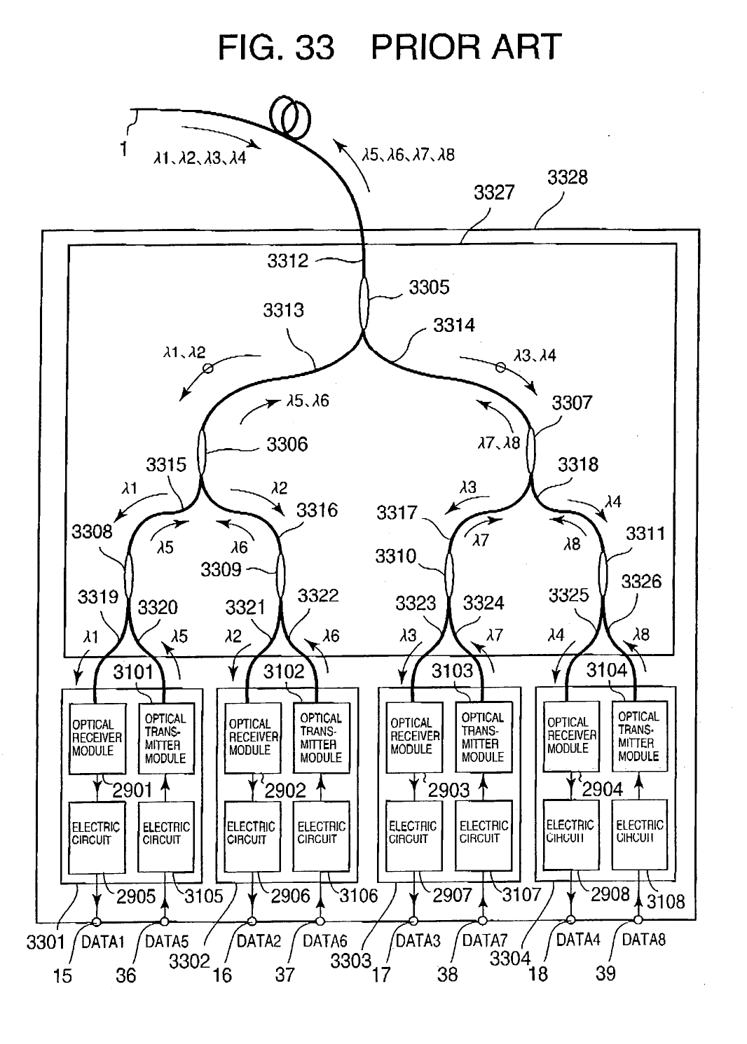

### DETAILED DESCRIPTION OF THE PREFERRED EMBODIMENTS

The invention will now be described referring to the accompanying drawings. Although the number of wavelength multiplexing stages of this type of WDM optical receiving apparatus and the types of input/output data should be arbitrary, a case where the number of wavelength multiplexing stages is four and the types of input/output data are four will be illustrated and discussed hereinafter for the sake of simplifying the description. It should be easy for those skilled in the art to anticipate and realize setting the number of wavelength multiplexing stages and the types of input/output data greater than four.

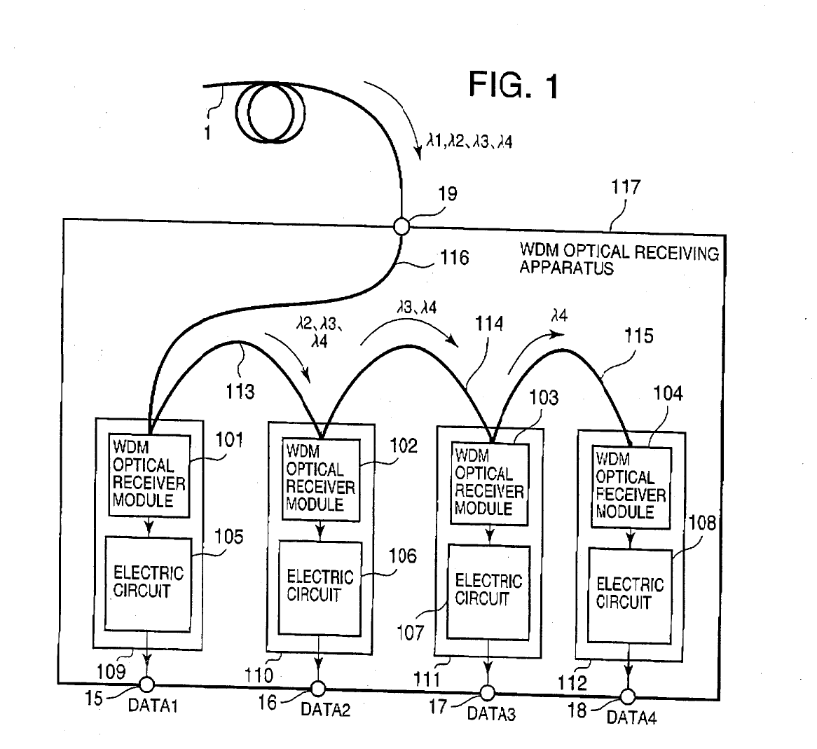

FIG. 1 shows the first embodiment of the invention. FIG. 1 is a block diagram of a WDM (Wavelength Division Multiplexing) optical receiving apparatus 117. A transfer optical fiber 1 whose one end is connected to an external unit has the other end connected to an optical connector 19 provided in the WDM optical receiving apparatus 117. Optical signals of four different types of wavelengths (λ1, λ2, λ3, λ4) are multiplexed in the transfer optical fiber 1 and are input to the WDM optical receiving apparatus 117. Intraconnection optical fibers 113, 114, 115 and 116 are provided to optically connect the components inside the apparatus to one another. In this embodiment, four WDM optical receiver modules 101, 102, 103 and 104 are provided. Throughout the present specification, the mode of sequentially connecting elements, such as the optical fibers 113, 114 and 115 shown in FIG. 1, in such a way that one element is connected to another element, which is further connected to a different element as shown in FIG. 1 is said to be “sequential connection”. The WDM optical receiver module 101 outputs a current signal corresponding to the optical signal power of the wavelength λ1, the WDM optical receiver module 102 outputs a current signal corresponding to the optical signal power of the wavelength λ2, the WDM optical receiver module 103 outputs a current signal corresponding to the optical signal power of the wavelength λ3 and the WDM optical receiver module 104 outputs a current signal corresponding to the optical signal power of the wavelength λ4.

The intraconnection optical fiber 116 which is the input optical fiber of the WDM optical receiver module 101 is connected to the transfer optical fiber 1 via the optical connector 19, the intraconnection optical fiber 113 or the input optical fiber of the WDM optical receiver module 102 is connected to the WDM optical receiver module 101, the intraconnection optical fiber 114 or the input optical fiber of the WDM optical receiver module 103 is connected to the WDM optical receiver module 102, and the intraconnection optical fiber 115 or the input optical fiber of the WDM optical receiver module 104 is connected to the WDM optical receiver module 103. Four electric processing circuits for the WDM optical receiver modules (hereinafter simply called “electric processing circuits” or “electric circuits”) 105, 106, 107 and 108 are provided in association with the four WDM optical receiver modules 101 to 104 and convert current signals output from the WDM optical receiver modules 101 to 104 to demanded signal forms or signal levels. The optical receiving sections 109 to 112 respectively comprise pairs of the associated WDM receiver modules 101 to 104 and the associated electric processing circuits 105 to 108. Electric connectors 15, 16, 17 and 18 are provided to send output signals to outside.

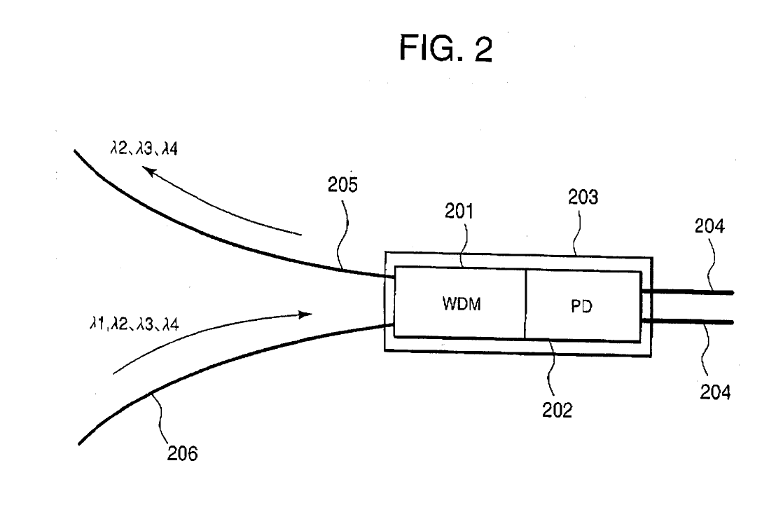

FIG. 2 is a block diagram of the WDM optical receiver module according to the first embodiment of the invention. Reference numerals “205” and “206” in FIG. 2 are intraconnection optical fibers. A wavelength multiplexing/demultiplexing element (WDM) 201 which passes an optical signal of a specific wavelength and reflects optical signals of the other wavelengths is connected to a light receiving element (PD) 202. Electric interconnection leads 204 are connected to the light receiving element 202. The wavelength multiplexing/demultiplexing element 201 is optically coupled to two intraconnection optical fibers 205 and 206, and the light receiving element 202 is optically coupled to the wavelength multiplexing/demultiplexing element 201 and electrically connected to the electric interconnection leads 204, thereby constituting a WDM optical receiver module 203. Although the description on FIG. 2 discusses a case where an optical signal with a wavelength λ1 is received, the WDM optical receiver module 102 which receives the wavelength λ2, the WDM optical receiver module 103 which receives the wavelength λ3 and the WDM optical receiver module 104 which receives the wavelength λ4 also have the same structure except for the wavelength characteristics of the associated wavelength multiplexing/demultiplexing elements.

The operation of the first embodiment of the invention will be discussed below. Of the optical signals with the four wavelengths λ1, λ2, λ3 and λ4 input to the WDM optical receiving apparatus 117 in FIG. 1, only the optical signal of the wavelength λ1 is converted to an electric signal by the WDM optical receiver module 101 and DATA1 is reproduced and output by the electric processing circuit 105. Meanwhile, the optical signals with the wavelengths λ2, λ3 and λ4 are input to the WDM optical receiver module 102 from the WDM optical receiver module 101, and only the optical signal of the wavelength λ2 is converted to an electric signal by the WDM optical receiver module 102 and DATA2 is reproduced and output by the electric processing circuit 106. Further, the optical signals with the four wavelengths λ3 and λ4 are input to the WDM optical receiver module 103 from the WDM optical receiver module 102, and only the optical signal of the wavelength λ3 is converted to an electric signal by the WDM optical receiver module 103 and DATA3 is reproduced and output by the electric processing circuit 107. Furthermore, the optical signal of the wavelength λ4 is input to the WDM optical receiver module 104 from the WDM optical receiver module 103, and converted to an electric signal by the WDM optical receiver module 104 and DATA4 is reproduced and output by the electric processing circuit 108. Apparently, the first embodiment of the invention can eliminate the wavelength multiplexing/demultiplexing section as compared with the conventional optical receiving apparatus and can provide an excellent WDM optical receiving apparatus which is prevented from becoming larger even if the number of wavelength multiplexing stages is increased.

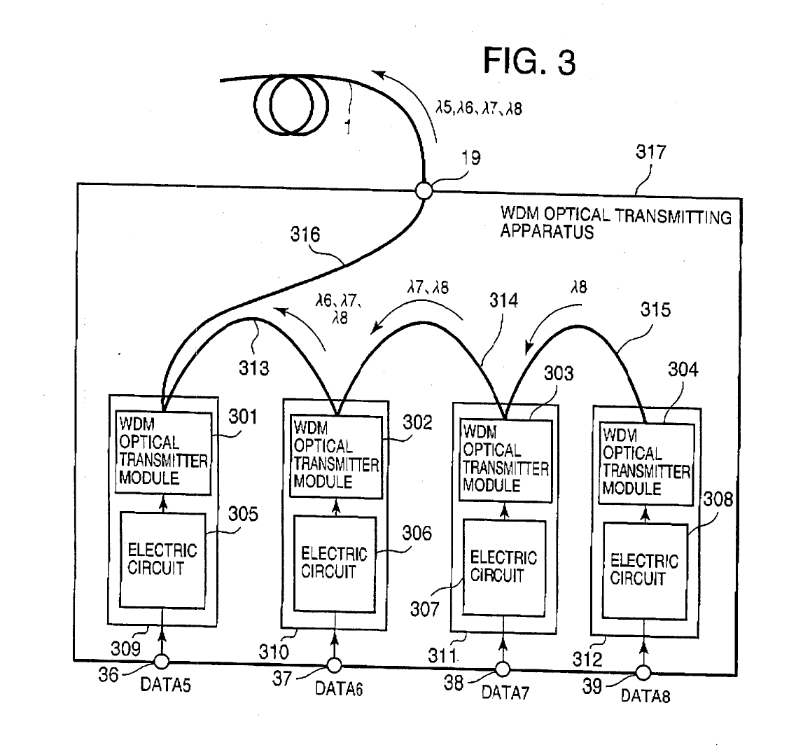

FIG. 3 shows the second embodiment of the invention. FIG. 3 is a block diagram of a WDM optical transmitting apparatus 317. In FIG. 3 and the subsequent diagrams, same reference symbols are used for the constituting elements which are the same as or correspond to those shown in FIG. 1 to avoid repeating their descriptions. A WDM optical transmitting apparatus 317 multiplexes optical signals with wavelengths (λ5, λ6, λ7, λ8) and outputs the multiplexed optical signal. Intraconnection optical fibers 313, 314, 315 and 316 optically connect the components inside the apparatus to one another. Reference numerals “301”, “302”, “303” and “304” are WDM optical transmitter modules. The intraconnection optical fiber 316 or the output optical fiber of the WDM optical transmitter module 301 is connected to the transfer optical fiber 1 via the optical connector 19. The intraconnection optical fiber 313 or the output optical fiber of the WDM optical transmitter module 302 is connected to the WDM optical transmitter module 301. The intraconnection optical fiber 314 or the output optical fiber of the WDM optical transmitter module 303 is connected to the WDM optical transmitter module 302. The intraconnection optical fiber 315 or the output optical fiber of the WDM optical transmitter module 304 is connected to the WDM optical transmitter module 303. The WDM optical transmitter module 304 outputs an optical signal of the wavelength λ8, the WDM optical transmitter module 303 outputs an optical signal of the wavelength λ7 in addition to the input optical signal of the wavelength λ8, the WDM optical transmitter module 302 outputs an optical signal of the wavelength λ6 in addition to the input optical signal with the wavelengths λ8 and λ7, and the WDM optical transmitter module 301 outputs an optical signal of the wavelength λ5 in addition to the input optical signal with the wavelengths λ8, λ7 and λ6.

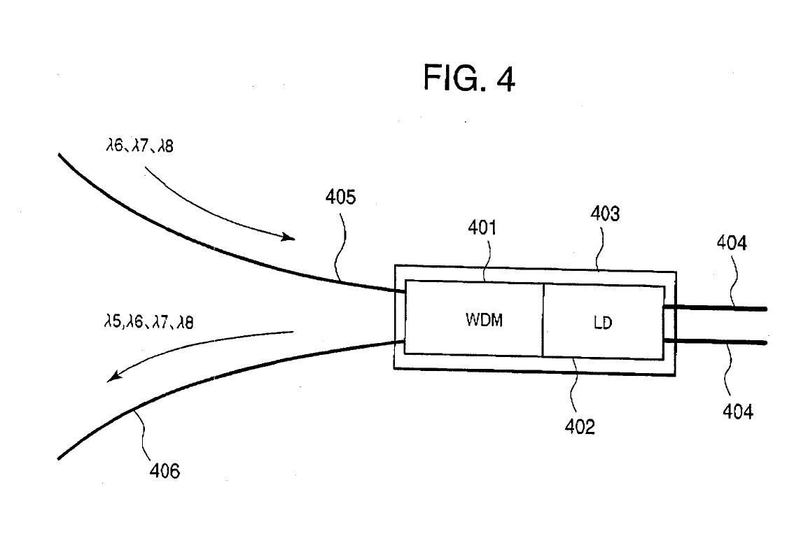

Electric processing circuits 305, 306, 307 and 308 convert input electric signals to current signals needed by the WDM optical transmitter modules 301, 302, 303 and 304. Optical transmitting sections 309, 310, 311 and 312 respectively comprise the associated WDM optical transmitter modules 301, 302, 303 and 304 and the associated electric processing circuits 305 to 308. Reference numerals “36”, 1137”, “38” and “39” denote electric connectors. FIG. 4 is a block diagram of the WDM optical transmitter module according to the second embodiment of the invention. Reference numerals “405” and “406” in FIG. 4 are intraconnection optical fibers. A wavelength multiplexing/demultiplexing element 401 which passes an optical signal of a specific wavelength and reflects optical signals of the other wavelengths is connected to a light emitting element 402. Reference numeral “404” denotes an electric interconnection lead. The wavelength multiplexing/demultiplexing element 401 is optically coupled to two intraconnection optical fibers 405 and 406, and the light emitting element 402 is optically coupled to the wavelength multiplexing/demultiplexing element 401 and electrically connected to the electric interconnection leads 404, thereby constituting a WDM optical transmitter module 403. Although the description on FIG. 4 discusses a case where an optical signal with a wavelength λ5 is transmitted, the WDM optical transmitter module 302 which transmits the wavelength λ6, the WDM optical transmitter module 303 which transmits the wavelength λ7 and the WDM optical transmitter module 304 which transmits the wavelength λ8 also have the same structure except for the wavelength characteristics of the associated wavelength multiplexing/demultiplexing elements.

The operation of the second embodiment of the invention will be discussed below. The electric processing circuit 308 converts the electric signal of the DATA8 input to the optical transmitting section 312 to an current signal needed by the WDM optical transmitter module 304. The WDM optical transmitter module 304 then converts the current signal to an optical signal of the wavelength λ8 and outputs the signal to the WDM optical transmitter module 303. The electric processing circuit 307 converts the electric signal of the DATA7 input to the optical transmitting section 311 to an current signal needed by the WDM optical transmitter module 303. The WDM optical transmitter module 303 then converts the current signal to an optical signal of the wavelength λ7 and outputs the signal together with the optical signal of the wavelength λ8, input from the WDM optical transmitter module 304, to the WDM optical transmitter module 302. The electric processing circuit 306 converts the electric signal of the DATA6 input to the optical transmitting section 310 to an current signal needed by the WDM optical transmitter module 302. The WDM optical transmitter module 302 then converts the current signal to an optical signal of the wavelength λ6 and outputs the signal together with the optical signal of the wavelengths λ7 and λ8, input from the WDM optical transmitter module 303, to the WDM optical transmitter module 301. The electric processing circuit 305 converts the electric signal of the DATA5 input to the optical transmitting section 309 to an current signal needed by the WDM optical transmitter module 301. The WDM optical transmitter module 301 then converts the current signal to an optical signal of the wavelength λ5 and outputs the signal together with the optical signal of the wavelengths λ6, λ7 and λ8, input from the WDM optical transmitter module 302, to the transfer optical fiber 1 via the optical connector 19. As apparent from the above, the second embodiment of the invention can eliminate the wavelength multiplexing/demultiplexing section as compared with the conventional optical transmitting apparatus and can provide an excellent WDM optical transmitting apparatus which is prevented from becoming larger even if the number of wavelength multiplexing stages is increased.

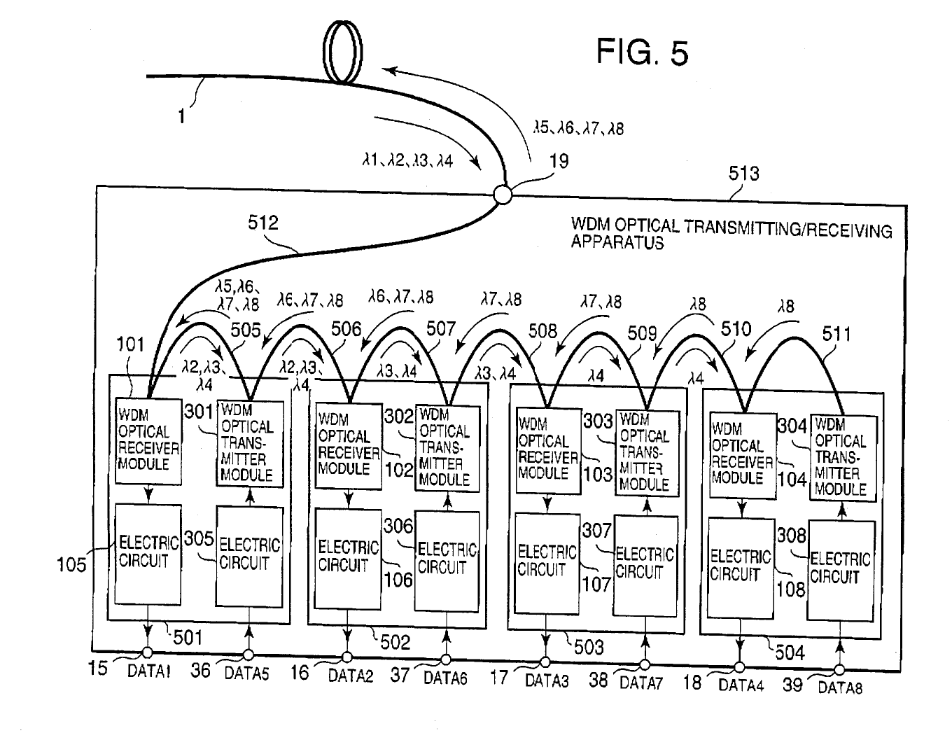

FIG. 5 shows the third embodiment of the invention. Reference numeral “513” in FIG. 5 is a WDM optical transmitting/receiving apparatus. The WDM optical transmitting/receiving apparatus 513 receives an optical signal with four wavelengths (λ1, λ2, λ3, λ4) from the transfer optical fiber 1 and multiplexes optical signals with wavelengths (λ5, λ6, λ7, λ8) and outputs the multiplexed optical signal to the transfer optical fiber 1. Intraconnection optical fibers 505, 506, 507, 508, 509, 510, 511 and 512 optically connect the components inside the apparatus to one another. Reference numerals “101”, “102”, “103” and “104” are WDM optical receiver modules which output currents corresponding to the input optical signal powers. Reference numerals “301”, “302”, “303” and “304” are WDM optical transmitter modules which output optical signals corresponding to the input currents. Reference numerals “105”, “106”, “107”, “108”, “305”, “306”, “307” and “308” are electric processing circuits. Optical transmitting/receiving sections 501, 502, 503 and 504 respectively comprise the associated WDM optical receiver modules 101, 102, 103 and 104, the associated WDM optical transmitter modules 301, 302, 303 and 304 and the associated electric processing circuits 105, 106, 107, 108, 305, 306, 307 and 308. Reference numerals electric “15”, “16”, “17”, “18”, “36”, “37”, “38” and “39” are electric connectors. The transfer optical fiber 1 is connected to the intraconnection optical fiber 512 or the input optical fiber of the WDM optical receiver module 101 via the optical connector 19. The intraconnection optical fibers 505, 507, 509 and 511 or the output optical fibers of the WDM optical receiver modules 101, 102, 103 and 104 are respectively connected to the WDM optical transmitter modules 301, 302, 303 and 304, thereby constituting the optical transmitting/receiving sections 501, 502, 503 and 504, respectively. The intraconnection optical fibers 506, 508 and 510 or the input optical fibers of the WDM optical transmitter modules 301, 302 and 303 in the optical transmitting/receiving sections 501, 502 and 503 are respectively connected to the WDM optical receiver modules 102, 103 and 104, so that the optical transmitting/receiving sections 501, 502, 503 and 504 are sequentially connected to one another.

The operation will now be discussed. The DATA5 to DATA8 to be input to the WDM optical transmitting/receiving apparatus 513 in FIG. 5 are respectively converted optical signals with the wavelengths λ5, λ6, λ7 and λ8 by the electric processing circuits 305 to 308 and the WDM optical transmitter modules 301, 302, 303 and 304. The optical signal of the wavelength λ8 is input to the WDM optical receiver module 104 and is output directly to the WDM optical transmitter module 303. In the WDM optical transmitter module 303, the optical signal of the wavelength λ7 is added to the input optical signal of the wavelength λ8 and the resultant optical signal is input to the WDM optical receiver module 103 and directly output to the WDM optical transmitter module 302. In the WDM optical transmitter module 302, the optical signal of the wavelength λ6 is added to the input optical signal of the wavelengths λ7 and λ8 and the resultant optical signal is input to the WDM optical receiver module 102 and directly output to the WDM optical transmitter module 301. In the WDM optical transmitter module 301, the optical signal of the wavelength λ5 is added to the input optical signal of the wavelengths λ6, λ7 and λ8 and the resultant optical signal is input to the WDM optical receiver module 101 and directly output to the transfer optical fiber 1 via the optical connector 19. Meanwhile, of the optical signals with the four wavelengths λ1, λ2, λ3 and λ4 to be input, only the optical signal of the wavelength λ1 is converted to an electric signal by the WDM optical receiver module 101 and DATA1 is reproduced and output by the electric processing circuit 105, and the optical signals with the three wavelengths λ2, λ3 and λ4 are output to the WDM optical receiver module 102 via the WDM optical transmitter module 301. Of the optical signals with the wavelengths λ2, λ3 and λ4, only the optical signal of the wavelength λ2 is converted to an electric signal by the WDM optical receiver module 102 and DATA2 is reproduced and output by the electric processing circuit 106, and the optical signals with the two wavelengths λ3 and λ4 are input to the WDM optical receiver module 103 from the WDM optical receiver module 102 via the WDM optical transmitter module 302. Of the optical signals with the wavelengths λ3 and λ4, and only the optical signal of the wavelength λ3 is converted to an electric signal by the WDM optical receiver module 103 and DATA3 is reproduced and output by the electric processing circuit 107 and the optical signal of the wavelength λ4 is output to the WDM optical receiver module 104 from the WDM optical receiver module 103 via the WDM optical transmitter module 303. The optical signal with the wavelength λ4 is converted to an electric signal by the WDM optical receiver module 104 and DATA4 is reproduced and output by the electric processing circuit 108. As apparent from the above, the third embodiment of the invention can eliminate the wavelength multiplexing/demultiplexing section as compared with the conventional optical transmitting/receiving apparatus and can provide an excellent WDM optical transmitting/receiving apparatus which is prevented from becoming larger even if the number of wavelength multiplexing stages is increased.

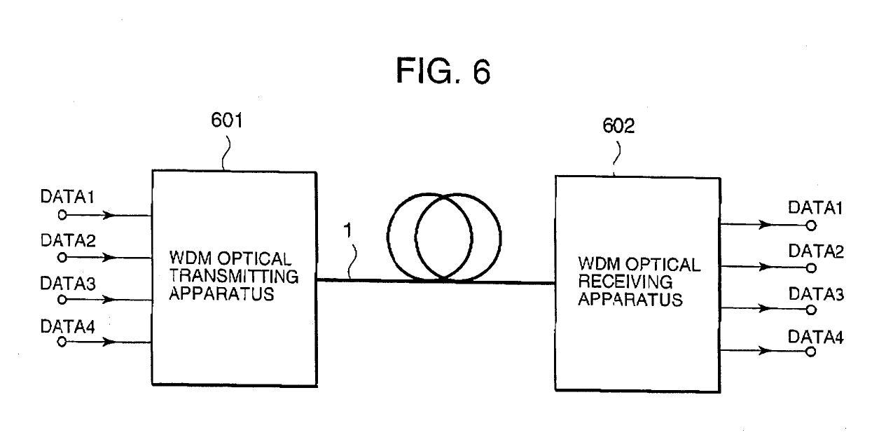

FIG. 6 illustrates an optical transfer system according to the fourth embodiment of the invention. In FIG. 6, “601” is the WDM optical transmitting apparatus according to the second embodiment of the invention, “602” is the WDM optical receiving apparatus according to the first embodiment of the invention, and the WDM optical transmitting apparatus 601 and the WDM optical receiving apparatus 602 are connected together by the transfer optical fiber 1.

The operation of the fourth embodiment of the invention will be discussed below. The DATA1, DATA2, DATA3 and DATA4 to be input to the WDM optical transmitting apparatus 601 are converted to optical signals with four wavelengths by the WDM optical transmitting apparatus 601. The optical signals with four wavelengths are transferred through a single transfer optical fiber to the WDM optical receiving apparatus 602. The WDM optical receiving apparatus 602 demultiplexes the four wavelengths and reproduces and outputs the DATA1, DATA2, DATA3 and DATA4. The fourth embodiment of the invention can apparently provide an optical transfer system comprising a compact WDM optical transmitting apparatus and a compact WDM optical receiving apparatus.

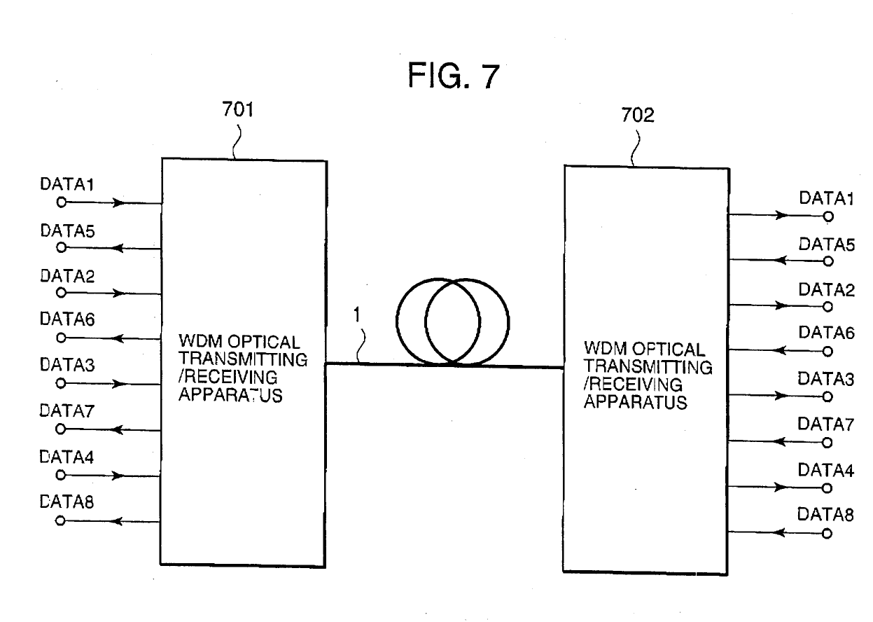

FIG. 7 illustrates a one-fiber bidirectional WDM optical transfer system according to the fifth embodiment of the invention. In FIG. 7, “701” and “702” denote the WDM optical transmitting/receiving apparatuses according to the third embodiment of the invention, which are connected together by the transfer optical fiber 1.

The operation of the fifth embodiment of the invention will be discussed below. The DATA1, DATA2, DATA3 and DATA4 to be input to the WDM optical transmitting/receiving apparatus 701 are converted to optical signals with four wavelengths by the WDM optical transmitting/receiving apparatus 701. The optical signals with four wavelengths are transferred through the single transfer optical fiber 1 to the WDM optical transmitting/receiving apparatus 702. The WDM optical transmitting/receiving apparatus 702 demultiplexes the four wavelengths and reproduces and outputs the DATA1, DATA2, DATA3 and DATA4. Meanwhile, the DATA5, DATA6, DATA7 and DATA8 to be input to the WDM optical transmitting/receiving apparatus 702 are converted to optical signals with four wavelengths by the WDM optical transmitting/receiving apparatus 702. The optical signals with four wavelengths are transferred through the single transfer optical fiber 1 to the WDM optical transmitting/receiving apparatus 701. The WDM optical transmitting/receiving apparatus 701 demultiplexes the four wavelengths and reproduces and outputs the DATA5, DATA6, DATA7 and DATA8. The fifth embodiment of the invention can apparently provide a one-fiber bidirectional WDM optical transfer system comprising compact WDM optical transmitting/receiving apparatuses.

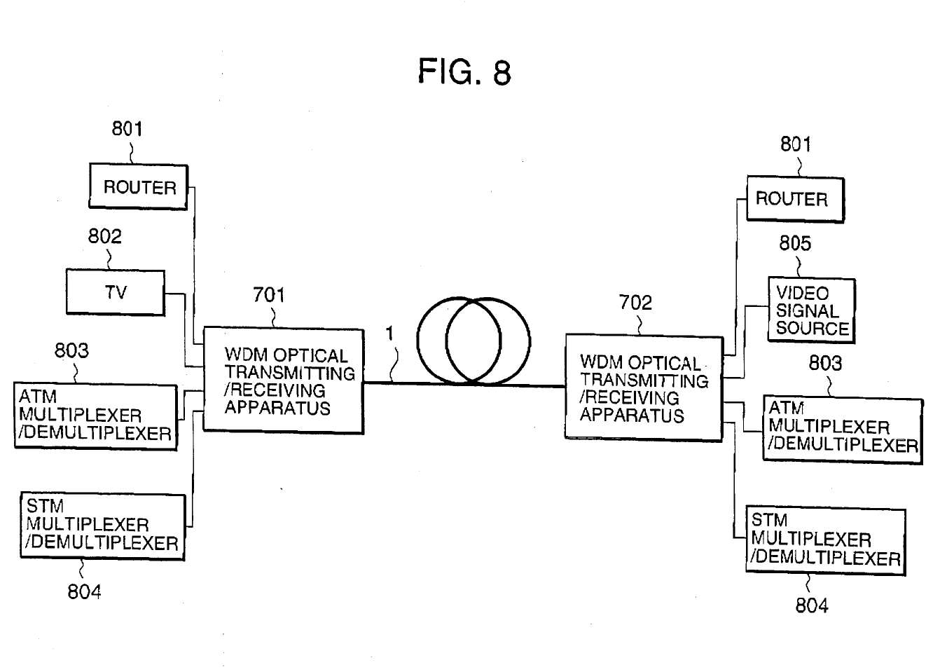

FIG. 8 illustrates a service multiplexed transfer system according to the sixth embodiment of the invention. Reference numerals “701” and “702” in FIG. 8 are the WDM optical transmitting/receiving apparatuses according to the third embodiment of the invention. Reference numeral “801” is a router which terminates an IP network, “802” is a television signal receiver (TV), “803” is an ATM multiplexer/demultiplexer which terminates an ATM network, “804” is an STM multiplexer/demultiplexer which terminates an STM network, and “805” is a video signal source. The two WDM optical transmitting/receiving apparatuses 701 and 702 are connected together by the transfer optical fiber 1.

The operation of the sixth embodiment of the invention will be discussed below. Signals that provide four services, an IP service by the router 801 connected to the WDM optical transmitting/receiving apparatus 702, a video distribution service by the video signal source 805, an ATM service by the ATM multiplexer/demultiplexer 803 and an STM service by the STM multiplexer/demultiplexer 804, are converted to optical signals with four wavelengths. The optical signals with four wavelengths are transferred over the single transfer optical fiber 1 to the WDM optical transmitting/receiving apparatus 701. The WDM optical transmitting/receiving apparatus 701 demultiplexes the four wavelengths to output signals that provide four services, namely the IP service by the router 801 connected to the WDM optical transmitting/receiving apparatus 702, the video distribution service by the video signal source 805, the ATM service by the ATM multiplexer/demultiplexer 803 and the STM service by the STM multiplexer/demultiplexer 804. Apparently, the sixth embodiment of the invention can provide a service multiplexed transfer system comprising compact WDM optical transmitting/receiving apparatuses.

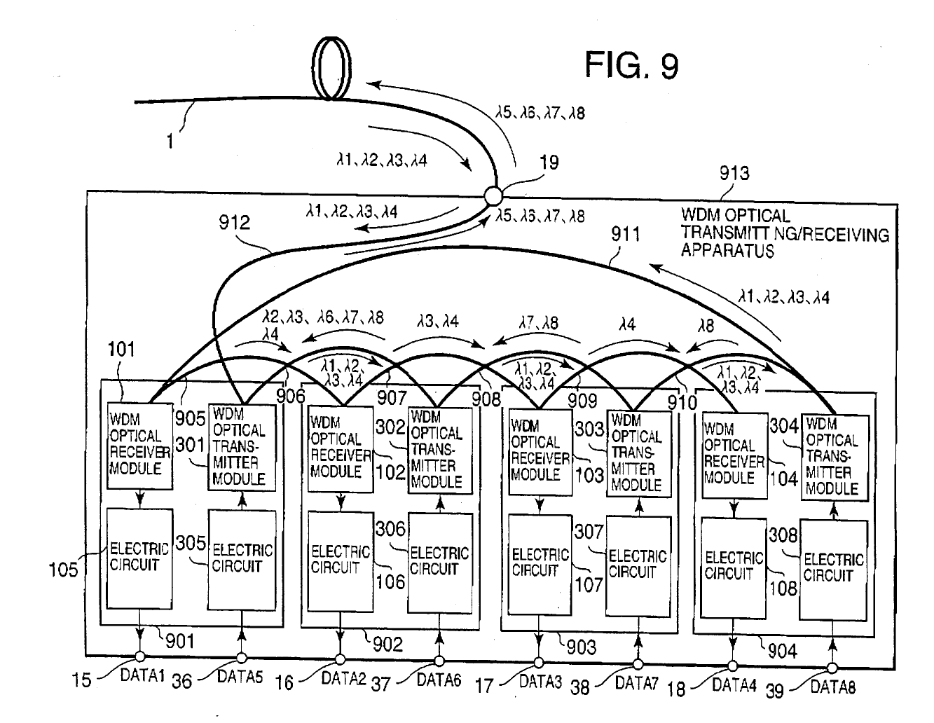

FIG. 9 shows the seventh embodiment of the invention. Reference numeral “913” in FIG. 9 is a WDM optical transmitting/receiving apparatus. The WDM optical transmitting/receiving apparatus 913 receives an optical signal with four wavelengths (λ1, λ2, λ3, λ4) from the transfer optical fiber 1 and multiplexes optical signals with wavelengths (λ5, λ6, λ7, λ8) and outputs the multiplexed optical signal to the transfer optical fiber 1. Intraconnection optical fibers 905, 906, 907, 908, 909, 910, 911 and 912 optically connect the components inside the apparatus to one another. Reference numerals “101”, “102”, “103” and “104” are WDM optical receiver modules which output currents corresponding to the input optical signal powers. Reference numerals “301”, “302”, “303” and “304” are WDM optical transmitter modules which output optical signals corresponding to the input currents. Reference numerals “105”, “106”, “107”, “108”, “305”, “306”, “307” and “308” are electric processing circuits. Optical transmitting/receiving sections 901, 902, 903 and 904 respectively comprise the associated WDM optical receiver modules 101, 102, 103 and 104, the associated WDM optical transmitter modules 301, 302, 303 and 304 and the associated electric processing circuits 105, 106, 107, 108, 305, 306, 307 and 308. Reference numerals “15”, “16”, “17”, “18”, “36”, “37”, “38” and “39” are electric connectors. The transfer optical fiber 1 is connected to the intraconnection optical fiber 912 or the output optical fiber of the WDM optical transmitter module 301 via the optical connector 19. The intraconnection optical fiber 906 or the input optical fiber of the WDM optical transmitter module 301 is connected to the WDM optical transmitter module 302. The intraconnection optical fiber 908 or the input optical fiber of the WDM optical transmitter module 302 is connected to the WDM optical transmitter module 303. The intraconnection optical fiber 910 or the input optical fiber of the WDM optical transmitter module 303 is connected to the WDM optical transmitter module 304. Further, the intraconnection optical fiber 911 or the input optical fiber of the WDM optical transmitter module 304 is connected to the WDM optical receiver module 101. The intraconnection optical fiber 905 or the output optical fiber of the WDM optical receiver module 101 is connected to the WDM optical receiver module 102. The intraconnection optical fiber 907 or the output optical fiber of the WDM optical receiver module 102 is connected to the WDM optical receiver module 103. The intraconnection optical fiber 909 or the output optical fiber of the WDM optical receiver module 103 is connected to the WDM optical receiver module 104.

The operation will now be discussed. The DATA5 to DATA8 to be input to the WDM optical transmitting/receiving apparatus 913 in FIG. 9 are respectively converted optical signals with the wavelengths λ5, λ6, λ7 and λ8 by the electric processing circuits 305 to 308 and the WDM optical transmitter modules 301, 302, 303 and 304. The optical signal of the wavelength λ8 is input to the WDM optical transmitter module 303 which adds the optical signal of the wavelength λ7 to the input optical signal of the wavelength λ8, and the resultant optical signal is input to the WDM optical transmitter module 302. The WDM optical transmitter module 302 adds the optical signal of the wavelength λ6 to the optical signal of the wavelengths λ7 and λ8, and the resultant optical signal is input to the WDM optical transmitter module 301. The WDM optical transmitter module 301 adds the optical signal of the wavelength λ5 to the optical signal of the wavelengths λ6, λ7 and λ8, and the resultant optical signal is output to the transfer optical fiber 1 via the optical connector 19. Meanwhile, the optical signals with the four wavelengths λ1, λ2, λ3 and λ4 to be input are input to the WDM optical receiver module 101 via the WDM optical transmitter modules 301, 302, 303 and 304, only the optical signal of the wavelength λ1 is converted to an electric signal by the WDM optical receiver module 101 and DATA1 is reproduced and output by the electric processing circuit 105, and the optical signals with the three wavelengths λ2, λ3 and λ4 are output to the WDM optical receiver module 102. Of the optical signals with the wavelengths λ2, λ3 and λ4, only the optical signal of the wavelength λ2 is converted to an electric signal by the WDM optical receiver module 102 and DATA2 is reproduced and output by the electric processing circuit 106, and the optical signals with the two wavelengths λ3 and λ4 are input to the WDM optical receiver module 103 from the WDM optical receiver module 102. Of the optical signals with the wavelengths λ3 and λ4, and only the optical signal of the wavelength λ3 is converted to an electric signal by the WDM optical receiver module 103 and DATA3 is reproduced and output by the electric processing circuit 107 and the optical signal of the wavelength λ4 is output to the WDM optical receiver module 104 from the WDM optical receiver module 103. The optical signal with the wavelength λ4 is converted to an electric signal by the WDM optical receiver module 104 and DATA4 is reproduced and output by the electric processing circuit 108. According to the seventh embodiment, as transmission optical signals with the wavelengths λ5, λ6, λ7 and λ8 which have large signal levels are output without going through the WDM optical receiver modules 101, 102, 103 and 104, interference on reception optical signals by the transmission optical signals is suppressed. It is therefore possible to realize a WDM optical transmitting/receiving apparatus with a high reception sensitivity. Further, the degree of wavelength demultiplexing of the wavelength multiplexing/demultiplexing element in the WDM optical receiver module can be relaxed, which would bring about an advantage of ensuring cost reduction. As apparent from the above, the seventh embodiment of the invention can eliminate the wavelength multiplexing/demultiplexing section as compared with the conventional optical transmitting/receiving apparatus and can provide an excellent WDM optical transmitting/receiving apparatus which without losing the advantage that upsizing of the apparatus is prevented even if the number of wavelength multiplexing stages is increased.

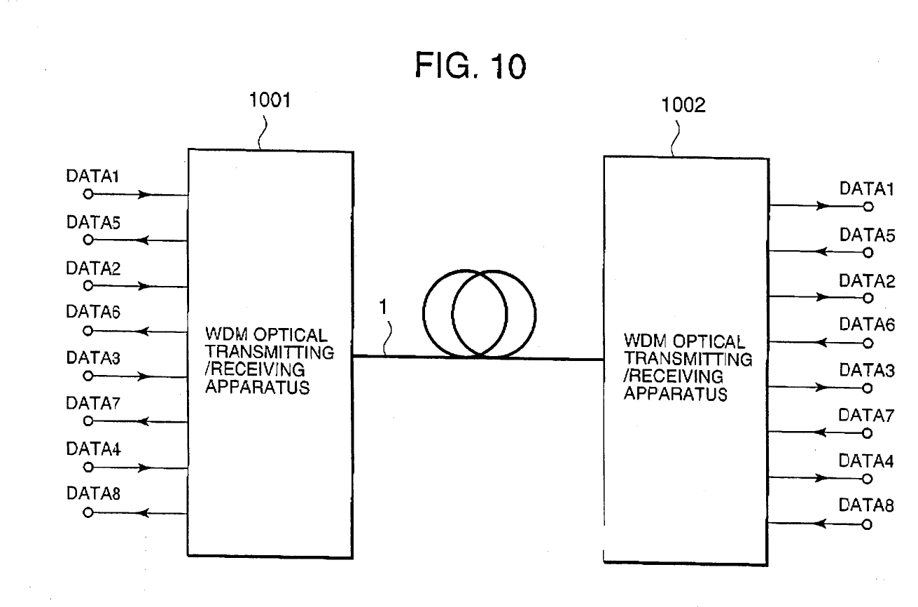

FIG. 10 illustrates the eighth embodiment of the invention. In FIG. 10, “1001” and “1002” denote the WDM optical transmitting/receiving apparatuses according to the seventh embodiment of the invention, which are connected together by the transfer optical fiber 1.

The operation of the eighth embodiment of the invention will be discussed below. The DATA1, DATA2, DATA3 and DATA4 to be input to the WDM optical transmitting/receiving apparatus 1001 are converted to optical signals with four wavelengths by the WDM optical transmitting/receiving apparatus 1001. The optical signals with four wavelengths are transferred through the single transfer optical fiber 1 to the WDM optical transmitting/receiving apparatus 1002. The WDM optical transmitting/receiving apparatus 1002 demultiplexes the four wavelengths and produces and outputs DATA1, DATA2, DATA3 and DATA4. The DATA5, DATA6, DATA7 and DATA8 to be input to the WDM optical transmitting/receiving apparatus 1002 are converted to optical signals with four wavelengths by the WDM optical transmitting/receiving apparatus 1002. The optical signals with four wavelengths are transferred through the single transfer optical fiber to the WDM optical transmitting/receiving apparatus 1001. The WDM optical transmitting/receiving apparatus 1001 demultiplexes the four wavelengths and reproduces and outputs the DATA5, DATA6, DATA7 and DATA8. The eighth embodiment of the invention can apparently provide a one-fiber bidirectional WDM optical transfer system comprising compact, low-cost WDM optical transmitting/receiving apparatuses with a high reception sensitivity.

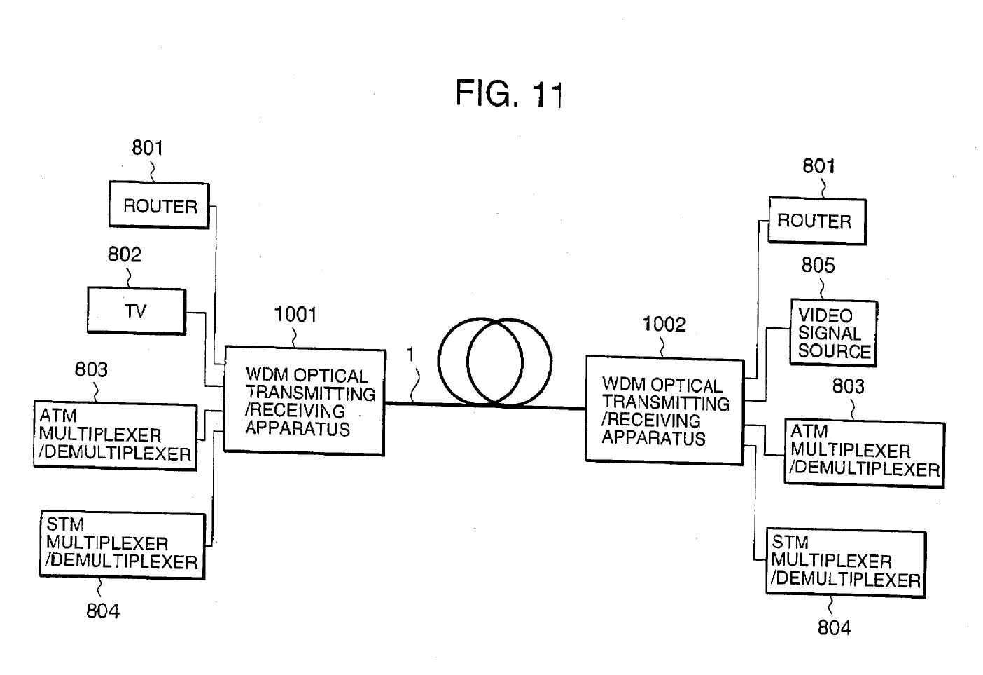

FIG. 11 illustrates a service multiplexed transfer system according to the ninth embodiment of the invention. Reference numerals “1001” and “1002” in FIG. 11 are the WDM optical transmitting/receiving apparatuses according to the seventh embodiment of the invention. Reference numeral “801” is a router which terminates an IP network, “802” is a television signal receiver, “803” is an ATM multiplexer/demultiplexer which terminates an ATM network, “804” is an STM multiplexer/demultiplexer which terminates an STM network, and “805” is a video signal source. The two WDM optical transmitting/receiving apparatuses 1001 and 1002 are connected together by the transfer optical fiber 1.

The operation of the ninth embodiment of the invention will be discussed below. Signals that provide four services, an IP service by the router 801 connected to the WDM optical transmitting/receiving apparatus 1002, a video distribution service by the video signal source 805, an ATM service by the ATM multiplexer/demultiplexer 803 and an STM service by the STM multiplexer/demultiplexer 804, are converted to optical signals with four wavelengths. The optical signals with four wavelengths are transferred over the single transfer optical fiber 1 to the WDM optical transmitting/receiving apparatus 1001. The WDM optical transmitting/receiving apparatus 1001 demultiplexes the four wavelengths to output signals that provide four services, namely the IP service by the router 801 connected to the WDM optical transmitting/receiving apparatus 1002, the video distribution service by the video signal source 805, the ATM service by the ATM multiplexer/demultiplexer 803 and the STM service by the STM multiplexer/demultiplexer 804. Apparently, the ninth embodiment of the invention can provide a service multiplexed transfer system comprising compact, low-cost WDM optical transmitting/receiving apparatuses with a high reception sensitivity.

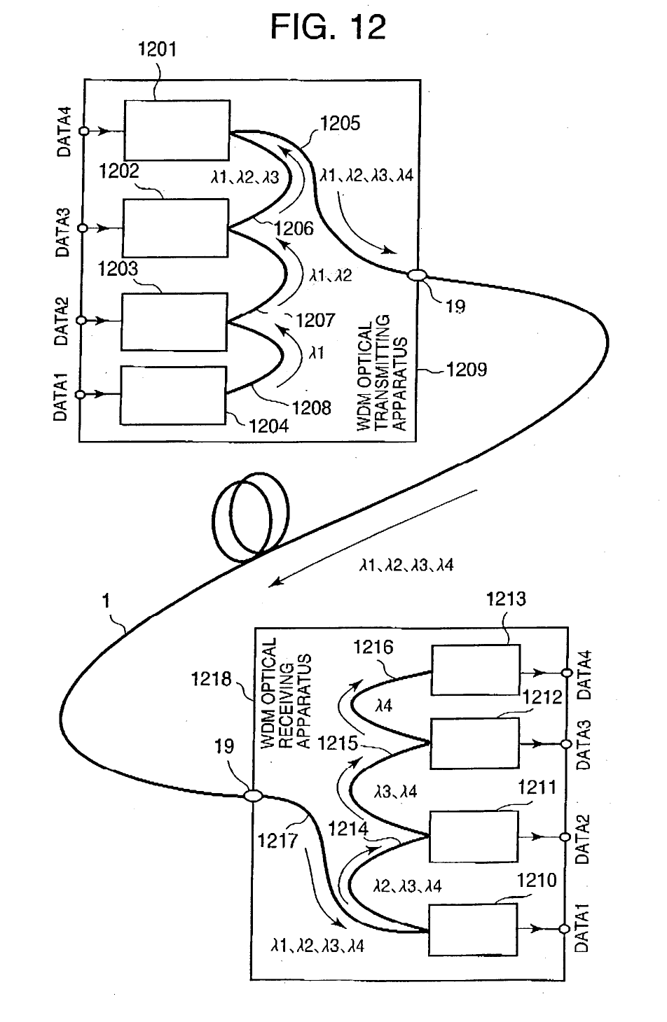

FIG. 12 shows a WDM optical transfer system according to the tenth embodiment of the invention. Reference numerals “1201”, “1202”, “1203” and “1204” denote optical transmitting sections each comprising a WDM optical transmitter module and an electric processing circuit and has an input optical fiber and an output optical fiber. The optical transmitting section 1204 converts the electric signal of the input DATA1 to an optical signal of the wavelength λ1 and then sends the optical signal to the optical transmitting section 1203 to be connected next. The optical transmitting section 1203 converts the electric signal of the input DATA2 to an optical signal of the wavelength λ2 and then sends the optical signal together with the input optical signal of the wavelength λ1 to the optical transmitting section 1202 to be connected next. The optical transmitting section 1202 converts the electric signal of the input DATA3 to an optical signal of the wavelength λ3 and then sends the optical signal together with the input optical signal of the wavelengths λ1 and λ2 to the optical transmitting section 1201 to be connected next. The optical transmitting section 1201 converts the electric signal of the input DATA4 to an optical signal of the wavelength λ4 and then sends the optical signal together with the input optical signal of the wavelengths λ1, λ2 and λ3 to the transfer optical fiber 1 via the optical connector 19.

A WDM optical transmitting apparatus 1209 is constructed by sequentially connecting the optical transmitting sections 1201, 1202, 1203 and 1204 in order. Reference numerals “1210”, “1211”, “1212” and “1213” are optical receiving sections each comprising a WDM optical receiver module and an electric processing circuit and has an input optical fiber and an output optical fiber. The optical receiving section 1211 converts the optical signal with the wavelength λ2 in the input optical signal with the wavelengths λ2, λ3 and λ4 to an electric signal to output DATA2 and outputs the optical signal with wavelengths λ3 and λ4 to the optical receiving section 1212 to be connected next. The optical receiving section 1212 converts the optical signal with the wavelength λ3 in the input optical signal with the wavelengths λ3 and λ4 to an electric signal to output DATA3 and outputs the optical signal of the wavelength λ4 to the optical receiving section 1213 to be connected next. The optical receiving section 1213 converts the optical signal with the wavelength λ4 to an electric signal to output DATA4. A WDM optical receiving apparatus 1218 is constructed by sequentially connecting the optical receiving sections 1210, 1211, 1212 and 1213 in order. The WDM optical transmitting apparatus 1209 and the WDM optical receiving apparatus 1218 are connected together by the transfer optical fiber 1.

The operation of the tenth embodiment of the invention will be discussed below. The DATA1, DATA2, DATA3 and DATA4 to be input to the WDM optical transmitting apparatus 1209 are converted to optical signals with four wavelengths by the WDM optical transmitting apparatus 1209. The optical signals with four wavelengths are transferred through the single transfer optical fiber 1 to the WDM optical receiving apparatus 1218. The WDM optical receiving apparatus 1218 demultiplexes the four wavelengths and produces and outputs DATA1, DATA2, DATA3 and DATA4. In the tenth embodiment, because the optical signal of the wavelength λ1 which is transmitted by the optical transmitting section 1204 located apart from the output section of the WDM optical transmitting apparatus 1209 is received at the optical receiving section 1210 located near the input section of the WDM optical receiving apparatus 1218 and the optical signal of the wavelength λ4 which is transmitted by the optical transmitting section 1201 located close to the output section of the WDM optical transmitting apparatus 1209 is received at the optical receiving section 1213 located apart from the input section of the WDM optical receiving apparatus 1218, it is possible to average the influence of the excess loss that occurs at the time an optical signal passes the optical transmitting section or the optical receiving section. This increases the level difference between the transmitting and receiving sections and can thus ensure longer distance transmission. According to the tenth embodiment of the invention, as discussed above, the transmission distance of the optical transfer system can be increased by the compact WDM optical transmitting apparatus and the compact WDM optical receiving apparatus.

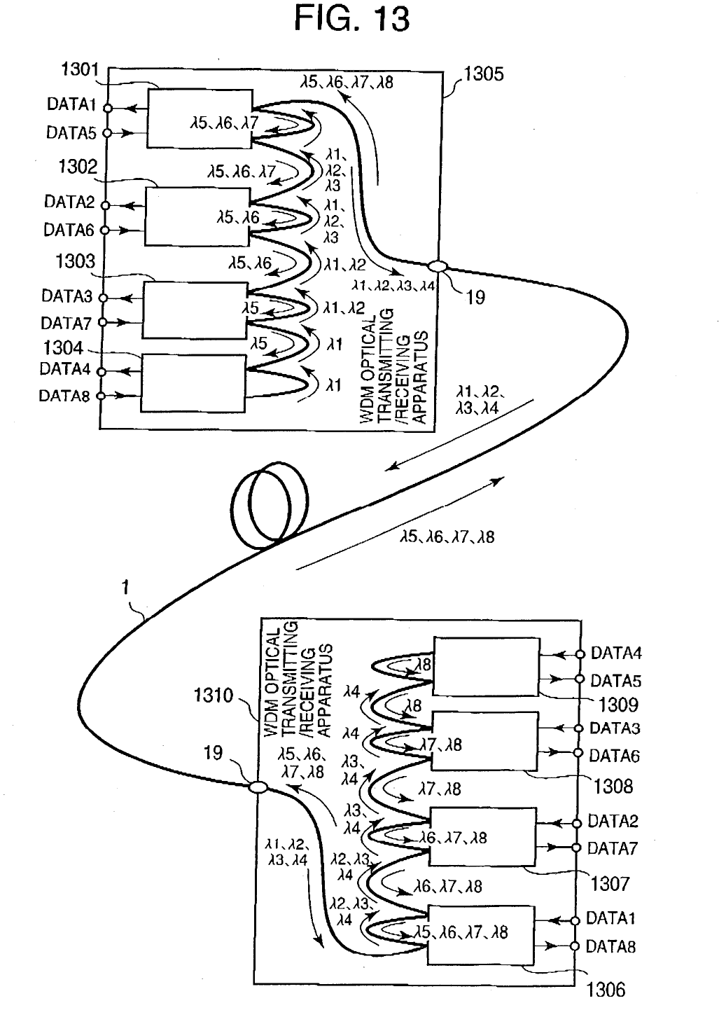

FIG. 13 shows a one-fiber bidirectional optical transfer system according to the eleventh embodiment of the invention. Reference numerals “1301”, “1302”, “1303”, “1304”, “1306”, “1307”, “1308” and “1309” denote optical transmitting/receiving sections each comprising a WDM optical transmitter module, a WDM optical receiver module and an electric processing circuit. The optical transmitting/receiving section 1304 converts the electric signal of the input DATA8 to an optical signal of the wavelength λ1 and then sends the optical signal to the optical transmitting/receiving section 1303 to be connected next. The optical transmitting/receiving section 1303 converts the electric signal of the input DATA7 to an optical signal of the wavelength λ2 and then sends the optical signal together with the input optical signal of the wavelength λ1 to the optical transmitting/receiving section 1302 to be connected next. The optical transmitting/receiving section 1302 converts the electric signal of the input DATA6 to an optical signal of the wavelength λ3 and then sends the optical signal together with the Input optical signal of the wavelengths λ1 and λ2 to the optical transmitting/receiving section 1301 to be connected next. The optical transmitting/receiving section 1301 converts the electric signal of the input DATA5 to an optical signal of the wavelength λ4 and then sends the optical signal together with the input optical signal of the wavelengths λ1, λ2 and λ3 to the transfer optical fiber 1 via the optical connector 19.

The optical transmitting/receiving section 1301 also converts the optical signal of the wavelength λ8 in the input optical signal with the wavelengths λ5, λ6, λ7 and λ8 to an electric signal, outputs DATA1 and sends the optical signal of the wavelengths λ5, λ6 and λ7 to the optical transmitting/receiving section 1302 to be connected next. The optical transmitting/receiving section 1302 converts the optical signal with the wavelength λ7 in the input optical signal with the wavelengths λ5, λ6 and λ7 to an electric signal, outputs DATA2 and sends the optical signal with wavelengths λ5 and λ6 to the optical transmitting/receiving section 1303 to be connected next. The optical transmitting/receiving section 1303 converts the optical signal with the wavelength λ6 in the input optical signal with the wavelengths λ5 and λ6 to an electric signal, outputs DATA3 and sends the optical signal of the wavelength λ5 to the optical transmitting/receiving section 1304 to be connected next. The optical transmitting/receiving section 1304 converts the optical signal with the wavelength λ5 to an electric signal and outputs DATA4. A WDM optical transmitting/receiving apparatus 1305 is constructed by sequentially connecting the optical transmitting/receiving sections 1301, 1302, 1303 and 1304 in order.

The optical transmitting/receiving section 1309 converts the electric signal of the input DATA4 to the optical signal of the wavelength λ8 and sends the electric signal to the optical transmitting/receiving section 1308 to be connected next. The optical transmitting/receiving section 1308 converts the electric signal of the input DATA3 to the optical signal of the wavelength λ7 and sends the electric signal together with the input optical signal of the wavelength λ8 to the optical transmitting/receiving section 1307 to be connected next. The optical transmitting/receiving section 1307 converts the electric signal of the input DATA2 to the optical signal of the wavelength λ6 and sends the electric signal together with the input optical signal of the wavelengths λ8 and λ7 to the optical transmitting/receiving section 1306 to be connected next. The optical transmitting/receiving section 1306 converts the electric signal of the input DATA1 to the optical signal of the wavelength λ5 and sends the electric signal together with the input optical signal of the wavelengths λ8, λ7 and λ6 to the transfer optical fiber 1 via the optical connector 19. The optical transmitting/receiving section 1306 also converts the optical signal of the wavelength λ1 in the input optical signal with the wavelengths λ1, λ2, λ3 and λ4 to an electric signal, outputs DATA8 and sends the optical signal of the wavelengths λ2, λ3 and λ4 to the optical transmitting/receiving section 1307 to be connected next.

The optical transmitting/receiving section 1307 converts the optical signal of the wavelength λ2 in the input optical signal with the wavelengths λ2, λ3 and λ4 to an electric signal, outputs DATA7 and sends the optical signal of the wavelengths λ3 and λ4 to the optical transmitting/receiving section 1308 to be connected next. The optical transmitting/receiving section 1308 converts the optical signal of the wavelength λ3 in the input optical signal with the wavelengths λ3 and λ4 to an electric signal, outputs DATA6 and sends the optical signal of the wavelength λ4 to the optical transmitting/receiving section 1309 to be connected next. The optical transmitting/receiving section 1309 converts the optical signal of the wavelength λ4 to an electric signal and outputs DATA5. A WDM optical transmitting/receiving apparatus 1310 is constructed by sequentially connecting the optical transmitting/receiving sections 1306, 1307, 1308 and 1309 in order. The WDM optical transmitting apparatus 1305 and the WDM optical receiving apparatus 1310 are connected together by the transfer optical fiber 1.

The operation of the eleventh embodiment of the invention will be discussed below. The DATA1, DATA2, DATA3 and DATA4 to be input to the WDM optical transmitting/receiving apparatus 1310 are converted to optical signals with four wavelengths by the WDM optical transmitting/receiving apparatus 1310. The optical signals with four wavelengths are transferred through the single transfer optical fiber 1 to the WDM optical transmitting/receiving apparatus 1305. The WDM optical transmitting/receiving apparatus 1305 demultiplexes the four wavelengths and produces and outputs DATA1, DATA2, DATA3 and DATA4. The DATA5, DATA6, DATA7 and DATA8 to be input to the WDM optical transmitting/receiving apparatus 1305 are converted to optical signals with four wavelengths by the WDM optical transmitting/receiving apparatus 1305. The optical signals with four wavelengths are transferred through the single transfer optical fiber 1 to the WDM optical transmitting/receiving apparatus 1310. The WDM optical transmitting/receiving apparatus 1310 demultiplexes the four wavelengths and produces and outputs DATA5, DATA6, DATA7 and DATA8.

In the eleventh embodiment, the optical signal of the wavelength λ8 which is transmitted by the optical transmitting/receiving section optical 1309 located apart from the output section of the WDM optical transmitting/receiving apparatus 1310 is received at the optical transmitting/receiving section optical 1301 located near the input section of the WDM optical transmitting/receiving apparatus 1305 and the optical signal of the wavelength λ5 which is transmitted by the optical transmitting/receiving section optical 1306 located near the output section of the WDM optical transmitting/receiving apparatus 1310 is received at the optical transmitting/receiving section 1304 located apart from the input section of the WDM optical transmitting/receiving apparatus 1305. Further, the optical signal of the wavelength λ1 which is transmitted by the optical transmitting/receiving section optical 1304 located apart from the output section of the WDM optical transmitting/receiving apparatus 1305 is received at the optical transmitting/receiving section optical 1306 located near the input section of the WDM optical transmitting/receiving apparatus 1310 and the optical signal of the wavelength λ4 which is transmitted by the optical transmitting/receiving section optical 1301 located near the output section of the WDM optical transmitting/receiving apparatus 1305 is received at the optical transmitting/receiving section 1309 located apart from the input section of the WDM optical transmitting/receiving apparatus 1310. It is therefore possible to average the influence of the excess loss that occurs at the time an optical signal passes the optical transmitting/receiving section. This increases the difference between the transmitting and receiving levels and can thus ensure longer distance one-fiber bidirectional transfer.

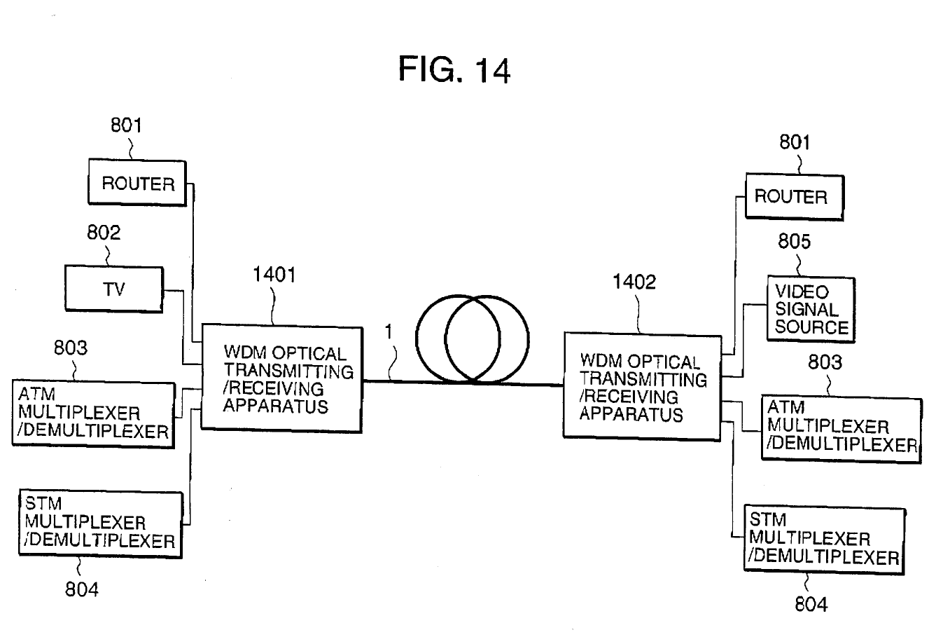

FIG. 14 illustrates a service multiplexed transfer system according to the twelfth embodiment of the invention. Reference numerals “1401” and “1402” in FIG. 14 are the WDM optical transmitting/receiving apparatuses according to the eleventh embodiment of the invention. Reference numeral “801” is a router which terminates an IP network, “802” is a television signal receiver, “803” is an ATM multiplexer/demultiplexer which terminates an ATM network, “804” is an STM multiplexer/demultiplexer which terminates an STM network, and “805” is a video signal source. The two WDM optical transmitting/receiving apparatuses 1401 and 1402 are connected together by the transfer optical fiber 1.

The operation of the twelfth embodiment of the invention will be discussed below. Signals that provide four services, an IP service by the router 801 connected to the WDM optical transmitting/receiving apparatus 1402, a video distribution service by the video signal source 805, an ATM service by the ATM multiplexer/demultiplexer 803 and an STM service by the STM multiplexer/demultiplexer 804, are converted to optical signals with four wavelengths. The optical signals with four wavelengths are transferred over the single transfer optical fiber 1 to the WDM optical transmitting/receiving apparatus 1401. The WDM optical transmitting/receiving apparatus 1401 demultiplexes the four wavelengths to output signals that provide four services, namely the IP service by the router 801 connected to the WDM optical transmitting/receiving apparatus 1402, the video distribution service by the video signal source 805, the ATM service by the ATM multiplexer/demultiplexer 803 and the STM service by the STM multiplexer/demultiplexer 804. Apparently, the twelfth embodiment of the invention can provide a service multiplexed transfer system comprising compact, low-cost WDM optical transmitting/receiving apparatuses which can carry out long-distance transmission.

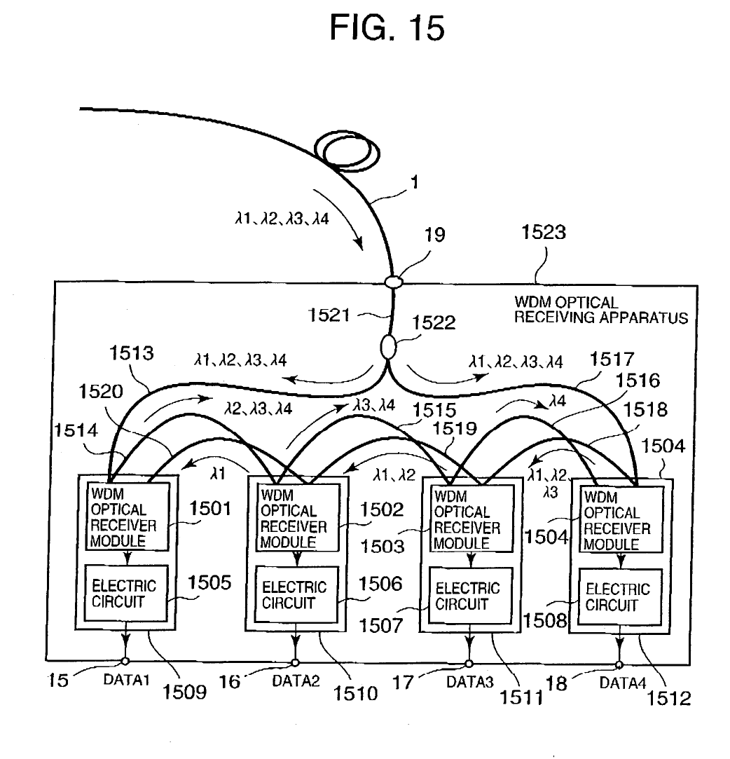

FIG. 15 shows the thirteenth embodiment of the invention. Reference numeral “1523” in FIG. 15 is a WDM optical receiving apparatus. An optical coupler 1522 splits an optical signal input via the optical connector 19 to two. Optical signals of four different wavelengths (λ1, λ2, λ3, λ4) are multiplexed in the transfer optical fiber 1 and are input to the WDM optical receiving apparatus 1523. Intraconnection optical fibers 1513, 1514, 1515, 1516, 1517, 1518, 1519, 1520 and 1521 are provided to optically connect the components inside the apparatus to one another. Each of WDM optical receiver modules 1501, 1502, 1503 and 1504 has two pairs of optical fibers each having an input optical fiber and an output optical fiber. The WDM optical receiver module 1501 outputs a current signal corresponding to the optical signal power of the wavelength λ1, the WDM optical receiver module 1502 outputs a current signal corresponding to the optical signal power of the wavelength λ2, the WDM optical receiver module 1503 outputs a current signal corresponding to the optical signal power of the wavelength λ3 and the WDM optical receiver module 1504 outputs a current signal corresponding to the optical signal power of the wavelength λ4.

The intraconnection optical fiber 1513 which is the input optical fiber in the first optical fiber pair of the WDM optical receiver module 1501 is connected to the transfer optical fiber 1 via the optical coupler 1522 and the optical connector 19, the intraconnection optical fiber 1514 or the input optical fiber in the first optical fiber pair of the WDM optical receiver module 1502 is connected to the output optical fiber in the first optical fiber pair of the WDM optical receiver module 1501, the intraconnection optical fiber 1515 or the input optical fiber in the first optical fiber pair of the WDM optical receiver module 1503 is connected to the output optical fiber in the first optical fiber pair of the WDM optical receiver module 1502, and the intraconnection optical fiber 1516 or the input optical fiber in the first optical fiber pair of the WDM optical receiver module 1504 is connected to the output optical fiber in the first optical fiber pair of the WDM optical receiver module 1503.

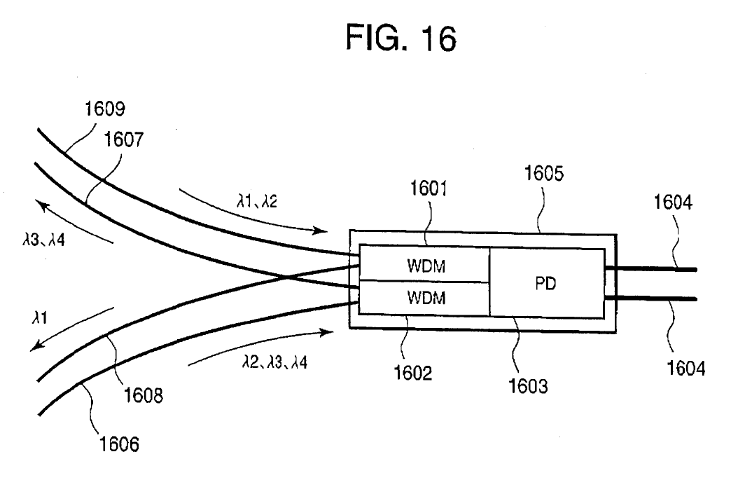

The intraconnection optical fiber 1517 which is the input optical fiber in the second optical fiber pair of the WDM optical receiver module 1504 is connected to the transfer optical fiber 1 via the optical coupler 1522 and the optical connector 19, the intraconnection optical fiber 1518 or the input optical fiber in the second optical fiber pair of the WDM optical receiver module 1503 is connected to the output optical fiber in the second optical fiber pair of the WDM optical receiver module 1504, the intraconnection optical fiber 1519 or the input optical fiber in the second optical fiber pair of the WDM optical receiver module 1502 is connected to the output optical fiber in the second optical fiber pair of the WDM optical receiver module 1503, and the intraconnection optical fiber 1520 or the input optical fiber in the second optical fiber pair of the WDM optical receiver module 1501 is connected to the output optical fiber in the second optical fiber pair of the WDM optical receiver module 1502. Electric processing circuits 1505, 1506, 1507 and 1508 convert current signals output from the WDM optical receiver modules 1501 to 1504 to demanded signal forms or signal levels. Optical receiving sections 1509, 1510, 1511 and 1512 respectively comprise the associated WDM receiver modules 1501 to 1504 and the associated electric processing circuits 1505 to 1508. Reference numerals “15”, “16”, “17” and “18” are electric connectors. FIG. 16 is a block diagram of the WDM optical receiver module according to the thirteenth embodiment of the invention. Reference numerals “1606”, “1607”, “1608” and “1609” in FIG. 16 are intraconnection optical fibers. Wavelength multiplexing/demultiplexing elements 1601 and 1602 pass an optical signal of a specific wavelength and reflect optical signals of the other wavelengths. Reference numeral “1603” denotes a light receiving element and “1604” denotes an electric interconnection lead. Each of the two wavelength multiplexing/demultiplexing elements 1601 and 1602 is optically coupled to two intraconnection optical fibers 1606 and 1607 or 1608 and 1609, and the light receiving element 1603 is optically coupled to the wavelength multiplexing/demultiplexing elements 1601 and 1602 and electrically connected to the electric interconnection leads 1604, thereby constituting a WDM optical receiver module 1605. Although the description on FIG. 16 discusses the case of the WDM optical receiver module 1502 which receives an optical signal with the wavelength λ2, the WDM optical receiver module 1501 which receives the wavelength λ1, the WDM optical receiver module 1503 which receives the wavelength λ3 and the WDM optical receiver module 1504 which receives the wavelength λ4 also have the same structure except for the wavelength characteristics of the associated wavelength multiplexing/demultiplexing elements 1601 and 1602.

The operation of the thirteenth embodiment of the invention will be discussed below. The optical signals with the four wavelengths λ1, λ2, λ3 and λ4 input to the WDM optical receiving apparatus 1523 in FIG. 15 are split into two by the optical coupler 1522, one being input to the first pair of optical fibers of the WDM optical receiver module 1501. Only the optical signal of the wavelength λ1 is converted to an electric signal by the WDM optical receiver module 1501 and DATA1 is reproduced and output by the electric processing circuit 1505. The optical signals with the wavelengths λ2, λ3 and λ4 are input to the WDM optical receiver module 1502 from the WDM optical receiver module 1501, and only the optical signal of the wavelength λ2 is converted to an electric signal by the WDM optical receiver module 1502 and DATA2 is reproduced and output by the electric processing circuit 1506. Further, the optical signals with the wavelengths λ3 and λ4 are input to the WDM optical receiver module 1503 from the WDM optical receiver module 1502, and only the optical signal of the wavelength λ3 is converted to an electric signal by the WDM optical receiver module 1503 and DATA3 is reproduced and output by the electric processing circuit 1507. Furthermore, the optical signal of the wavelength λ4 is input to the WDM optical receiver module 1504 from the WDM optical receiver module 1503, and converted to an electric signal by the WDM optical receiver module 1504 and DATA4 is reproduced and output by the electric processing circuit 1508. The other output of the optical coupler 1522 is input to the second pair of optical fibers of the WDM optical receiver module 1504. Only the optical signal with the wavelength λ4 is converted to an electric signal by the WDM optical receiver module 1504 and DATA4 is reproduced and output by the electric processing circuit 1508.

The optical signals with the wavelengths λ1, λ2 and λ3 are input to the WDM optical receiver module 1503 from the WDM optical receiver module 1504, and only the optical signal of the wavelength λ3 is converted to an electric signal by the WDM optical receiver module 1503 and DATA3 is reproduced and output by the electric processing circuit 1507. Further, the optical signals with the wavelengths λ1 and λ2 are input to the WDM optical receiver module 1502 from the WDM optical receiver module 1503, and only the optical signal of the wavelength λ2 is converted to an electric signal by the WDM optical receiver module 1502 and DATA2 is reproduced and output by the electric processing circuit 1506. Furthermore, the optical signal of the wavelength λ1 is input to the WDM optical receiver module 1501 from the WDM optical receiver module 1502, and converted to an electric signal by the WDM optical receiver module 1501 and DATA1 is reproduced and output by the electric processing circuit 1505. As apparent from the above, the thirteenth embodiment of the invention can eliminate the wavelength multiplexing/demultiplexing section as compared with the conventional optical receiving apparatus and can provide an excellent, live-insertable (hot-plugable) WDM optical receiving apparatus which is prevented from become larger even if the number of wavelength multiplexing stages is increased and does not influence the other optical receiving sections, due to the dual sequential connection, even if one optical receiving section fails and needs replacement.

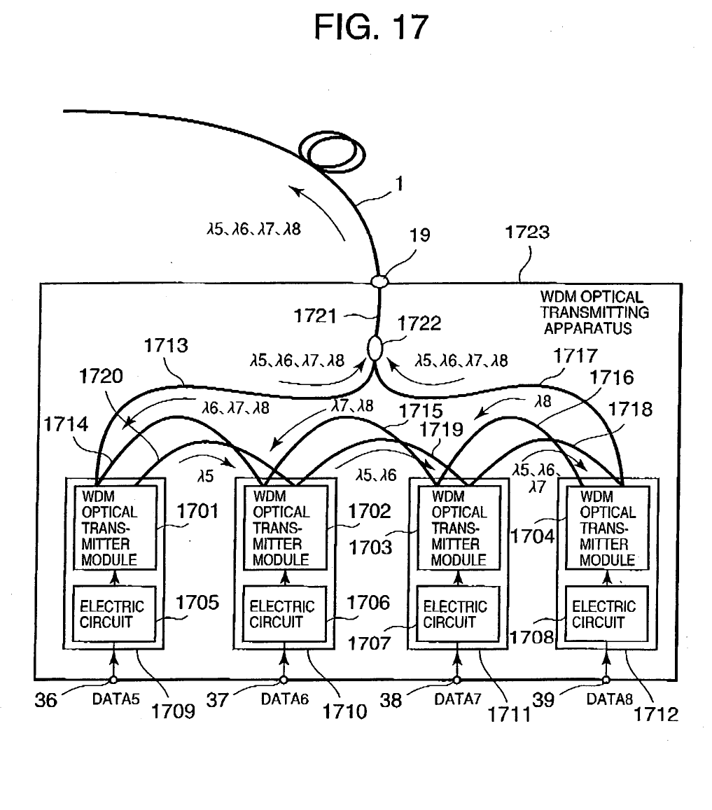

FIG. 17 shows the fourteenth embodiment of the invention. Reference numeral “1723” in FIG. 17 is a WDM optical transmitting apparatus. An optical coupler 1722 combines two input optical signals. The WDM optical transmitting apparatus 1723 multiplexes optical signals of four wavelengths (λ5, λ6, λ7, λ8) and outputs the multiplexed signal to the transfer optical fiber 1. Intraconnection optical fibers 1713, 1714, 1715, 1716, 1717, 1718, 1719, 1720 and 1721 optically connect the components inside the apparatus to one another. Each of WDM optical transmitter modules 1701, 1702, 1703 and 1704 has two pairs of optical fibers each having an input optical fiber and an output optical fiber. The intraconnection optical fiber 1713 which is the output optical fiber in the first optical fiber pair of the WDM optical transmitter module 1701 is connected to the transfer optical fiber 1 via the optical coupler 1722 and the optical connector 19, the intraconnection optical fiber 1714 or the output optical fiber in the first optical fiber pair of the WDM optical transmitter module 1702 is connected to the input optical fiber in the first optical fiber pair of the WDM optical transmitter module 1701, the intraconnection optical fiber 1715 or the output optical fiber in the first optical fiber pair of the WDM optical transmitter module 1703 is connected to the input optical fiber in the first optical fiber pair of the WDM optical transmitter module 1702, and the intraconnection optical fiber 1716 or the output optical fiber in the first optical fiber pair of the WDM optical transmitter module 1704 is connected to the input optical fiber in the first optical fiber pair of the WDM optical transmitter module 1703.

The intraconnection optical fiber 1717 which is the output optical fiber in the second optical fiber pair of the WDM optical transmitter module 1704 is connected to the transfer optical fiber 1 via the optical coupler 1722 and the optical connector 19, the intraconnection optical fiber 1718 or the output optical fiber in the second optical fiber pair of the WDM optical transmitter module 1703 is connected to the input optical fiber in the second optical fiber pair of the WDM optical transmitter module 1704, the intraconnection optical fiber 1719 or the output optical fiber in the second optical fiber pair of the WDM optical transmitter module 1702 is connected to the input optical fiber in the second optical fiber pair of the WDM optical transmitter module 1703, and the intraconnection optical fiber 1720 or the output optical fiber in the second optical fiber pair of the WDM optical transmitter module 1701 is connected to the input optical fiber in the second optical fiber pair of the WDM optical transmitter module 1702. The WDM optical transmitter module 1701 sends the optical signal of the wavelength λ5 added with the optical signal with the wavelengths λ6, λ7 and λ8, input from the input optical fiber in the first optical fiber pair, to the intraconnection optical fiber 1713 which is the output optical fiber in the first optical fiber pair and sends the optical signal of the wavelength λ5 to the intraconnection optical fiber 1720 which is the output optical fiber in the second optical fiber pair.

The WDM optical transmitter module 1702 sends the optical signal of the wavelength λ6 added with the optical signal with the wavelengths λ7 and λ8, input from the input optical fiber in the first optical fiber pair, to the intraconnection optical fiber 1714 which is the output optical fiber in the first optical fiber pair and sends the optical signal of the wavelength λ6 added with the optical signal of the wavelength λ5, input from the input optical fiber in the second optical fiber pair, to the intraconnection optical fiber 1719 which is the output optical fiber in the second optical fiber pair. The WDM optical transmitter module 1703 sends the optical signal of the wavelength λ7 added with the optical signal of the wavelength λ8, input from the input optical fiber in the first optical fiber pair, to the intraconnection optical fiber 1715 which is the output optical fiber in the first optical fiber pair and sends the optical signal of the wavelength λ7 added with the optical signal with the wavelengths λ5 and λ6, input from the input optical fiber in the second optical fiber pair, to the intraconnection optical fiber 1718 which is the output optical fiber in the second optical fiber pair. The WDM optical transmitter module 1704 sends the optical signal of the wavelength λ8 to the intraconnection optical fiber 1716 which is the output optical fiber in the first optical fiber pair and sends the optical signal of the wavelength λ8 added with the optical signal with the wavelengths λ5, λ6 and λ7, input from the input optical fiber in the second optical fiber pair, to the intraconnection optical fiber 1717 which is the output optical fiber in the second optical fiber pair.

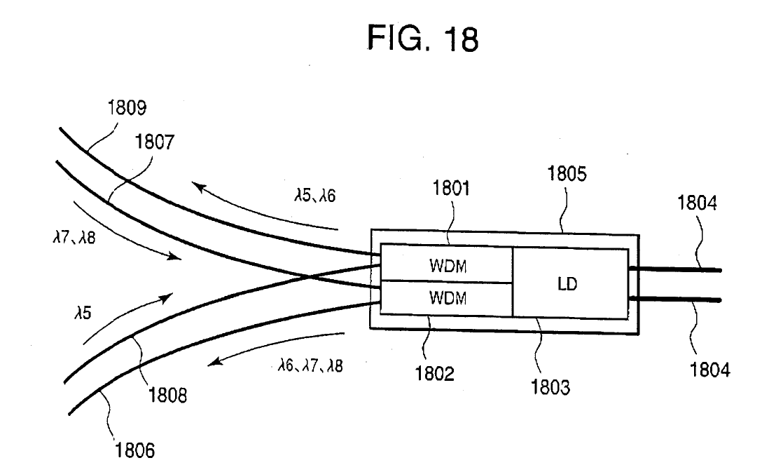

Electric processing circuits 1705, 1706, 1707 and 1708 convert input electric signals to current signals needed by the WDM optical transmitter modules 1701, 1702, 1703 and 1704. Optical transmitting sections 1709, 1710, 1711 and 1712 respectively comprise the associated WDM optical transmitter modules 1701, 1702, 1703 and 1704 and the associated electric processing circuits 1705, 1706, 1707 and 1708. Reference numerals “36”, “37”, “38” and “39” denote electric connectors. FIG. 18 is a block diagram of the WDM optical transmitter module according to the fourteenth embodiment of the invention. Reference numerals “1806”, “1807”, “1808” and “1809” in FIG. 18 are intraconnection optical fibers. Reference numerals “1801” and “180” are wavelength multiplexing/demultiplexing elements which pass an optical signal of a specific wavelength and reflect optical signals of the other wavelengths, “1803” denotes a light emitting element and “1804” denotes an electric interconnection lead. Each of the two wavelength multiplexing/demultiplexing elements 1801 and 1802 is optically coupled to two intraconnection optical fibers 1808 and 1809 or 1806 and 1807, and the light emitting element 1803 is optically coupled to the two wavelength multiplexing/demultiplexing elements 1801 and 1802 and electrically connected to the electric interconnection leads 1804, thereby constituting a WDM optical transmitter module 1805. Although the description on FIG. 18 discusses the case of the WDM optical transmitter module 1702 which transmits an optical signal of the wavelength λ6, the WDM optical transmitter module 1701 which transmits the wavelength λ5, the WDM optical transmitter module 1703 which transmits the wavelength λ7 and the WDM optical transmitter module 1704 which transmits the wavelength λ8 also have the same structure except for the wavelength characteristics of the associated wavelength multiplexing/demultiplexing elements.

The operation of the fourteenth embodiment of the invention will be discussed below. The electric processing circuit 1708 converts the electric signal of the DATA8 input to the optical transmitting section 1712 to a current signal needed by the WDM optical transmitter module 1704. The current signal is converted to an optical signal of the wavelength λ8 by the WDM optical transmitter module 1704 and sent to the intraconnection optical fiber 1716 or the output optical fiber in the first optical fiber pair. The optical signal is also sent together with the optical signal with the wavelengths λ5, λ6 and λ7, input from the input optical fiber in the second optical fiber pair, to the intraconnection optical fiber 1717 or the output optical fiber in the second optical fiber pair and sent to the transfer optical fiber 1 via the optical coupler 1722 and the optical connector 19. The electric processing circuit 1707 converts the electric signal of the DATA7 input to the optical transmitting section 1711 to a current signal needed by the WDM optical transmitter module 1703. The current signal is converted to an optical signal of the wavelength λ7 by the WDM optical transmitter module 1703 and sent together with the optical signal of the wavelength λ8, input from the input optical fiber in the first optical fiber pair, to the intraconnection optical fiber 1715 or the output optical fiber in the first optical fiber pair. The optical signal of the wavelength λ7 is also sent together with the optical signal with the wavelengths λ5 and λ6, input from the input optical fiber in the second optical fiber pair, to the intraconnection optical fiber 1718 or the output optical fiber in the second optical fiber pair.

The electric processing circuit 1706 converts the electric signal of the DATA6 input to the optical transmitting section 1710 to a current signal needed by the WDM optical transmitter module 1702. The current signal is converted to an optical signal of the wavelength λ6 by the WDM optical transmitter module 1702 and sent together with the optical signal of the wavelengths λ7 and λ8, input from the input optical fiber in the first optical fiber pair, to the intraconnection optical fiber 1714 or the output optical fiber in the first optical fiber pair. The optical signal of the wavelength λ6 is also sent together with the optical signal of the wavelength λ5, input from the input optical fiber in the second optical fiber pair, to the intraconnection optical fiber 1719 or the output optical fiber in the second optical fiber pair. The electric processing circuit 1705 converts the electric signal of the DATA5 input to the optical transmitting section 1709 to a current signal needed by the WDM optical transmitter module 1701. The current signal is converted to an optical signal of the wavelength λ5 by the WDM optical transmitter module 1701 and sent together with the optical signal with the wavelengths λ6, λ7 and λ8, input from the input optical fiber in the first optical fiber pair, to the intraconnection optical fiber 1713 or the output optical fiber in the first optical fiber pair. This optical signal is sent to the transfer optical fiber 1 via the optical coupler 1722 and the optical connector 19 and is also sent to the intraconnection optical fiber 1720 or the output optical fiber in the second optical fiber pair.

As apparent from the above, the fourteenth embodiment of the invention can eliminate the wavelength multiplexing/demultiplexing section as compared with the conventional optical transmitting apparatus and can provide an excellent, live-insertable (hot-plugable) WDM optical transmitting apparatus which is prevented from become larger even if the number of wavelength multiplexing stages is increased and does not influence the other optical transmitting sections, due to the dual sequential connection, even if one optical transmitting section fails and needs replacement.

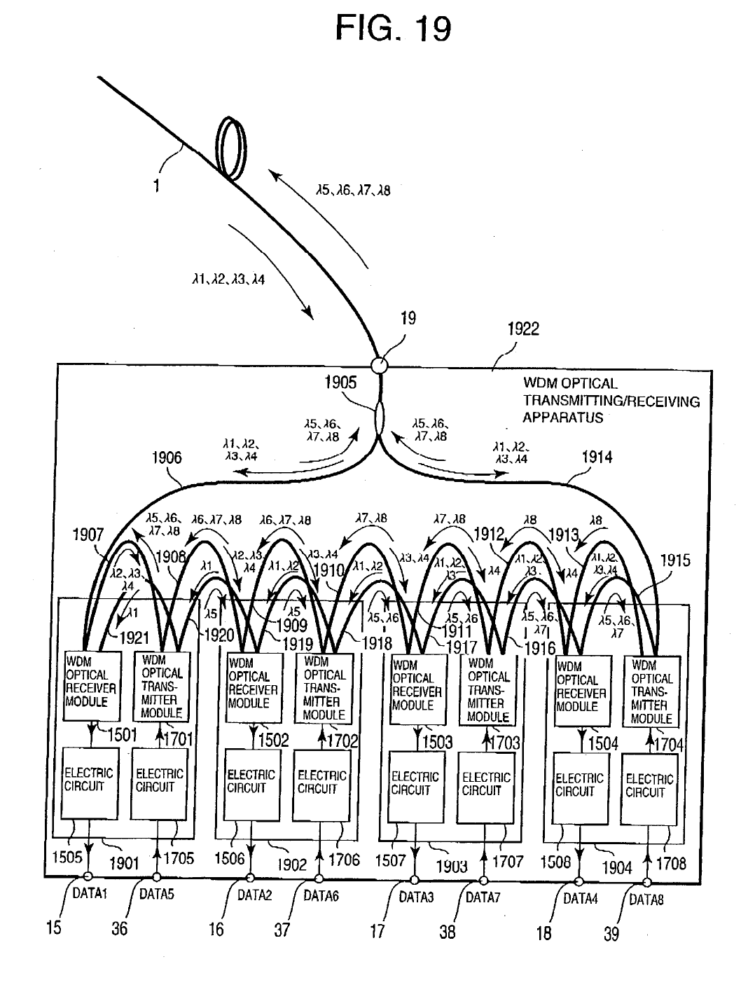

FIG. 19 shows the fifteenth embodiment of the invention. Reference numeral “1922” in FIG. 19 is a WDM optical transmitting/receiving apparatus. The WDM optical transmitting/receiving apparatus 1922 receives an optical signal with four wavelengths (λ1, λ2, λ3, λ4) from the transfer optical fiber 1 via the optical connector 19 and multiplexes optical signals with wavelengths (λ5, λ6, λ7, λ8) and outputs the multiplexed optical signal to the transfer optical fiber 1. Intraconnection optical fibers 1906, 1907, 1908, 1909, 1910, 1911, 1912, 1913, 1914, 1915, 1916, 1917, 1918, 1919, 1920 and 1921 optically connect the components inside the apparatus to one another. Reference numerals “1501”, “1502”, “1503” and “1504” are WDM optical receiver modules each of which has two pairs of optical fibers each having an input optical fiber and an output optical fiber. The WDM optical receiver module 1501 outputs a current signal corresponding to the optical signal power of the wavelength λ1, the WDM optical receiver module 1502 outputs a current signal corresponding to the optical signal power of the wavelength λ2, the WDM optical receiver module 1503 outputs a current signal corresponding to the optical signal power of the wavelength λ3 and the WDM optical receiver module 1504 outputs a current signal corresponding to the optical signal power of the wavelength λ4.

Each of WDM optical transmitter modules 1701, 1702, 1703 and 1704 has two pairs of optical fibers each having an input optical fiber and an output optical fiber. The WDM optical transmitter module 1701 outputs an optical signal of the wavelength λ5 corresponding to the input current, the WDM optical transmitter module 1702 outputs an optical signal of the wavelength λ6 corresponding to the input current, the WDM optical transmitter module 1703 outputs an optical signal of the wavelength λ7 corresponding to the input current, and the WDM optical transmitter module 1704 outputs an optical signal of the wavelength λ8 corresponding to the input current. The intraconnection optical fiber 1906 or the input optical fiber in the first optical fiber pair of the WDM optical receiver module 1501 is connected to the transfer optical fiber 1 via an optical coupler 1905 and optical connector 19. The intraconnection optical fiber 1907 or the output optical fiber in the first optical fiber pair of the WDM optical transmitter module 1701 is connected to the output optical fiber in the first optical fiber pair of the WDM optical receiver module 1501. The intraconnection optical fiber 1908 or the input optical fiber in the first optical fiber pair of the WDM optical receiver module 1502 is connected to the input optical fiber in the first optical fiber of the WDM optical transmitter module 1701. The intraconnection optical fiber 1909 or the output optical fiber in the first optical fiber pair of the WDM optical transmitter module 1702 is connected to the output optical fiber in the first optical fiber pair of the WDM optical receiver module 1502. The intraconnection optical fiber 1910 or the input optical fiber in the first optical fiber pair of the WDM optical receiver module 1503 is connected to the input optical fiber in the first optical fiber of the WDM optical transmitter module 1702. The intraconnection optical fiber 1911 or the output optical fiber in the first optical fiber pair of the WDM optical transmitter module 1703 is connected to the output optical fiber in the first optical fiber pair of the WDM optical receiver module 1503. The intraconnection optical fiber 1912 or the input optical fiber in the first optical fiber pair of the WDM optical receiver module 1504 is connected to the input optical fiber in the first optical fiber of the WDM optical transmitter module 1703. The intraconnection optical fiber 1913 or the output optical fiber in the first optical fiber pair of the WDM optical transmitter module 1704 is connected to the output optical fiber in the first optical fiber pair of the WDM optical receiver module 1504.

The intraconnection optical fiber 1914 or the output optical fiber in the second optical fiber pair of the WDM optical transmitter module 1704 is connected to the transfer optical fiber 1 via the optical coupler 1905 and the optical connector 19. The intraconnection optical fiber 1915 or the input optical fiber in the second optical fiber pair of the WDM optical receiver module 1504 is connected to the input optical fiber in the second optical fiber of the WDM optical transmitter module 1704. The intraconnection optical fiber 1916 or the output optical fiber in the second optical fiber pair of the WDM optical transmitter module 1703 is connected to the output optical fiber in the second optical fiber pair of the WDM optical receiver module 1504. The intraconnection optical fiber 1917 or the input optical fiber in the second optical fiber pair of the WDM optical receiver module 1503 is connected to the input optical fiber in the second optical fiber of the WDM optical transmitter module 1703. The intraconnection optical fiber 1918 or the output optical fiber in the second optical fiber pair of the WDM optical transmitter module 1702 is connected to the output optical fiber in the second optical fiber pair of the WDM optical receiver module 1503. The intraconnection optical fiber 1919 or the input optical fiber in the second optical fiber pair of the WDM optical receiver module 1502 is connected to the input optical fiber in the second optical fiber of the WDM optical transmitter module 1702. The intraconnection optical fiber 1920 or the output optical fiber in the second optical fiber pair of the WDM optical transmitter module 1701 is connected to the output optical fiber in the second optical fiber pair of the WDM optical receiver module 1502. The intraconnection optical fiber 1921 or the input optical fiber in the second optical fiber pair of the WDM optical receiver module 1501 is connected to the input optical fiber in the second optical fiber of the WDM optical transmitter module 1701.

Reference numerals “1505”, “1506”, “1507”, “1508”, “1705”, “1706”, “1707” and “1708” are electric processing circuits. Reference numerals “1901”, “1902”, “1903” and “1904” are optical transmitting sections, which respectively comprise the associated WDM optical transmitter modules 1701, 1702, 1703 and 1704 and the associated electric processing circuits 1505, 1506, 1507, 1508, 1705, 1706, 1707 and 1708. Reference numerals “15”, “16”, “17”, “18”, “36”, “37”, “38” and “39” are electric connectors.

The operation will now be discussed. The DATA5 to DATA8 input to the WDM optical transmitting/receiving apparatus 1922 in FIG. 19 are converted optical signals with the wavelengths λ5, λ6, λ7 and λ8 by the electric processing circuits 1705, 1706, 1707 and 1708 and the WDM optical transmitter modules 1701, 1702, 1703 and 1704. The optical signal of the wavelength λ8 is added to the optical signal with the wavelengths λ5, λ6 and λ7, input from the input optical fiber in the second optical fiber pair of the WDM optical transmitter module 1704, and is output to the transfer optical fiber 1 via the optical coupler 1905 and optical connector 19 from the intraconnection optical fiber 1914 or the output optical fiber. The optical signal of the wavelength λ8 is also input to the intraconnection optical fiber 1913 or the input optical fiber in the first optical fiber pair of the WDM optical receiver module 1504 and is directly input to the input optical fiber in the first optical fiber pair of the WDM optical transmitter module 1703.

In the WDM optical transmitter module 1703, the optical signal of the wavelength λ7 is added to the optical signal of the wavelength λ8 input to the input optical fiber in the first optical fiber pair and the resultant optical signal is input to the output optical fiber in the first optical fiber pair of the WDM optical receiver module 1503 and is directly output to the input optical fiber in the first optical fiber pair of the WDM optical transmitter module 1702, the optical signal of the wavelength λ7 is added to the optical signal with the wavelengths λ5 and λ6 input from the input optical fiber in the second optical fiber pair and the resultant optical signal is input to the output optical fiber in the second optical fiber pair of the WDM optical receiver module 1504 and is directly input to the input optical fiber in the second optical fiber pair of the WDM optical transmitter module 1704. In the WDM optical transmitter module 1702, the optical signal of the wavelength λ6 is added to the optical signal of the wavelengths λ7 and λ8 input to the input optical fiber in the first optical fiber pair and the resultant optical signal is input to the output optical fiber in the first optical fiber pair of the WDM optical receiver module 1502 and is directly output to the input optical fiber in the first optical fiber pair of the WDM optical transmitter module 1701, the optical signal of the wavelength λ6 is added to the optical signal of the wavelength λ5 input from the input optical fiber in the second optical fiber pair and the resultant optical signal is input to the output optical fiber in the second optical fiber pair of the WDM optical receiver module 1503 and is directly input to the input optical fiber in the second optical fiber pair of the WDM optical transmitter module 1703. In the WDM optical transmitter module 1701, the optical signal of the wavelength λ5 is added to the optical signal of the wavelengths λ6, λ7 and λ8 input to the input optical fiber in the first optical fiber pair, the resultant optical signal is input to the output optical fiber in the first optical fiber pair of the WDM optical receiver module 1501 and is directly output to the transfer optical fiber 1 via the optical coupler 1905 and optical connector 19, and the optical signal of the wavelength λ5 is input to the output optical fiber in the second optical fiber pair of the WDM optical receiver module 1502 and is directly input to the input optical fiber in the second optical fiber pair of the WDM optical transmitter module 1702.

Meanwhile, the optical signals with the four wavelengths λ1, λ2, λ3 and λ4 are split into two by the optical coupler 1905, one being input to the input optical fiber in the first optical fiber pair of the WDM optical receiver module 1501 while the other one is input to the output optical fiber in the second optical fiber pair of the WDM optical transmitter module 1704 and is directly input to the input optical fiber in the second optical fiber pair of the WDM optical receiver module 1504. Of the optical signal of λ1, λ2, λ3 and λ4, input to the input optical fiber in the first optical fiber pair of the WDM optical receiver module 1501, only the optical signal of the wavelength λ1 is converted to an electric signal by the WDM optical receiver module 1501 and DATA1 is reproduced and output by the electric processing circuit 1505. The optical signal of the wavelength λ1, input to the input optical fiber in the second optical fiber pair of the WDM optical receiver module 1501, is converted to an electric signal by the WDM optical receiver module 1501 and DATA1 is reproduced and output by the electric processing circuit 1505. Of the optical signal of λ2, λ3 and λ4, input to the input optical fiber in the first optical fiber pair of the WDM optical receiver module 1502, only the optical signal of the wavelength λ2 is converted to an electric signal by the WDM optical receiver module 1502 and DATA1 is reproduced and output by the electric processing circuit 1506, and the optical signal with the wavelengths λ3 and λ4 is input to the WDM optical receiver module 1503 via the WDM optical transmitter module 1702. Of the optical signal of λ1 and λ2 input to the input optical fiber in the second optical fiber pair of the WDM optical receiver module 1502, only the optical signal of the wavelength λ2 is converted to an electric signal by the WDM optical receiver module 1502 and DATA2 is reproduced and output by the electric processing circuit 1506 and the optical signal of λ1 is input to the WDM optical receiver module 1501 via the WDM optical transmitter module 1701.

Of the optical signal of λ3 and λ4, input to the input optical fiber in the first optical fiber pair of the WDM optical receiver module 1503, only the optical signal of the wavelength λ3 is converted to an electric signal by the WDM optical receiver module 1503 and DATA3 is reproduced and output by the electric processing circuit 1507, and the optical signal of the wavelength λ4 is input to the WDM optical receiver module 1504 via the WDM optical transmitter module 1703. Of the optical signal of λ1, λ2 and λ3 input to the input optical fiber in the second optical fiber pair of the WDM optical receiver module 1503, only the optical signal of the wavelength λ3 is converted to an electric signal by the WDM optical receiver module 1503 and DATA3 is reproduced and output by the electric processing circuit 1507 and the optical signal of λ1 and λ2 is input to the WDM optical receiver module 1502 via the WDM optical transmitter module 1702. The optical signal of λ4, input to the input optical fiber in the first optical fiber pair of the WDM optical receiver module 1504 is converted to an electric signal by the WDM optical receiver module 1504 and DATA4 is reproduced and output by the electric processing circuit 1508. Of the optical signal of λ1, λ2, λ3 and input to the input optical fiber in the second optical fiber pair of the WDM optical receiver module 1504, only the optical signal of the wavelength λ4 is converted to an electric signal by the WDM optical receiver module 1504 and DATA4 is reproduced and output by the electric processing circuit 1508 and the optical signal of λ1, λ2 and λ3 is input to the WDM optical receiver module 1503 via the WDM optical transmitter module 1703. As apparent from the above, the fifteenth embodiment of the invention can eliminate the wavelength multiplexing/demultiplexing section as compared with the conventional optical transmitting/receiving apparatus and can provide an excellent, live-insertable (hot-plugable) WDM optical transmitting/receiving apparatus which is prevented from become larger even if the number of wavelength multiplexing stages is increased and does not influence the other optical transmitting/receiving sections, due to the dual sequential connection, even if one optical transmitting/receiving section fails and needs replacement.

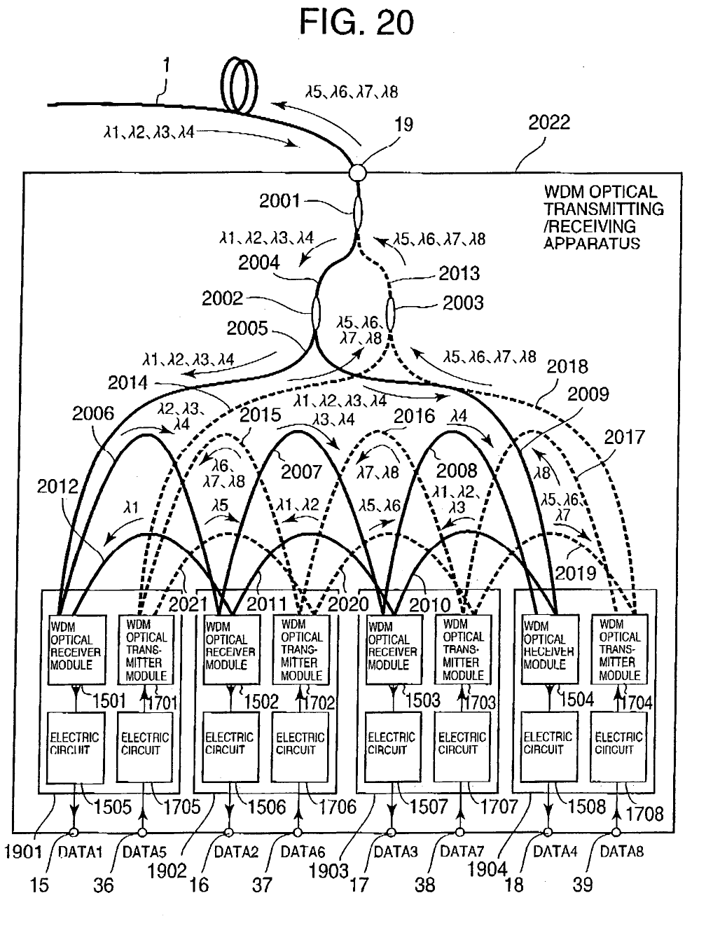

FIG. 20 shows the sixteenth embodiment of the invention. Reference numeral “2002” in FIG. 20 is a WDM optical transmitting/receiving apparatus. Reference numeral “2001” is a wavelength multiplexing/demultiplexing coupler and “2002” and “2003” are optical couplers each of which splits an input optical signal to two. The wavelength multiplexing/demultiplexing coupler 2001 sends the optical signal with the wavelengths λ1, λ2, λ3 and λ4, input via the optical connector 19, to the optical coupler 2002 and sends the optical signal with the wavelengths λ5, λ6, λ7 and λ8, input from the optical coupler 2003, via the optical connector 19. The WDM optical transmitting/receiving apparatus 2022 receives four wavelengths (λ1, λ2, λ3, λ4) via the optical connector 19 from the transfer optical fiber 1 and multiplexes optical signals with four wavelengths (λ5, λ6, λ7, λ8) and outputs the multiplexed optical signal to the transfer optical fiber 1. Intraconnection optical fibers 2004 to 2021 optically connect the components inside the apparatus to one another. Each of WDM optical receiver modules 1501, 1502, 1503 and 1504 has two pairs of optical fibers each having an input optical fiber and an output optical fiber. The WDM optical receiver module 1501 outputs a current signal corresponding to the optical signal power of the wavelength λ1, the WDM optical receiver module 1502 outputs a current signal corresponding to the optical signal power of the wavelength λ2, the WDM optical receiver module 1503 outputs a current signal corresponding to the optical signal power of the wavelength λ3 and the WDM optical receiver module 1504 outputs a current signal corresponding to the optical signal power of the wavelength λ4.

The input optical fiber in the first optical fiber pair of the WDM optical receiver module 1501 is connected to the transfer optical fiber 1 via the optical coupler 2002, the wavelength multiplexing/demultiplexing coupler 2001 and the optical connector 19, the input optical fiber in the first optical fiber pair of the WDM optical receiver module 1502 is connected to the output optical fiber in the first optical fiber pair of the WDM optical receiver module 1501, the input optical fiber in the first optical fiber pair of the WDM optical receiver module 1503 is connected to the output optical fiber in the first optical fiber pair of the WDM optical receiver module 1502, and the input optical fiber in the first optical fiber pair of the WDM optical receiver module 1504 is connected to the output optical fiber in the first optical fiber pair of the WDM optical receiver module 1503. The input optical fiber in the second optical fiber pair of the WDM optical receiver module 1504 is connected to the transfer optical fiber 1 via the optical coupler 2003, the wavelength multiplexing/demultiplexing coupler 2001 and the optical connector 19, the input optical fiber in the second optical fiber pair of the WDM optical receiver module 1503 is connected to the output optical fiber in the second optical fiber pair of the WDM optical receiver module 1504, the input optical fiber in the second optical fiber pair of the WDM optical receiver module 1502 is connected to the output optical fiber in the second optical fiber pair of the WDM optical receiver module 1503, and the input optical fiber in the second optical fiber pair of the WDM optical receiver module 1501 is connected to the output optical fiber in the second optical fiber pair of the WDM optical receiver module 1502.

Electric processing circuits 1505, 1506, 1507 and 1508 convert current signals output from the WDM optical receiver modules 1501 to 1504 to demanded signal forms or signal levels. Each of WDM optical transmitter modules 1701, 1702, 1703 and 1704 has two pairs of optical fibers each having an input optical fiber and an output optical fiber. The output optical fiber in the first optical fiber pair of the WDM optical transmitter module 1701 is connected to the transfer optical fiber 1 via the optical coupler 2003, the wavelength multiplexing/demultiplexing coupler 2001 and the optical connector 19, the output optical fiber in the first optical fiber pair of the WDM optical transmitter module 1702 is connected to the input optical fiber in the first optical fiber pair of the WDM optical transmitter module 1701, the output optical fiber in the first optical fiber pair of the WDM optical transmitter module 1703 is connected to the input optical fiber in the first optical fiber pair of the WDM optical transmitter module 1702, and the output optical fiber in the first optical fiber pair of the WDM optical transmitter module 1704 is connected to the input optical fiber in the first optical fiber pair of the WDM optical transmitter module 1703.

The output optical fiber in the second optical fiber pair of the WDM optical transmitter module 1704 is connected to the transfer optical fiber 1 via the optical coupler 2003, the wavelength multiplexing/demultiplexing coupler 2001-and the optical connector 19, the output optical fiber in the second optical fiber pair of the WDM optical transmitter module 1703 is connected to the input optical fiber in the second optical fiber pair of the WDM optical transmitter module 1704, the output optical fiber in the second optical fiber pair of the WDM optical transmitter module 1702 is connected to the input optical fiber in the second optical fiber pair of the WDM optical transmitter module 1703, and the output optical fiber in the second optical fiber pair of the WDM optical transmitter module 1701 is connected to the input optical fiber in the second optical fiber pair of the WDM optical transmitter module 1702. The WDM optical transmitter module 1701 sends the optical signal of the wavelength λ5 added with the optical signal with the wavelengths λ6, λ7 and λ8, input from the input optical fiber in the first optical fiber pair, to the output optical fiber in the first optical fiber pair and sends the optical signal of the wavelength λ5 to the output optical fiber in the second optical fiber pair.

The WDM optical transmitter module 1702 sends the optical signal of the wavelength λ6 added with the optical signal with the wavelengths λ7 and λ8, input from the input optical fiber in the first optical fiber pair, to the output optical fiber in the first optical fiber pair and sends the optical signal of the wavelength λ6 added with the optical signal of the wavelength λ5, input from the input optical fiber in the second optical fiber pair, to the output optical fiber in the second optical fiber pair. The WDM optical transmitter module 1703 sends the optical signal of the wavelength λ7 added with the optical signal of the wavelength λ8, input from the input optical fiber in the first optical fiber pair, to the output optical fiber in the first optical fiber pair and sends the optical signal of the wavelength λ7 added with the optical signal with the wavelengths λ5 and λ6, input from the input optical fiber in the second optical fiber pair, to the output optical fiber in the second optical fiber pair. The WDM optical transmitter module 1704 sends the optical signal of the wavelength λ8 to the output optical fiber in the first optical fiber pair and sends the optical signal of the wavelength λ8 added with the optical signal with the wavelengths λ5, λ6 and λ7, input from the input optical fiber in the second optical fiber pair, to the output optical fiber in the second optical fiber pair.

Electric processing circuits 1705, 1706, 1707 and 1708 convert input electric signals to current signals needed by the WDM optical transmitter modules 1701, 1702, 1703 and 1704. Optical transmitting/receiving sections 1901, 1902, 1903 and 1904 respectively comprise the associated WDM optical receiver modules 1501, 1502, 1503 and 1504, the associated WDM optical transmitter modules 1701, 1702, 1703 and 1704 and the associated electric processing circuits 1505, 1506, 1507, 1508, 1705, 1706, 1707 and 1708. Reference numerals “15”, “16”, “17”, “18”, “36”, “37”, “38” and “39” denote electric connectors.

The operation of the sixteenth embodiment of the invention will be discussed below. The optical signals with the four wavelengths λ1, λ2, λ3 and λ4 input to the WDM optical transmitting/receiving apparatus 2022 in FIG. 20 are input to the optical coupler 2002 via the wavelength multiplexing/demultiplexing coupler 2001, and split into two by the optical coupler 2002, one being input to the first pair of optical fibers of the WDM optical receiver module 1501. Only the optical signal of the wavelength λ1 is converted to an electric signal by the WDM optical receiver module 1501 and DATA1 is reproduced and output by the electric processing circuit 1505. The optical signals with the wavelengths λ2, λ3 and λ4 are input to the WDM optical receiver module 1502 from the WDM optical receiver module 1501, and only the optical signal of the wavelength λ2 is converted to an electric signal by the WDM optical receiver module 1502 and DATA2 is reproduced and output by the electric processing circuit 1506. Further, the optical signals with the wavelengths λ3 and λ4 are input to the WDM optical receiver module 1503 from the WDM optical receiver module 1502, and only the optical signal of the wavelength λ3 is converted to an electric signal by the WDM optical receiver module 1503 and DATA3 is reproduced and output by the electric processing circuit 1507.

Furthermore, the optical signal of the wavelength λ4 is input to the WDM optical receiver module 1504 from the WDM optical receiver module 1503, and converted to an electric signal by the WDM optical receiver module 1504 and DATA4 is reproduced and output by the electric processing circuit 1508. The other output of the optical coupler 2002 is input to the second pair of optical fibers of the WDM optical receiver module 1504. Only the optical signal with the wavelength λ4 is converted to an electric signal by the WDM optical receiver module 1504 and DATA4 is reproduced and output by the electric processing circuit 1508. The optical signals with the wavelengths λl, λ2 and λ3 are input to the WDM optical receiver module 1503 from the WDM optical receiver module 1504, and only the optical signal of the wavelength λ3 is converted to an electric signal by the WDM optical receiver module 1503 and DATA3 is reproduced and output by the electric processing circuit 1507.

Further, the optical signals with the wavelengths λ1 and λ2 are input to the WDM optical receiver module 1502 from the WDM optical receiver module 1503, and only the optical signal of the wavelength λ2 is converted to an electric signal by the WDM optical receiver module 1502 and DATA2 is reproduced and output by the electric processing circuit 1506. Furthermore, the optical signal of the wavelength λ1 is input to the WDM optical receiver module 1501 from the WDM optical receiver module 1502, and converted to an electric signal by the WDM optical receiver module 1501 and DATA1 is reproduced and output by the electric processing circuit 1505. The electric processing circuit 1708 converts the electric signal of the DATA8, input to the optical transmitting/receiving section 1904, to a current signal needed by the WDM optical transmitter module 1704. The current signal is converted to an optical signal of the wavelength λ8 by the WDM optical transmitter module 1704 and sent by the output optical fiber in the first optical fiber pair. The optical signal is also sent together with the optical signal with the wavelengths λ5, λ6 and λ7, input from the input optical fiber in the second optical fiber pair, by the output optical fiber in the second optical fiber pair and sent to the transfer optical fiber 1 via the optical coupler 2003, the wavelength multiplexing/demultiplexing coupler 2001 and the optical connector 19.

The electric processing circuit 1707 converts the electric signal of the DATA7 input to the optical transmitting/receiving section 1903 to a current signal needed by the WDM optical transmitter module 1703. The current signal is converted to an optical signal of the wavelength λ7 by the WDM optical transmitter module 1703 and sent together with the optical signal of the wavelength λ8, input from the input optical fiber in the first optical fiber pair, by the output optical fiber in the first optical fiber pair. The optical signal of the wavelength λ7 is also sent together with the optical signal with the wavelengths λ5 and λ6, input from the input optical fiber in the second optical fiber pair, by the output optical fiber in the second optical fiber pair. The electric processing circuit 1706 converts the electric signal of the DATA6, input to the optical transmitting/receiving section 1902, to a current signal needed by the WDM optical transmitter module 1702. The current signal is converted to an optical signal of the wavelength λ6 by the WDM optical transmitter module 1702 and sent together with the optical signal of the wavelengths λ7 and λ8, input from the input optical fiber in the first optical fiber pair, by the output optical fiber in the first optical fiber pair. The optical signal of the wavelength λ6 is also sent together with the optical signal of the wavelength λ5, input from the input optical fiber in the second optical fiber pair, by the output optical fiber in the second optical fiber pair.

The electric processing circuit 1705 converts the electric signal of the DATA5, input to the optical transmitting/receiving section 1901, to a current signal needed by the WDM optical transmitter module 1701. The current signal is converted to an optical signal of the wavelength λ5 by the WDM optical transmitter module 1701 and sent together with the optical signal with the wavelengths λ6, λ7 and λ8, input from the input optical fiber in the first optical fiber pair, by the output optical fiber in the first optical fiber pair. This optical signal is sent to the transfer optical fiber 1 via the optical coupler 2003, the wavelength multiplexing/demultiplexing coupler 2001 and the optical connector 19 and is also sent by the output optical fiber in the second optical fiber pair. As apparent from the above, the sixteenth embodiment of the invention can make the wavelength multiplexing/demultiplexing section smaller in size as compared with the conventional optical transmitting/receiving apparatus and can provide an excellent, live-insertable (hot-plugable) WDM optical transmitting/receiving apparatus which is prevented from become larger even if the number of wavelength multiplexing stages is increased and does not influence the other optical transmitting/receiving sections, due to the dual sequential connection, even if one optical transmitting/receiving section fails and needs replacement.

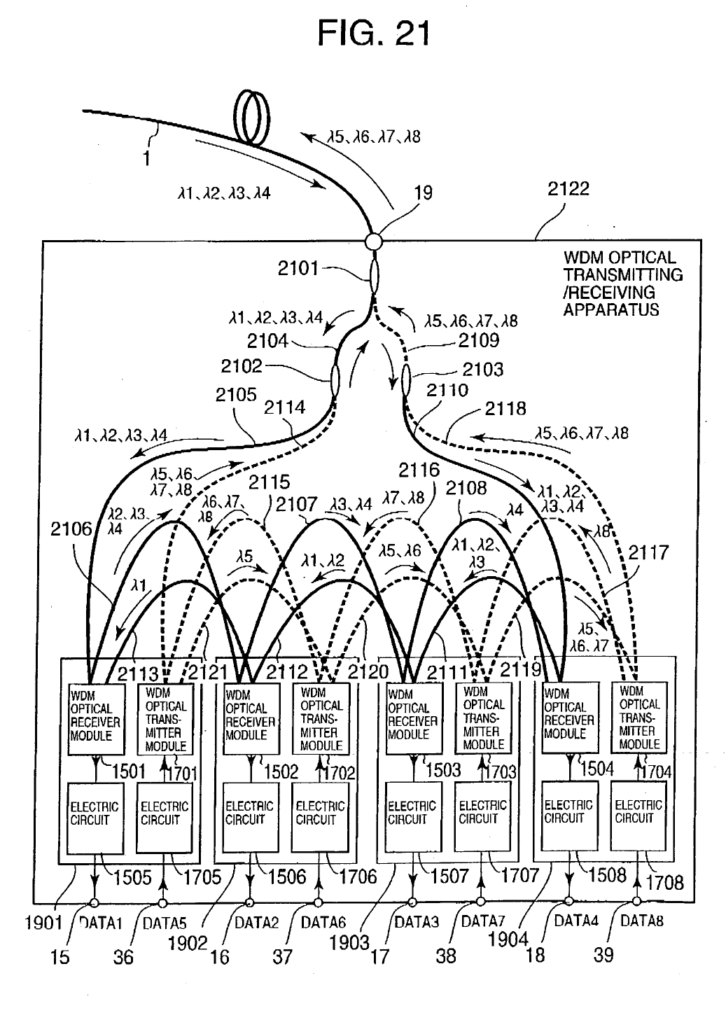

FIG. 21 shows the seventeenth embodiment of the invention. Reference numeral “2122” in FIG. 21 is a WDM optical transmitting/receiving apparatus. The WDM optical transmitting/receiving apparatus 2122 receives an optical signal with four wavelengths (λ1, λ2, λ3, λ4) from the transfer optical fiber 1 via the optical connector 19 and multiplexes optical signals with wavelengths (λ5, λ6, λ7, λ8) and outputs the multiplexed optical signal to the transfer optical fiber 1. Reference numerals “2102” and “2103” are wavelength multiplexing/demultiplexing couplers and “2101” is an optical coupler of which splits an input optical signal to two. The optical coupler 2101 sends the optical signal with the wavelengths λ1, λ2, λ3 and λ4, input via the optical connector 19, to the two wavelength multiplexing/demultiplexing couplers 2102 and 2103 and sends the optical signal with the wavelengths λ5, λ6, λ7 and λ8, input from the wavelength multiplexing/demultiplexing couplers 2102 and 2103, to the transfer optical fiber 1 via the optical connector 19. The wavelength multiplexing/demultiplexing coupler 2102 sends the input optical signal of λ1, λ2, λ3 and λ4 to the WDM optical receiver module 1501 and sends the optical signal of λ5, λ6, λ7 and λ8, input from the WDM optical transmitter module 1701, to the optical coupler 2101.

The other wavelength multiplexing/demultiplexing coupler 2103 sends the input optical signal of λ1, λ2, λ3 and λ4 to the WDM optical receiver module 1504 and sends the optical signal of λ5, λ6, λ7 and λ8, input from the WDM optical transmitter module 1704, to the transfer optical fiber 1 via the optical coupler 2101 and the optical connector 19. Intraconnection optical fibers 2104 to 2121 optically connect the components inside the apparatus to one another. Each of WDM optical receiver modules 1501, 1502, 1503 and 1504 has two pairs of optical fibers each having an input optical fiber and an output optical fiber. The WDM optical receiver module 1501 outputs a current signal corresponding to the optical signal power of the wavelength λ1, the WDM optical receiver module 1502 outputs a current signal corresponding to the optical signal power of the wavelength λ2, the WDM optical receiver module 1503 outputs a current signal corresponding to the optical signal power of the wavelength λ3 and the WDM optical receiver module 1504 outputs a current signal corresponding to the optical signal power of the wavelength λ4.

The input optical fiber in the first optical fiber pair of the WDM optical receiver module 1501 is connected to the transfer optical fiber 1 via the optical coupler 2101, the wavelength multiplexing/demultiplexing coupler 2102 and the optical connector 19, the input optical fiber in the first optical fiber pair of the WDM optical receiver module 1502 is connected to the output optical fiber in the first optical fiber pair of the WDM optical receiver module 1501, the input optical fiber in the first optical fiber pair of the WDM optical receiver module 1503 is connected to the output optical fiber in the first optical fiber pair of the WDM optical receiver module 1502, and the input optical fiber in the first optical fiber pair of the WDM optical receiver module 1504 is connected to the output optical fiber in the first optical fiber pair of the WDM optical receiver module 1503. The input optical fiber in the second optical fiber pair of the WDM optical receiver module 1504 is connected to the transfer optical fiber 1 via the optical coupler 2101, the wavelength multiplexing/demultiplexing coupler 2103 and the optical connector 19, the input optical fiber in the second optical fiber pair of the WDM optical receiver module 1503 is connected to the output optical fiber in the second optical fiber pair of the WDM optical receiver module 1504, the input optical fiber in the second optical fiber pair of the WDM optical receiver module 1502 is connected to the output optical fiber in the second optical fiber pair of the WDM optical receiver module 1503, and the input optical fiber in the second optical fiber pair of the WDM optical receiver module 1501 is connected to the output optical fiber in the second optical fiber pair of the WDM optical receiver module 1502.

Electric processing circuits 1505, 1506, 1507 and 1508 convert current signals output from the WDM optical receiver modules 1501 to 1504 to demanded signal forms or signal levels. Each of WDM optical transmitter modules 1701, 1702, 1703 and 1704 has two pairs of optical fibers each having an input optical fiber and an output optical fiber. The output optical fiber in the first optical fiber pair of the WDM optical transmitter module 1701 is connected to the transfer optical fiber 1 via the optical coupler 2101, the wavelength multiplexing/demultiplexing coupler 2102 and the optical connector 19, the output optical fiber in the first optical fiber pair of the WDM optical transmitter module 1702 is connected to the input optical fiber in the first optical fiber pair of the WDM optical transmitter module 1701, the output optical fiber in the first optical fiber pair of the WDM optical transmitter module 1703 is connected to the input optical fiber in the first optical fiber pair of the WDM optical transmitter module 1702, and the output optical fiber in the first optical fiber pair of the WDM optical transmitter module 1704 is connected to the input optical fiber in the first optical fiber pair of the WDM optical transmitter module 1703.

The output optical fiber in the second optical fiber pair of the WDM optical transmitter module 1704 is connected to the transfer optical fiber 1 via the optical coupler 2101, the wavelength multiplexing/demultiplexing coupler 2103 and the optical connector 19, the output optical fiber in the second optical fiber pair of the WDM optical transmitter module 1703 is connected to the input optical fiber in the second optical fiber pair of the WDM optical transmitter module 1704, the output optical fiber in the second optical fiber pair of the WDM optical transmitter module 1702 is connected to the input optical fiber in the second optical fiber pair of the WDM optical transmitter module 1703, and the output optical fiber in the second optical fiber pair of the WDM optical transmitter module 1701 is connected to the input optical fiber in the second optical fiber pair of the WDM optical transmitter module 1702. The WDM optical transmitter module 1701 sends the optical signal of the wavelength λ5 added with the optical signal with the wavelengths λ6, λ7 and λ8, input from the input optical fiber in the first optical fiber pair, to the output optical fiber in the first optical fiber pair and sends the optical signal of the wavelength λ5 to the output optical fiber in the second optical fiber pair. The WDM optical transmitter module 1702 sends the optical signal of the wavelength λ6 added with the optical signal with the wavelengths λ7 and λ8, input from the input optical fiber in the first optical fiber pair, to the output optical fiber in the first optical fiber pair and sends the optical signal of the wavelength λ6 added with the optical signal of the wavelength λ5, input from the input optical fiber in the second optical fiber pair, to the output optical fiber in the second optical fiber pair. The WDM optical transmitter module 1703 sends the optical signal of the wavelength λ7 added with the optical signal of the wavelength λ8, input from the input optical fiber in the first optical fiber pair, to the output optical fiber in the first optical fiber pair and sends the optical signal of the wavelength λ7 added with the optical signal with the wavelengths λ5 and λ6, input from the input optical fiber in the second optical fiber pair, to the output optical fiber in the second optical fiber pair.

The WDM optical transmitter module 1704 sends the optical signal of the wavelength λ8 to the output optical fiber in the first optical fiber pair and sends the optical signal of the wavelength λ8 added with the optical signal with the wavelengths λ5, λ6 and λ7, input from the input optical fiber in the second optical fiber pair, to the output optical fiber in the second optical fiber pair. Electric processing circuits 1705, 1706, 1707 and 1708 convert input electric signals to current signals needed by the WDM optical transmitter modules 1701, 1702, 1703 and 1704. Optical transmitting/receiving sections 1901, 1902, 1903 and 1904 respectively comprise the associated WDM optical receiver modules 1501, 1502, 1503 and 1504, the associated WDM optical transmitter modules 1701, 1702, 1703 and 1704 and the associated electric processing circuits 1505, 1506, 1507, 1508, 1705, 1706, 1707 and 1708. Reference numerals “15”, “16”, “17”, “18”, “36”, “37”, “38” and “39” denote electric connectors.

The operation of the seventeenth embodiment of the invention will be described below. The optical signals with the four wavelengths λ1, λ2, λ3 and λ4 input to the WDM optical transmitting/receiving apparatus 2122 in FIG. 21 are split into two by the optical coupler 2101, one being input to the WDM optical receiver module 1501 via the wavelength multiplexing/demultiplexing coupler 2102. The other one split by the optical coupler 2101 is input to the WDM optical receiver module 504 via the wavelength multiplexing/demultiplexing coupler 2103. Of the optical signal input to the WDM optical receiver module 1501, only the optical signal of the wavelength λ1 is converted to an electric signal by the WDM optical receiver module 1501 and DATA1 is reproduced and output by the electric processing circuit 1505. The optical signals with the wavelengths λ2, λ3 and λ4 are input to the WDM optical receiver module 1502 from the WDM optical receiver module 1501, and only the optical signal of the wavelength λ2 is converted to an electric signal by the WDM optical receiver module 1502 and DATA2 is reproduced and output by the electric processing circuit 1506.

Further, the optical signals with the wavelengths λ3 and λ4 are input to the WDM optical receiver module 1503 from the WDM optical receiver module 1502, and only the optical signal of the wavelength λ3 is converted to an electric signal by the WDM optical receiver module 1503 and DATA3 is reproduced and output by the electric processing circuit 1507. Furthermore, the optical signal of the wavelength λ4 is input to the WDM optical receiver module 1504 from the WDM optical receiver module 1503, and converted to an electric signal by the WDM optical receiver module 1504 and DATA4 is reproduced and output by the electric processing circuit 1508. Of the optical signal input to the WDM optical receiver module 1504, only the optical signal with the wavelength λ4 is converted to an electric signal by the WDM optical receiver module 1504 and DATA4 is reproduced and output by the electric processing circuit 1508. The optical signals with the wavelengths λ1, λ2 and λ3 are input to the WDM optical receiver module 1503 from the WDM optical receiver module 1504, and only the optical signal of the wavelength λ3 is converted to an electric signal by the WDM optical receiver module 1503 and DATA3 is reproduced and output by the electric processing circuit 1507. Further, the optical signals with the wavelengths λ1 and λ2 are input to the WDM optical receiver module 1502 from the WDM optical receiver module 1503, and only the optical signal of the wavelength λ2 is converted to an electric signal by the WDM optical receiver module 1502 and DATA2 is reproduced and output by the electric processing circuit 1506.

Furthermore, the optical signal of the wavelength λ1 is input to the WDM optical receiver module 1501 from the WDM optical receiver module 1502, and converted to an electric signal by the WDM optical receiver module 1501 and DATA1 is reproduced and output by the electric processing circuit 1505. The electric processing circuit 1708 converts the electric signal of the DATA8, input to the optical transmitting/receiving section 1904, to a current signal needed by the WDM optical transmitter module 1704. The current signal is converted to an optical signal of the wavelength λ8 by the WDM optical transmitter module 1704 and sent by the output optical fiber in the first optical fiber pair. The optical signal is also sent together with the optical signal with the wavelengths λ5, λ6 and λ7, input from the input optical fiber in the second optical fiber pair, by the output optical fiber in the second optical fiber pair and sent to the transfer optical fiber 1 via the optical coupler 2101, the wavelength multiplexing/demultiplexing coupler 2103 and the optical connector 19.

The electric processing circuit 1707 converts the electric signal of the DATA7 input to the optical transmitting/receiving section 1903 to a current signal needed by the WDM optical transmitter module 1703. The current signal is converted to an optical signal of the wavelength λ7 by the WDM optical transmitter module 1703 and sent together with the optical signal of the wavelength λ8, input from the input optical fiber in the first optical fiber pair, by the output optical fiber in the first optical fiber pair. The optical signal of the wavelength λ7 is also sent together with the optical signal with the wavelengths λ5 and λ6, input from the input optical fiber in the second optical fiber pair, by the output optical fiber in the second optical fiber pair. The electric processing circuit 1706 converts the electric signal of the DATA6, input to the optical transmitting/receiving section 1902, to a current signal needed by the WDM optical transmitter module 1702. The current signal is converted to an optical signal of the wavelength λ6 by the WDM optical transmitter module 1702 and sent together with the optical signal of the wavelengths λ7 and λ8, input from the input optical fiber in the first optical fiber pair, by the output optical fiber in the first optical fiber pair. The optical signal of the wavelength λ6 is also sent together with the optical signal of the wavelength λ5, input from the input optical fiber in the second optical fiber pair, by the output optical fiber in the second optical fiber pair.

The electric processing circuit 1705 converts the electric signal of the DATA5, input to the optical transmitting/receiving section 1901, to a current signal needed by the WDM optical transmitter module 1701. The current signal is converted to an optical signal of the wavelength λ5 by the WDM optical transmitter module 1701 and sent together with the optical signal with the wavelengths λ6, λ7 and λ8, input from the input optical fiber in the first optical fiber pair, by the output optical fiber in the first optical fiber pair. This optical signal is sent to the transfer optical fiber 1 via the optical coupler 2101, the wavelength multiplexing/demultiplexing coupler 2102 and the optical connector 19 and is also sent by the output optical fiber in the second optical fiber pair. As apparent from the above, the seventeenth embodiment of the invention can make the wavelength multiplexing/demultiplexing section smaller in size as compared with the conventional optical transmitting/receiving apparatus and can provide an excellent, live-insertable (hot-plugable) WDM optical transmitting/receiving apparatus which is prevented from become larger even if the number of wavelength multiplexing stages is increased and does not influence the other optical transmitting/receiving sections, due to the dual sequential connection, even if one optical transmitting/receiving section fails and needs replacement.

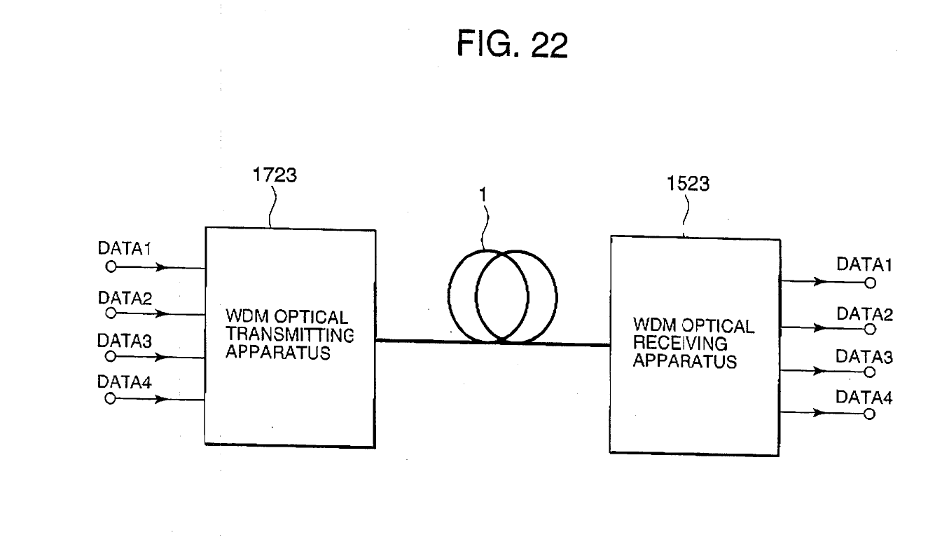

FIG. 22 illustrates an optical transfer system according to the eighteenth embodiment of the invention. In FIG. 22, “1723” is the WDM optical transmitting apparatus according to the fourteenth embodiment of the invention, “1523” is the WDM optical receiving apparatus according to the thirteenth embodiment of the invention, and the WDM optical transmitting apparatus 1723 and the WDM optical receiving apparatus 1523 are connected together by the transfer optical fiber 1.

The operation of the eighteenth embodiment of the invention will be discussed below. The DATA1, DATA2, DATA3 and DATA4 to be input to the WDM optical transmitting apparatus 1723 are converted to optical signals with four wavelengths by the WDM optical transmitting apparatus 1723. The optical signals with four wavelengths are transferred through a single transfer optical fiber to the WDM optical receiving apparatus 1523. The WDM optical receiving apparatus 1523 demultiplexes the four wavelengths and reproduces and outputs the DATA1, DATA2, DATA3 and DATA4. As apparent from the above, the eighteenth embodiment of the invention can provide a live-insertable (hot-plugable) optical transfer system which comprises a compact WDM optical transmitting apparatus and a compact WDM optical receiving apparatus.

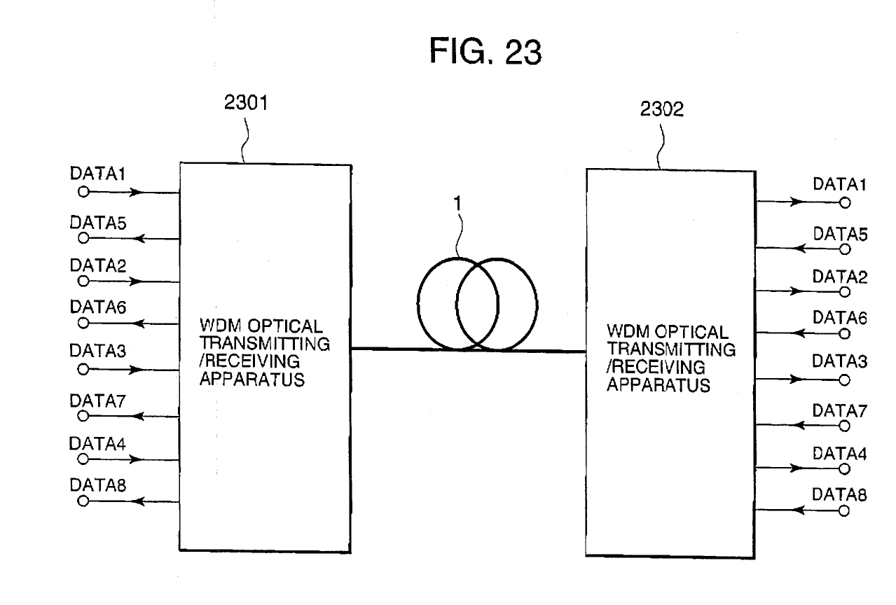

FIG. 23 illustrates a one-fiber bidirectional WDM optical transfer system according to the nineteenth embodiment of the invention. In FIG. 23, “2301” and “2302” denote the WDM optical transmitting/receiving apparatuses according to the fifteenth, sixteenth or seventeenth embodiment of the invention. The two WDM optical transmitting/receiving apparatuses 2301 and 2302 are connected together by the transfer optical fiber 1.

The operation of the nineteenth embodiment of the invention will be discussed below. The DATA1, DATA2, DATA3 and DATA4 to be input to the WDM optical transmitting/receiving apparatus 2301 are converted to optical signals with four wavelengths by the WDM optical transmitting/receiving apparatus 2301. The optical signals with four wavelengths are transferred through the single transfer optical fiber 1 to the WDM optical transmitting/receiving apparatus 2302. The WDM optical transmitting/receiving apparatus 2302 demultiplexes the four wavelengths and reproduces and outputs the DATA1, DATA2, DATA3 and DATA4. Meanwhile, the DATA5, DATA6, DATA7 and DATA8 to be input to the WDM optical transmitting/receiving apparatus 2302 are converted to optical signals with four wavelengths by the WDM optical transmitting/receiving apparatus 2302. The optical signals with four wavelengths are transferred through the single transfer optical fiber 1 to the WDM optical transmitting/receiving apparatus 2301. The WDM optical transmitting/receiving apparatus 2301 demultiplexes the four wavelengths and reproduces and outputs the DATA5, DATA6, DATA7 and DATA8. The nineteenth embodiment of the invention can apparently provide a live-insertable (hot-plugable) one-fiber bidirectional WDM optical transfer system comprising compact WDM optical transmitting/receiving apparatuses.

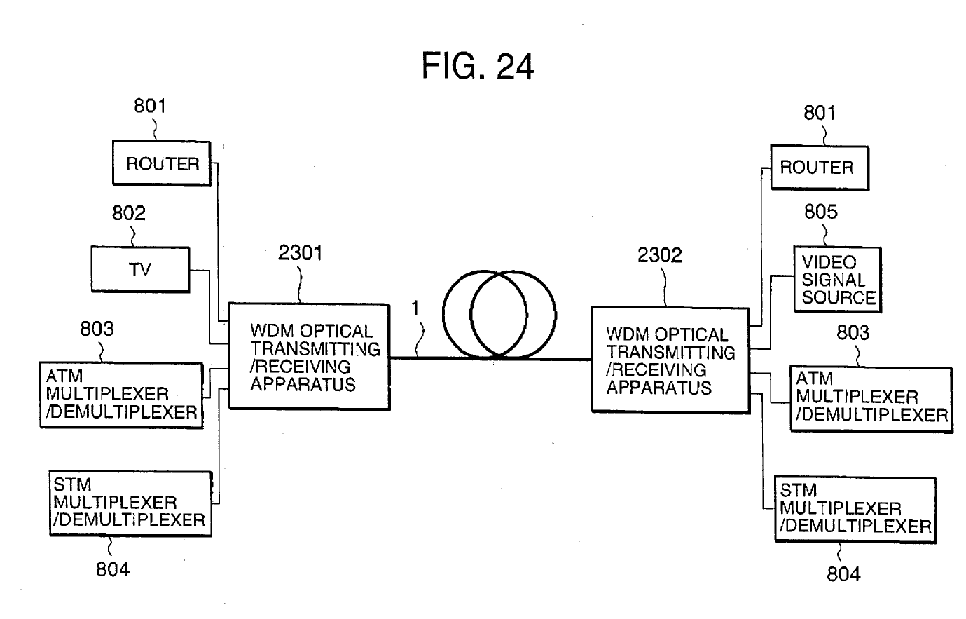

FIG. 24 illustrates a service multiplexed transfer system according to the twentieth embodiment of the invention. Reference numeral “2301” and “2302” in FIG. 24 are the WDM optical transmitting/receiving apparatuses according to any of the fifteenth, sixteenth and seventeenth embodiments of the invention. Reference numeral “801” is a router which terminates an IP network, “802” is a television signal receiver (TV), “803” is an ATM multiplexer/demultiplexer which terminates an ATM network, “804” is an STM multiplexer/demultiplexer which terminates an STM network, and “805” is a video signal source. The two WDM optical transmitting/receiving apparatuses 2301 and 2302 are connected together by the transfer optical fiber 1.

The operation of the twentieth embodiment of the invention will be discussed below. Signals that provide four services, an IP service by the router 801 connected to the WDM optical transmitting/receiving apparatus 2302, a video distribution service by the video signal source 805, an ATM service by the ATM multiplexer/demultiplexer 803 and an STM service by the STM multiplexer/demultiplexer 804, are converted to optical signals with four wavelengths. The optical signals with four wavelengths are transferred over the single transfer optical fiber 1 to the WDM optical transmitting/receiving apparatus 2301. The WDM optical transmitting/receiving apparatus 2301 demultiplexes the four wavelengths to output signals that provide four services, namely the IP service by the router 801 connected to the WDM optical transmitting/receiving apparatus 2302, the video distribution service by the video signal source 805, the ATM service by the ATM multiplexer/demultiplexer 803 and the STM service by the STM multiplexer/demultiplexer 804. Apparently, the twentieth embodiment of the invention can provide a live-insertable (hot-plugable) service multiplexed transfer system comprising compact WDM optical transmitting/receiving apparatuses.

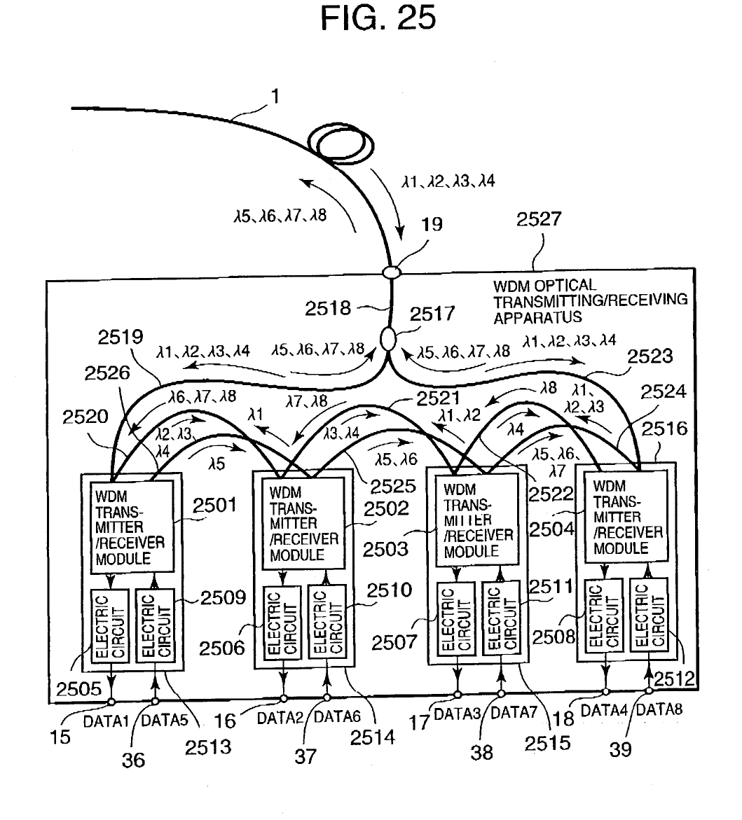

FIG. 25 shows the twenty-first embodiment of the invention. Reference numeral “2527” in FIG. 25 is a WDM optical transmitting/receiving apparatus. Reference numeral “2517” is an optical coupler which splits an optical signal, input via the optical connector 19, into two. The WDM optical transmitting/receiving apparatus 2527 receives four wavelengths (λ1, λ2, λ3, λ4) via the optical connector 19 from the transfer optical fiber 1 and multiplexes optical signals with wavelengths (λ5, λ6, λ7, λ8) and sends the multiplexed optical signal to the transfer optical fiber 1. Intraconnection optical fibers 2518 to 2526 optically connect the components inside the apparatus to one another. Reference numerals “2501”, “2502”, “2503” and “2504” are WDM optical transmitter/receiver modules each of which has two pairs of optical fibers each having two optical fibers. The WDM optical transmitter/receiver module 2501 outputs a current signal corresponding to the optical signal power of the wavelength λ1, the WDM optical transmitter/receiver module 2502 outputs a current signal corresponding to the optical signal power of the wavelength λ2, the WDM optical transmitter/receiver module 2503 outputs a current signal corresponding to the optical signal power of the wavelength λ3 and the WDM optical transmitter/receiver module 2504 outputs a current signal corresponding to the optical signal power of the wavelength λ4.

The WDM optical transmitter/receiver module 2501 outputs the optical signal of the wavelength λ5 added with the optical signal having wavelengths λ6, λ7 and λ8 input from the first pair of optical fibers to the first pair of optical fibers to the and outputs the optical signal of the wavelength λ6 to the second pair of optical fibers. The WDM optical transmitter/receiver module 2502 outputs the optical signal of the wavelength λ6 added with the optical signal having wavelengths λ7 and λ8, input from the first pair of optical fibers, to the first pair of optical fibers to the and outputs the optical signal of the wavelength λ6 added with the optical signal of the wavelength λ5, input from the second pair of optical fibers, to the second pair of optical fibers. The WDM optical transmitter/receiver module 2503 outputs the optical signal of the wavelength λ7 added with the optical signal of wavelength λ8, input from the first pair of optical fibers, to the first pair of optical fibers to the and outputs the optical signal of the wavelength λ7 added with the optical signal having the wavelengths λ5 and λ6, input from the second pair of optical fibers, to the second pair of optical fibers.

The WDM optical transmitter/receiver module 2504 outputs the optical signal of the wavelength λ8 to the first pair of optical fibers, and outputs the optical signal of the wavelength λ8 added with the optical signal having the wavelengths λ5, λ6 and λ7, input from the second pair of optical fibers, to the second pair of optical fibers. Electronic processing circuits 2509 to 2512 respectively convert input electric signals to current signals needed by the WDM optical transmitter/receiver modules 2501 to 2504. The first pair of optical fibers of the WDM optical transmitter/receiver module 2501 is connected to the transfer optical fiber 1 via the optical coupler 2517 and the optical connector 19. The first pair of optical fibers of the WDM optical transmitter/receiver module 2502 is connected to the first pair of optical fibers of the WDM optical transmitter/receiver module 2501. The first pair of optical fibers of the WDM optical transmitter/receiver module 2503 is connected to the first pair of optical fibers of the WDM optical transmitter/receiver module 2502. The first pair of optical fibers of the WDM optical transmitter/receiver module 2504 is connected to the first pair of optical fibers of the WDM optical transmitter/receiver module 2503.

The second pair of optical fibers of the WDM optical transmitter/receiver module 2504 is connected to the transfer optical fiber 1 via the optical coupler 2517 and the optical connector 19. The second pair of optical fibers of the WDM optical transmitter/receiver module 2503 is connected to the second pair of optical fibers of the WDM optical transmitter/receiver module 2504. The second optical fiber pair of optical fibers of the WDM optical transmitter/receiver module 2502 is connected to the second pair of optical fibers of the WDM optical transmitter/receiver module 2503. The second pair of optical fibers of the WDM optical transmitter/receiver module 2501 is connected to the second pair of optical fibers of the WDM optical transmitter/receiver module 2502. Electric processing circuits 2505 to 2508 convert input electric signals output from the WDM optical transmitter/receiver modules 2501 to 2504 to required signal forms and signal levels. Optical transmitting/receiving sections 2513 to 2516 respectively comprise the associated WDM optical transmitter/receiver modules 2501 to 2516 and the associated electric processing circuits 2505 to 2512. Reference numerals “15”, “16”, “17”, “18”, “36”, “37”, “38” and “39” denote electric connectors.

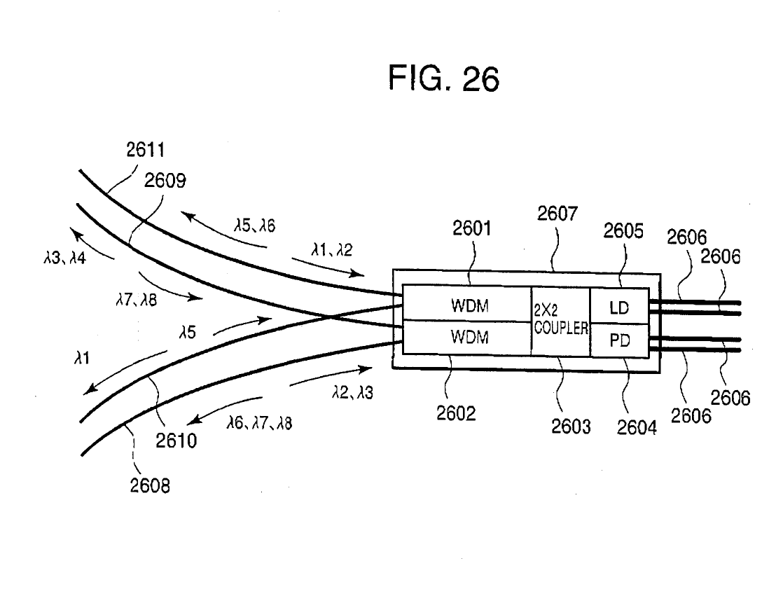

FIG. 26 is a block diagram of the WDM optical transmitter/receiver module according to the twenty-first embodiment of the invention. Reference numerals “2608”, “2609”, “2610” and “2611” in FIG. 26 are intraconnection optical fibers, “2601” and “2602” are wavelength multiplexing/demultiplexing elements each of which passes an optical signal of a specific wavelength and reflects optical signals of the other wavelengths, “2603” is an optical coupler element, “2604” is a light receiving element, “2605” is a light emitting element, and “2606” denotes an electric interconnection lead. The two wavelength multiplexing/demultiplexing elements 2601 and 2602 are each optically coupled to two intraconnection optical fibers, and the light receiving element 2604 and the light emitting element 2605 are optically coupled to the two wavelength multiplexing/demultiplexing elements 2601 and 2602 and electrically connected to the electric interconnection leads 2606, thereby constituting a WDM optical transmitter/receiver module 2607. Although the description on FIG. 26 discusses the case of the WDM optical transmitter/receiver module 2502 which receives an optical signal of the wavelength ?2 and transmits an optical signal of the wavelength λ6, the WDM optical transmitter/receiver module 2501 which receives the wavelength λ1 and transmits the wavelength λ5, the WDM optical transmitter/receiver module 2503 which receives the wavelength λ3 and transmits the wavelength λ7, and the WDM optical transmitter/receiver module 2504 which receives the wavelength λ4 and transmits the wavelength S8 have the same structure except for the wavelength characteristics of the wavelength multiplexing/demultiplexing elements 2601 and 2602.

As the optical signal with the wavelengths λ2, λ3 and λ4 is input from the first pair of optical fibers optically coupled to the wavelength multiplexing/demultiplexing element 2602, the wavelength multiplexing/demultiplexing element 2602 causes only the optical signal of the wavelength λ2 to be input to the light receiving element 2604 and the wavelengths λ3 and λ4 are output from the first pair of optical fiber. The optical signal of the wavelength λ6 output from the light emitting element 2605 is split by the optical coupler element 2603 and is added to the wavelengths λ7 and λ8 input from the first pair of optical fibers by the wavelength multiplexing/demultiplexing element 2602 before being then output. As the optical signal with the wavelengths λ1 and λ2 is input from the second pair of optical fibers optically coupled to the wavelength multiplexing/demultiplexing element 2601, the wavelength multiplexing/demultiplexing element 2601 causes only the optical signal of the wavelength λ2 to be input to the light receiving element 2604 and the wavelength λ1 is output from the second pair of optical fiber. The optical signal of the wavelength λ6 output from the light emitting element 2605 is split by the optical coupler element 2603 and is added to the wavelength λ5 input from the second pair of optical fibers by the wavelength multiplexing/demultiplexing element 2601 before being then output.

The operation of the twenty-first embodiment of the invention will be discussed below. The optical signals with the four wavelengths λ1, λ2, λ3 and λ4 input to the WDM optical transmitting/receiving apparatus 2527 in FIG. 25 are split into two by the optical coupler 2517, one being input to the first pair of optical fibers of the WDM optical transmitter/receiver module 2501. Only the optical signal of the wavelength λ1 is converted to an electric signal by the WDM optical transmitter/receiver module 2501 and DATA1 is reproduced and output by the electric processing circuit 2505. The optical signals with the wavelengths λ2, λ3 and λ4 are input to the first pair of optical fibers of the WDM optical transmitter/receiver module 2502 from the WDM optical transmitter/receiver module 2501, and only the optical signal of the wavelength λ2 is converted to an electric signal by the WDM optical transmitter/receiver module 2502 and DATA2 is reproduced and output by the electric processing circuit 2506. Further, the optical signals with the four wavelengths λ3 and λ4 are input to the first pair of optical fibers of the WDM optical transmitter/receiver module 2503 from the WDM optical transmitter/receiver module 2502, and only the optical signal of the wavelength λ3 is converted to an electric signal by the WDM optical transmitter/receiver module 2503 and DATA3 is reproduced and output by the electric processing circuit 2507. Furthermore, the optical signal of the wavelength λ4 is input to the first pair of optical fibers of the WDM optical transmitter/receiver module 2504 from the WDM optical transmitter/receiver module 2503, and converted to an electric signal by the WDM optical transmitter/receiver module 2504 and DATA4 is reproduced and output by the electric processing circuit 2508.

The other output of the optical coupler 2517 is input to the second pair of optical fibers of the WDM optical transmitter/receiver module 2504. Only the optical signal with the wavelength λ4 is converted to an electric signal by the WDM optical transmitter/receiver module 2504 and DATA4 is reproduced and output by the electric processing circuit 2508. The optical signals with the wavelengths λ1, λ2 and λ3 are input to the second pair of optical fibers of the WDM optical transmitter/receiver module 2503 from the WDM optical transmitter/receiver module 2504, and only the optical signal of the wavelength λ3 is converted to an electric signal by the WDM optical transmitter/receiver module 2503 and DATA3 is reproduced and output by the electric processing circuit 2507. Further, the optical signals with the four wavelengths λ1 and λ2 are input to the second pair of optical fibers of the WDM optical transmitter/receiver module 2502 from the WDM optical transmitter/receiver module 2503, and only the optical signal of the wavelength λ2 is converted to an electric signal by the WDM optical transmitter/receiver module 2502 and DATA2 is reproduced and output by the electric processing circuit 2506. Furthermore, the optical signal of the wavelength λ1 is input to the second pair of optical fibers of the WDM optical transmitter/receiver module 2501 from the WDM optical transmitter/receiver module 2502, and converted to an electric signal by the WDM optical transmitter/receiver module 2501 and DATA1 is reproduced and output by the electric processing circuit 2505.

The electric processing circuit 2512 converts the electric signal of the DATA8, input to the optical transmitting/receiving section 2516, to a current signal needed by the WDM optical transmitter/receiver module 2504. The current signal is converted to an optical signal of the wavelength λ8 by the WDM optical transmitter/receiver module 2504 and output by the first pair of optical fibers. The optical signal is added to the optical signal with the wavelengths λ5, λ6 and λ7, input from the second pair of optical fibers, and output from the second pair of optical fibers and output to the transfer optical fiber 1 via the optical coupler 2517 and the optical connector 19. The electric processing circuit 2511 converts the electric signal of the DATA7 input to the optical transmitting/receiving section 2515 to a current signal needed by the WDM optical transmitter/receiver module 2503. The current signal is converted to an optical signal of the wavelength λ7 by the WDM optical transmitter/receiver module 2503, added to the optical signal of the wavelength λ8, input to the first pair of optical fibers, and output from the first pair of optical fibers. The optical signal of the wavelength λ7 is added to the optical signal with the wavelengths λ5 and λ6, input from the second pair of optical fibers, and is output from the second pair of optical fibers. The electric processing circuit 2510 converts the electric signal of the DATA6, input to the optical transmitting/receiving section 2514, to a current signal needed by the WDM optical transmitter/receiver module 2502. The current signal is converted to an optical signal of the wavelength λ6 by the WDM optical transmitter/receiver module 2502, added to the optical signal of the wavelengths λ7 and λ8, input from the first pair of optical fibers, and output from the first pair of optical fibers. The optical signal of the wavelength λ6 is also added to the optical signal of the wavelength λ5, input from the second pair of optical fibers, and output from the second pair of optical fibers.

The electric processing circuit 2509 converts the electric signal of the DATA5, input to the optical transmitting/receiving section 2513, to a current signal needed by the WDM optical transmitter/receiver module 2501. The current signal is converted to an optical signal of the wavelength λ5 by the WDM optical transmitter/receiver module 2501, added to the optical signal with the wavelengths λ6, λ7 and λ8, input from the first pair of optical fibers, and output to the transfer optical fiber 1 via the optical coupler 2517 and the optical connector 19. This optical signal is output from the second pair of optical fibers. As apparent from the above, the twenty-first embodiment of the invention can make the wavelength multiplexing/demultiplexing section smaller in size as compared with the conventional optical transmitting/receiving apparatus and can provide an excellent, live-insertable (hot-plugable) WDM optical transmitting/receiving apparatus which is prevented from become larger even if the number of wavelength multiplexing stages is increased and does not influence the other optical transmitting/receiving sections, due to the dual sequential connection, even if one optical transmitting/receiving section fails and needs replacement.

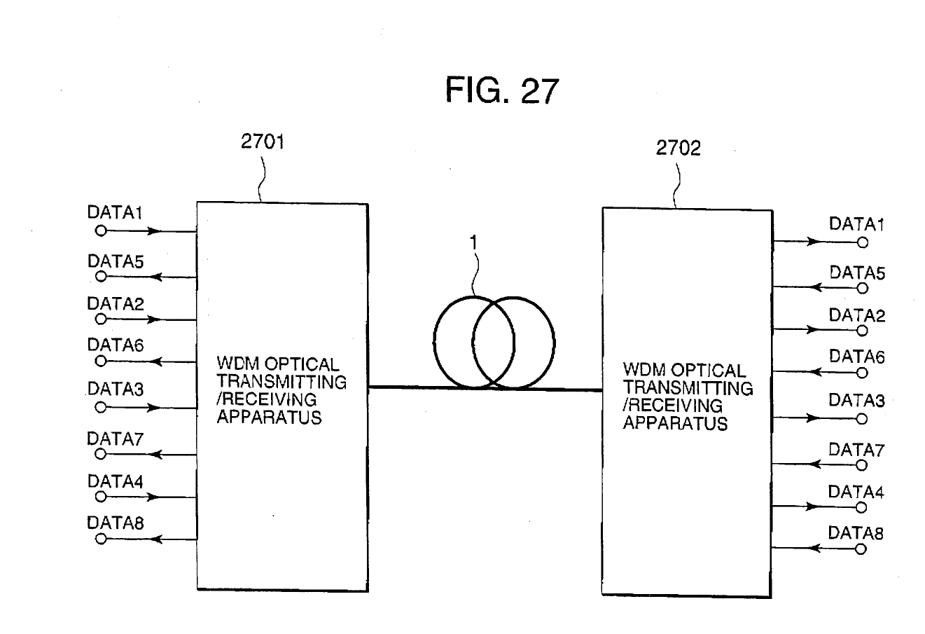

FIG. 27 illustrates a one-fiber bidirectional WDM optical transfer system according to the twenty-second embodiment of the invention. In FIG. 27, “2701” and “2702” denote the WDM optical transmitting/receiving apparatuses according to the twenty-first embodiment of the invention. The two WDM optical transmitting/receiving apparatuses 2701 and 2702 are connected together by the transfer optical fiber 1.

The operation of the twenty-second embodiment of the invention will be discussed below. The DATA1, DATA2, DATA3 and DATA4 to be input to one of the WDM optical transmitting/receiving apparatuses, 2701, are converted to optical signals with four wavelengths by the WDM optical transmitting/receiving apparatus 2701. The optical signals with four wavelengths are transferred through the single transfer optical fiber 1 to the WDM optical transmitting/receiving apparatus 2702. The WDM optical transmitting/receiving apparatus 2702 demultiplexes the four wavelengths and reproduces and outputs the DATA1, DATA2, DATA3 and DATA4. The DATA5, DATA6, DATA7 and DATA8 to be input to the other WDM optical transmitting/receiving apparatus, 2702, are converted to optical signals with four wavelengths by the WDM optical transmitting/receiving apparatus 2702. The optical signals with four wavelengths are transferred through the single transfer optical fiber 1 to the WDM optical transmitting/receiving apparatus 2701. The WDM optical transmitting/receiving apparatus 2701 demultiplexes the four wavelengths and reproduces and outputs the DATA5, DATA6, DATA7 and DATA8. The twenty-second embodiment of the invention can apparently provide a live-insertable (hot-plugable) one-fiber bidirectional WDM optical transfer system comprising compact WDM optical transmitting/receiving apparatuses.

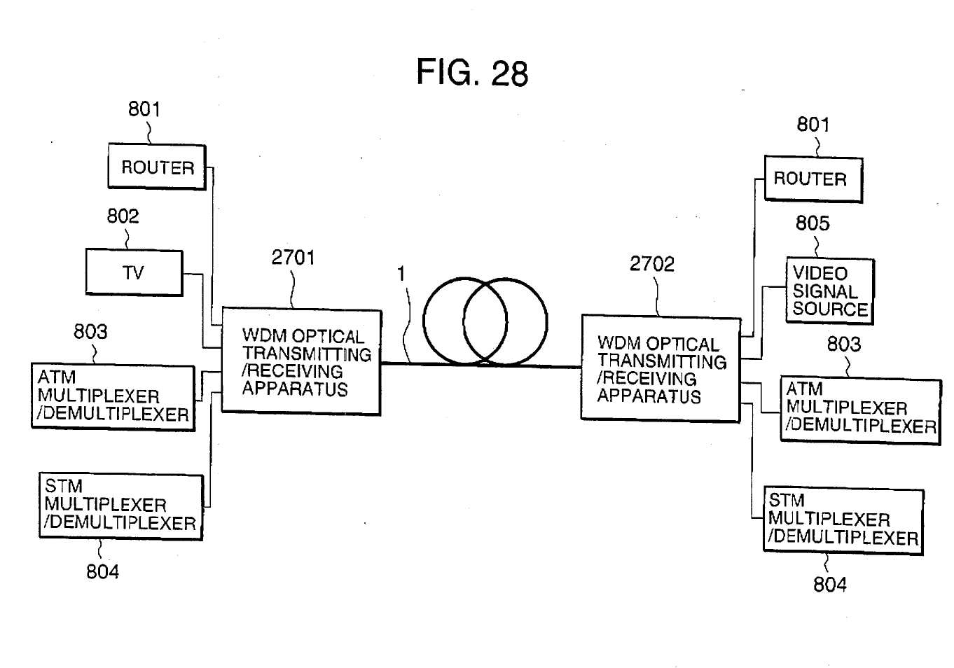

FIG. 28 illustrates a service multiplexed transfer system according to the twenty-third embodiment of the invention. Reference numeral “2701” and “2702” in FIG. 28 are the WDM optical transmitting/receiving apparatuses according to the twenty-first embodiment of the invention. Reference numeral “801” is a router which terminates an IP network, “802” is a television signal receiver (TV), “803” is an ATM multiplexer/demultiplexer which terminates an ATM network, “804” is an STM multiplexer/demultiplexer which terminates an STM network, and “805” is a video signal source. The two WDM optical transmitting/receiving apparatuses 2701 and 2702 are connected together by the transfer optical fiber 1.

The operation of the twenty-third embodiment of the invention will be discussed below. Signals that provide four services, an IP service by the router 801 connected to the WDM optical transmitting/receiving apparatus 2702, a video distribution service by the video signal source 805, an ATM service by the ATM multiplexer/demultiplexer 803 and an STM service by the STM multiplexer/demultiplexer 804, are converted to optical signals with four wavelengths. The optical signals with four wavelengths are transferred over the single transfer optical fiber 1 to the WDM optical transmitting/receiving apparatus 2701. The WDM optical transmitting/receiving apparatus 2701 demultiplexes the four wavelengths to output signals that provide four services, namely the IP service by the router 801 connected to the WDM optical transmitting/receiving apparatus 2702, the video distribution service by the video signal source 805, the ATM service by the ATM multiplexer/demultiplexer 803 and the STM service by the STM multiplexer/demultiplexer 804. Apparently, the twenty-third embodiment of the invention can provide a live-insertable (hot-plugable) service multiplexed transfer system comprising compact WDM optical transmitting/receiving apparatuses.

It should be apparent from the foregoing description that the invention has the following advantages.

1. The invention can provide a compact and low-cost WDM optical receiving apparatus, WDM optical transmitting apparatus, WDM optical transmitting/receiving apparatus, WDM optical transfer system, one-fiber bidirectional WDM optical transfer system, and service multiplexed transfer system.

2. The invention can provide a compact and low-cost WDM optical receiving apparatus, WDM optical transmitting apparatus, WDM optical transmitting/receiving apparatus, WDM optical transfer system, one-fiber bidirectional WDM optical transfer system, and service multiplexed transfer system which have a high reception sensitivity.

3. The invention can provide a compact, low-cost live-insertable (hot-plugable) WDM optical receiving apparatus, WDM optical transmitting apparatus, WDM optical transmitting/receiving apparatus, WDM optical transfer system, one-fiber bidirectional WDM optical transfer system, and service multiplexed transfer system.

What is claimed is:

1. An optical receiving apparatus comprising:
first to n-th optical receiving sections (n being an integer equal to or greater than 2) each including a receiver module having a wavelength multiplexing/demultiplexing element for passing an optical signal of a specific wavelength and reflecting optical signals having other wavelengths than said specific wavelength, and a light receiving element for converting output light from said wavelength multiplexing/demultiplexing element to an electric signal, and an electric circuit for converting an output electric signal from said receiver module into a predetermined form and/or level and outputting said output electric signal; and
optical fiber means for sequentially connecting said wavelength multiplexing/demultiplexing elements of said first to n-th optical receiving sections one to another and connecting said wavelength multiplexing/demultiplexing element of said first optical receiving section to an optical connector.

2. The optical receiving apparatus according to claim 1, wherein said specific wavelength differs among said wavelength multiplexing/demultiplexing elements of said first to n-th optical receiving sections.

3. An optical transmitting apparatus comprising:
first to n-th optical transmitting sections (n being an integer equal to or greater than 2) each including an electric circuit for converting an electric signal to be input into a predetermined form and/or level and outputting said electric signal, and a transmitter module equipped in a single module with a light emitting element for converting said output electric signal from said electric circuit to an optical signal, a wavelength multiplexing/demultiplexing element, provided at an optical output section of said light emitting element, for passing an optical signal of a specific wavelength and reflecting optical signals having other wavelengths than said specific wavelength and an optical coupling section for optically coupling an input optical fiber and an output optical fiber to said wavelength multiplexing/demultiplexing element; and
optical fiber means for sequentially connecting said optical coupling sections of said first to n-th optical transmitting sections one to another and connecting said optical coupling section of said first optical transmitting section to an optical connector.

4. The optical transmitting apparatus according to claim 3, wherein said specific wavelength differs among said wavelength multiplexing/demultiplexing elements of said first to n-th optical transmitting sections.

5. An optical transmitting/receiving apparatus comprising:
first to n-th optical receiving sections (n being an integer equal to or greater than 2) each including a receiver module having a wavelength multiplexing/demultiplexing element for passing an optical signal of a specific wavelength and reflecting optical signals having other wavelengths than said specific wavelength, and a light receiving element for converting output light from said wavelength multiplexing/demultiplexing element to an electric signal, and an electric circuit for converting an output electric signal from said receiver module into a predetermined form and/or level and outputting said output electric signal;
first to n-th optical transmitting sections each including an electric circuit for converting an electric signal to be input into a predetermined form and/or level and outputting said electric signal, and a transmitter module equipped in a single module with a light emitting element for converting said output electric signal from said electric circuit to an optical signal, a wavelength multiplexing/demultiplexing element, provided at an optical output section of said light emitting element, for passing an optical signal of a specific wavelength and reflecting optical signals having other wavelengths than said specific wavelength and an optical coupling section for optically coupling an input optical fiber and an output optical fiber to said wavelength multiplexing/demultiplexing element; and
optical fiber means for connecting said wavelength multiplexing/demultiplexing element of said first optical receiving section to said optical coupling section of said first optical transmitting section, connecting said optical coupling section of said first optical transmitting section to said wavelength multiplexing/demultiplexing element of said second optical receiving section, making similar connections thereafter and connecting said wavelength multiplexing/demultiplexing element of said first optical receiving section to an optical connector.

6. An optical transfer system for transferring data of a plurality of different signal forms in a form of a wavelength multiplexed signal, comprising:
(a) an optical transmitting apparatus having
first to n-th optical transmitting sections (n being an integer equal to or greater than 2) each including an electric circuit for converting an electric signal to be input into a predetermined form and/or level and outputting said electric signal, and a transmitter module equipped in a single module with a light emitting element for converting said output electric signal from said electric circuit to an optical signal, a wavelength multiplexing/demultiplexing element, provided at an optical output section of said light emitting element, for passing an optical signal of a specific wavelength and reflecting optical signals having other wavelengths than said specific wavelength and an optical coupling section for optically coupling an input optical fiber and an output optical fiber to said wavelength multiplexing/demultiplexing element, and
optical fiber means for sequentially connecting said optical coupling sections of said first to n-th optical transmitting sections one to another and connecting said optical coupling section of said first optical transmitting section to an optical connector;
(b) an optical receiving apparatus having
first to n-th optical receiving sections each including a receiver module having a wavelength multiplexing/demultiplexing element for passing an optical signal of a specific wavelength and reflecting optical signals having other wavelengths than said specific wavelength and a light receiving element for converting output light from said wavelength multiplexing/demultiplexing element to an electric signal, and an electric circuit for converting an output electric signal from said receiver module into a predetermined form and/or level and outputting said output electric signal, and
optical fiber means for sequentially connecting said wavelength multiplexing/demultiplexing elements of said first to n-th optical receiving sections one to another and connecting said wavelength multiplexing/demultiplexing element of said first optical receiving section to an optical connector; and
(c) a transfer optical fiber provided between said optical transmitting apparatus and said optical receiving apparatus.

7. An optical transfer system for bidirectionally transferring data of a plurality of different signal forms in a form of a wavelength multiplexed signal, comprising:
(a) a first optical transmitting/receiving apparatus having
first to n-th optical receiving sections (n being an integer equal to or greater than 2) each including a receiver module having a wavelength multiplexing/demultiplexing element for passing an optical signal of a specific wavelength and reflecting optical signals having other wavelengths than said specific wavelength and a light receiving element for converting output light from said wavelength multiplexing/demultiplexing element to an electric signal, and an electric circuit for converting an output electric signal from said receiver module into a predetermined form and/or level and outputting said output electric signal,
first to n-th optical transmitting sections each including an electric circuit for converting an electric signal to be input into a predetermined form and/or level and outputting said electric signal, and a transmitter module equipped in a single module with a light emitting element for converting said output electric signal from said electric circuit to an optical signal, a wavelength multiplexing/demultiplexing element, provided at an optical output section of said light emitting element, for passing an optical signal of a specific wavelength and reflecting optical signals having other wavelengths than said specific wavelength and an optical coupling section for optically coupling an input optical fiber and an output optical fiber to said wavelength multiplexing/demultiplexing element, and
optical fiber means for connecting said wavelength multiplexing/demultiplexing element of said first optical receiving section to said optical coupling section of said first optical transmitting section, connecting said optical coupling section of said first optical transmitting section to said wavelength multiplexing/demultiplexing element of said second optical receiving section, making similar connections thereafter and connecting said wavelength multiplexing/demultiplexing element of said first optical receiving section to an optical connector;
(b) a second optical transmitting/receiving apparatus having a same structure as said first optical transmitting/receiving apparatus; and
(c) a single transfer optical fiber for connecting said first optical transmitting/receiving apparatus and said second optical transmitting/receiving apparatus together.

8. An optical transmitting/receiving apparatus comprising:
first to n-th optical receiving sections (n being an integer equal to or greater than 2) each including a receiver module having a wavelength multiplexing/demultiplexing element for passing an optical signal of a specific wavelength and reflecting optical signals having other wavelengths than said specific wavelength and a light receiving element for converting output light from said wavelength multiplexing/demultiplexing element to an electric signal, and an electric circuit for converting an output electric signal from said receiver module into a predetermined form and/or level and outputting said output electric signal;
first to n-th optical transmitting sections each including an electric circuit for converting an electric signal to be input into a predetermined form and/or level and outputting said electric signal, and a transmitter module equipped in a single module with a light emitting element for converting said output electric signal from said electric circuit to an optical signal, a wavelength multiplexing/demultiplexing element, at an optical output section of said light emitting element, for passing an optical signal of a specific wavelength and reflecting optical signals having other wavelengths than said specific wavelength and an optical coupling section for optically coupling an input optical fiber and an output optical fiber to said wavelength multiplexing/demultiplexing element;
first optical fiber means for sequentially connecting said wavelength multiplexing/demultiplexing elements of said first to n-th optical receiving sections one to another and connecting said wavelength multiplexing/demultiplexing element of said first optical receiving section to said optical coupling section of said n-th optical transmitting section; and
second optical fiber means for sequentially connecting said optical coupling sections of said first to n-th optical transmitting sections one to another and connecting said optical coupling section of said first optical transmitting section to an optical connector, whereby output light from any optical transmitting section which has a large optical output level is prevented from being input to an associated one of said optical receiving sections.

9. An optical transfer system for bidirectionally transferring data of a plurality of different signal forms in a form of a wavelength multiplexed signal, comprising:
(a) a first optical transmitting/receiving apparatus having
first to n-th optical receiving sections (n being an integer equal to or greater than 2) each including a receiver module having a wavelength multiplexing/demultiplexing element for passing an optical signal of a specific wavelength and reflecting optical signals having other wavelengths than said specific wavelength and a light receiving element for converting output light from said wavelength multiplexing/demultiplexing element to an electric signal, and an electric circuit for converting an output electric signal from said receiver module into a predetermined form and/or level and outputting said output electric signal,
first to n-th optical transmitting sections each including an electric circuit for converting an electric signal to be input into a predetermined form and/or level and outputting said electric signal, and a transmitter module equipped in a single module with a light emitting element for converting said output electric signal from said electric circuit to an optical signal, a wavelength multiplexing/demultiplexing element, provided at an optical output section of said light emitting element, for passing an optical signal of a specific wavelength and reflecting optical signals having other wavelengths than said specific wavelength and an optical coupling section for optically coupling an input optical fiber and an output optical fiber to said wavelength multiplexing/demultiplexing element, all into a single module,
first optical fiber means for sequentially connecting said wavelength multiplexing/demultiplexing elements of said first to n-th optical receiving sections one to another and connecting said wavelength multiplexing/demultiplexing element of said first optical receiving section to said optical coupling section of said n-th optical transmitting section, and
second optical fiber means for sequentially connecting said optical coupling sections of said first to n-th optical transmitting sections one to another and connecting said optical coupling section of said first optical transmitting section to an optical connector, whereby output light from any optical transmitting section which has a large optical output level is prevented from being input to an associated one of said optical receiving sections.
(b) a second optical transmitting/receiving apparatus having a same structure as said first optical transmitting/receiving apparatus; and
(c) a single transfer optical fiber for connecting said first optical transmitting/receiving apparatus and said second optical transmitting/receiving apparatus together.

10. The optical transfer system according to claim 9, wherein said specific wavelengths of said wavelength multiplexing/demultiplexing elements of said first to n-th optical receiving sections of said first optical transmitting/receiving apparatus differ from one another and are set equal to said specific wavelengths of said wavelength multiplexing/demultiplexing elements of said n-th to first optical transmitting sections of said second optical transmitting/receiving apparatus.

11. The optical transfer system according to claim 9, wherein said specific wavelengths in said first to n-th optical receiving sections of said first optical transmitting/receiving apparatus differ from one another and are set equal to said specific wavelengths of said wavelength multiplexing/demultiplexing elements of said n-th to first optical transmitting sections of said second optical transmitting/receiving apparatus, and said specific wavelengths in said first to n-th optical transmitting sections of said first optical transmitting/receiving apparatus differ from one another and are set equal to said specific wavelengths of said wavelength multiplexing/demultiplexing elements of said n-th to first optical transmitting sections of said second optical transmitting/receiving apparatus.

12. An optical receiving apparatus comprising a plurality of optical receiving sections each including:
an optical coupler for splitting an optical signal input from a transfer optical fiber to two;
a receiver module equipped in a single module with a light receiving element, two wavelength multiplexing/demultiplexing elements provided at an optical output section of said light receiving element and an optical coupling section for optically coupling two pairs of optical fibers each pair having an input optical fiber and an output optical fiber; and
an electric processing circuit for converting an output electric signal from said receiver module into a demanded signal form or signal level and outputting said electric signal,
wherein one output of said optical coupler is connected to said input optical fiber in the first optical fiber pair of said first optical receiving section, the other optical receiving sections are sequentially connected to one another by said first optical fiber pairs, the other output of said optical coupler is connected to said input optical fiber of the second optical fiber pair of that optical receiving section which is located last in sequential connection using said first optical fiber pairs, and sequential connection is made by said second optical fiber pairs, so that if one of said optical receiving sections fails and is removed, the other optical receiving sections are not influenced.

13. An optical transmitting apparatus comprising a plurality of optical transmitting sections each including:
an optical coupler for combining two optical signals and outputting a combined signal to a transfer optical fiber;
a transmitter module equipped in a single module with a light emitting element, two wavelength multiplexing/demultiplexing elements provided at an optical output section of said light emitting element and an optical coupling section for optically coupling two pairs of optical fibers each pair having an input optical fiber and an output optical fiber; and
an electric processing circuit for converting a form or level of an input signal to a one required by said transmitter module,
wherein one input of said optical coupler is connected to said output optical fiber in the first optical fiber pair of said first optical transmitting section, the other optical transmitting sections are sequentially connected to one another by said first optical fiber pairs, the other input of said optical coupler are connected to said output optical fiber of the second optical fiber pair of that optical transmitting section which is located last in sequential connection using said first optical fiber pairs, and sequential connection is made by said second optical fiber pairs, so that if one of said optical transmitting sections fails and is removed, the other optical transmitting sections are not influenced.

14. An optical transmitting/receiving apparatus comprising a plurality of optical transmitting/receiving sections each including an optical coupler for splitting and combining an input optical signal from a transfer optical fiber and an output optical signal to a transfer optical fiber, having an output optical fiber in a first optical fiber pair of an optical receiving section supplied to connected to an output optical fiber in a first optical fiber pair of an optical transmitting section and having an output optical fiber in a second optical fiber pair of said optical receiving section supplied to connected to an output optical fiber in a second optical fiber pair of said optical transmitting section,
wherein one of two inputs/outputs of said optical coupler is connected to said first optical fiber pair of said first optical transmitting/receiving section to sequentially connect plural optical transmitting/receiving sections to one another by said first optical fiber pairs, and the other input/output of said optical coupler is sequentially connected by said second optical fiber pairs, so that if one of said optical transmitting/receiving sections fails and is removed, the other optical transmitting/receiving sections are not influenced.

15. An optical transmitting/receiving apparatus comprising a plurality of optical transmitting/receiving sections each including a wavelength multiplexing/demultiplexing coupler for splitting an optical signal input from a transfer optical fiber to two different optical fibers in accordance with wavelength components of said optical signal and combining optical signals of different wavelength components input from two different optical fibers, first and second optical couplers connected to the two optical fibers of said wavelength multiplexing/demultiplexing coupler, an optical receiving section and an optical transmitting section,
wherein one optical fiber of said first optical coupler is connected to a first optical fiber pair of said optical receiving section of said first optical transmitting/receiving section to sequentially connect plural optical receiving sections to one another by said first optical fiber pairs, the other optical fiber of said first optical coupler is connected to a second optical fiber pair of an end one of said optical receiving sections sequentially connected by said first optical fiber pairs to sequentially connect the other optical receiving sections by said second optical fiber pairs, one optical fiber of said second optical coupler is connected to a first optical fiber pair of said optical transmitting section of said first optical transmitting/receiving section to sequentially connect plural optical transmitting sections to one another by said first optical fiber pairs, the other optical fiber of said second optical coupler is connected to a second optical fiber pair of an end one of said optical transmitting sections sequentially connected by said first optical fiber pairs to sequentially connect the other optical transmitting sections by said second optical fiber pairs, so that if one of said optical transmitting/receiving sections fails and is removed, the other optical transmitting/receiving sections are not influenced.

16. An optical transmitting/receiving apparatus comprising a plurality of optical transmitting/receiving sections each including first and second wavelength multiplexing/demultiplexing couplers connected to two different optical fibers of an optical coupler for splitting an optical signal input from a transfer optical fiber to two and combining two optical signals to be output to said transfer optical fiber, an optical receiving section and an optical transmitting section,
wherein one optical fiber of said first wavelength multiplexing/demultiplexing coupler is connected to a first optical fiber pair of said optical receiving section of said first optical transmitting/receiving section to sequentially connect plural optical receiving sections to one another by said first optical fiber pairs, one optical fiber of said second optical coupler is connected to a second optical fiber pair of an end one of said optical receiving sections sequentially connected by said first optical fiber pairs to sequentially connect the other optical receiving sections by said second optical fiber pairs, the other optical fiber of said second wavelength multiplexing/demultiplexing coupler is connected to a first optical fiber pair of said optical transmitting section of said first optical transmitting/receiving section to sequentially connect plural optical transmitting sections to one another by said first optical fiber pairs, the other optical fiber of said second wavelength multiplexing/demultiplexing coupler is connected to a second optical fiber pair of an end one of said optical transmitting sections sequentially connected by said first optical fiber pairs to sequentially connect the other optical transmitting sections by said second optical fiber pairs, so that if one of said optical transmitting/receiving sections fails and is removed, the other optical transmitting/receiving sections are not influenced.

17. An optical transfer system for bidirectionally transferring data of a plurality of different signal forms in a form of a wavelength multiplexed signal, comprising:
an optical transmitting apparatus having a plurality of optical transmitting sections each including an optical coupler for combining two optical signals and outputting a combined signal to a transfer optical fiber, a transmitter module equipped in a single module with a light emitting element, two wavelength multiplexing/demultiplexing elements provided at an optical output section of said light emitting element and an optical coupling section for optically coupling two pairs of optical fibers each pair having an input optical fiber and an output optical fiber, and an electric processing circuit for converting a form or level of an input signal to a one required by said transmitter module, wherein one input of said optical coupler is connected to said output optical fiber in the first optical fiber pair of said first optical transmitting section, the other optical transmitting sections are sequentially connected to one another by said first optical fiber pairs, the other input of said optical coupler are connected to said output optical fiber of the second optical fiber pair of that optical transmitting section which is located last in sequential connection using said first optical fiber pairs, and sequential connection is made by said second optical fiber pairs, so that if one of said optical transmitting sections fails and is removed, the other optical transmitting sections are not influenced;
an optical receiving apparatus having a plurality of optical receiving sections each including an optical coupler for splitting an optical signal input from a transfer optical fiber to two, a receiver module equipped in a single module with a light receiving element, two wavelength multiplexing/demultiplexing elements provided at an optical output section of said light receiving element and an optical coupling section for optically coupling two pairs of optical fibers each pair having an input optical fiber and an output optical fiber, and an electric processing circuit for converting an output electric signal from said receiver module into a demanded signal form or signal level and outputting said electric signal, wherein one output of said optical coupler is connected to said input optical fiber in the first optical fiber pair of said first optical receiving section, the other optical receiving sections are sequentially connected to one another by said first optical fiber pairs, the other output of said optical coupler is connected to said input optical fiber of the second optical fiber pair of that optical receiving section which is located last in sequential connection using said first optical fiber pairs, and sequential connection is made by said second optical fiber pairs, so that if one of said optical receiving sections fails and is removed, the other optical receiving sections are not influenced;
a single transfer optical fiber for connecting said optical transmitting apparatus and said optical receiving apparatus together.

18. An optical transfer system which has two optical transmitting/receiving apparatuses recited in claim 14, 15 or 16 connected by a single transfer optical fiber and bidirectionally transfers data of a plurality of different signal forms in a form of a wavelength multiplexed signal.

19. A compact optical transmitting/receiving apparatus comprising a plurality of optical transmitting/receiving sections each including:
an optical coupler for splitting an optical signal input from a transfer optical fiber to two;
a transmitter/receiver module equipped in a single module with a light receiving element, a light emitting element, a light receiving element, optical coupler elements for combining optical signals at an optical input section of said light receiving element and at an optical output section of said light emitting element, two wavelength multiplexing/demultiplexing elements and an optical coupling section for optically coupling two pairs of optical fibers each pair having an input optical fiber and an output optical fiber;
an electric processing circuit for converting an output electric signal from said transmitter/receiver module into a demanded signal form or signal level and outputting said electric signal; and
an electric processing circuit for converting an input electric signal to a signal needed by said light emitting element,
wherein one output of said optical coupler is connected to said input optical fiber in the first optical fiber pair of said first optical transmitting/receiving section, the other optical transmitting/receiving sections are sequentially connected to one another by said first optical fiber pairs, the other output of said optical coupler is connected to said input optical fiber of the second optical fiber pair of that optical transmitting/receiving section which is located last in sequential connection using said first optical fiber pairs, and sequential connection is made by said second optical fiber pairs, so that if one of said optical receiving sections fails and is removed, the other optical receiving sections are not influenced.

20. An optical transfer system for bidirectionally transferring data of a plurality of different signal forms in a form of a wavelength multiplexed signal, comprising:
a first compact optical transmitting/receiving apparatus comprising a plurality of optical transmitting/receiving sections each including an optical coupler for splitting an optical signal input from a transfer optical fiber to two, a transmitter/receiver module equipped in a single module with a light receiving element, a light emitting element, a light receiving element, optical coupler elements for combining optical signals at an optical input section of said light receiving element and at an optical output section of said light emitting element, two wavelength multiplexing/demultiplexing elements and an optical coupling section for optically coupling two pairs of optical fibers each pair having an input optical fiber and an output optical fiber, an electric processing circuit for converting an output electric signal from said transmitter/receiver module into a demanded signal form or signal level and outputting said electric signal, and an electric processing circuit for converting an input electric signal to a signal needed by said light emitting element, wherein one output of said optical coupler is connected to said input optical fiber in the first optical fiber pair of said first optical transmitting/receiving section, the other optical transmitting/receiving sections are sequentially connected to one another by said first optical fiber pairs, the other output of said optical coupler is connected to said input optical fiber of the second optical fiber pair of that optical transmitting/receiving section which is located last in sequential connection using said first optical fiber pairs, and sequential connection is made by said second optical fiber pairs, so that if one of said optical receiving sections fails and is removed, the other optical receiving sections are not influenced;
a second optical transmitting/receiving apparatus having a same structure as said first optical transmitting/receiving apparatus; and
a single transfer optical fiber for connecting said first optical transmitting/receiving apparatus and said second optical transmitting/receiving apparatus together.

21. The optical transfer system according to any one of claims 7, 9, 11, 18 and 20, further comprising at least one of an IP router for performing packet exchange, a video signal source for a plurality of channels multiplexed by frequency multiplexing, an ATM multiplexer/demultiplexer for multiplexing and demultiplexing an ATM signal and an STM multiplexer/demultiplexer for multiplexing and demultiplexing an STM signal, whereby service interfacing with plurality of different signal forms is possible.
